(19) United States
(12) Patent Application Publication
(10) Pub. No.: US 2009/0300578 A1
(43) Pub. Date: Dec. 3, 2009

(54) System and Method For Developing An Application For Extending Access to Local Software Of A Wireless Device

(75) Inventor: Timothy Allen Neil, Mississauga (CA)

Correspondence Address: GOWLING LAFLEUR HENDERSON LLP (RIM), 160 ELGIN STREET, SUITE 2600, OTTAWA, ON, K1P 1C3, CA

(73) Assignee: Nextair Corporation, Waterloo (CA)

(21) Appl. No.: 12/425,642

(22) Filed: Apr. 17, 2009

Related U.S. Application Data
(63) Continuation of application No. 11/061,890, filed on Feb. 22, 2005, now abandoned.
Application No. 11/061,890 is a continuation-in-part of application No. 09/846,781, filed on May 2, 2001, now Pat. No. 7,546,298.
(60) Provisional application No. 60/260,223, filed on Jan. 9, 2001.

(51) Int. Cl. G06F 9/44

(52) U.S. Cl. 717/104; 717/135; 717/106

(57) ABSTRACT

A system and method for developing an application for subsequent deployment on a mobile device, the mobile device configured for using the deployed application to communicate over a network with a data source through a transaction server. The system and method comprising: an interface component module for providing access to a defined interface component for use in providing communication between the application and a local software configured to be resident on the mobile device; and a composer module for defining a text file containing definitions expressed in a structured definition language, the definitions describing a message section and a data section and a user interface section of the application, the composer module further for inserting handler definitions in the text file such that the handler definitions are configured for calling the interface component of the interface component module.

### CROSS-REFERENCE TO RELATED APPLICATIONS

This application is a continuation of application Ser. No. 11/061,890, filed on Feb. 22, 2005, the entire disclosure of which is hereby incorporated by reference for all purposes, which is a continuation in part of patent application Ser. No. 09/846,781 filed on May 2, 2001, the entire disclosure of which is hereby incorporated by reference for all purposes, which claims the benefit of provisional application Ser. No. 60/260,223, filed on Jan. 9, 2001, the entire disclosure of which is hereby incorporated by reference for all purposes.

### FIELD OF THE INVENTION

The present invention relates to software, devices and methods for providing development environments for network applications for mobile devices.

### BACKGROUND OF THE INVENTION

Wireless connectivity is a feature of the modern telecommunications environment. An increasing range of people are using a wide variety of wireless data networks to access corporate data applications.

However, there are numerous competing mobile devices that can be used to achieve this. Each device has its own operating system and its own display characteristics. Operating systems are not mutually compatible, nor are the display characteristics—some are color, some are black and white, some are text-only, some are pictorial.

At the same time, an increasing number of mobile device users are people without a technical background or high level of educational achievement. Such people are often intimidated by the need to run complex installation programs. Furthermore, at present, such installation programs generally depend on cable connections to a personal computer by the means of a ‘cradle’ or other such device.

As the mobile device is expanded to, for example, include new hardware or local software applications the server side application can typically not take advantages of the new hardware and software. Of course, the virtual machine software component could be rewritten (or recompiled). This, however, is cumbersome and would require many versions of virtual machine software specific to many different hardware configurations.

### SUMMARY OF THE INVENTION

Therefore, it is an object of the present invention to provide a mechanism whereby a mobile client for a server side application may be enabled for multiple wireless devices with minimal modification of the application at the server is required. a further object of the invention is to provide a development tools for the applications executed by the mobile devices, when in communication with the server side applications of backend data sources. A further object of the present invention is to provide for the ability to install and upgrade the application onto mobile devices wirelessly without the need for human intervention or connection to PCs. A further object of the present invention is to provide for push asynchronous communications to the backend data source from a variety of entities such as a middleware server and the development tool. It is a further object of the present invention to provide for virtual machine software that is extensible to communicate with local device applications.

There is provided a system for developing an application for subsequent deployment on a mobile device, the mobile device configured for using the deployed application to communicate over a network with a data source through a transaction server, the system comprising: an interface component module for providing access to a defined interface component for use in providing communication between the application and a local software configured to be resident on the mobile device; and a composer module for defining a text file containing definitions expressed in a structured definition language, the definitions describing a message section and a data section and a user interface section of the application, the composer module further for inserting handler definitions in the text file such that the handler definitions are configured for calling the interface component of the interface component module.

There is further provided a method for developing an application for subsequent deployment on a mobile device, the mobile device configured for using the deployed application to communicate over a network with a data source through a transaction server, the method comprising the steps of: providing access to a defined interface component for use in providing communication between the application and a local software configured to be resident on the mobile device; defining a text file containing definitions expressed in a structured definition language, the definitions describing a message section and a data section and a user interface section of the application; and inserting handler definitions in the text file such that the handler definitions are configured for calling the interface component of the interface component module.

There is further provided a computer program product for developing an application for subsequent deployment on a mobile device, the mobile device configured for using the deployed application to communicate over a network with a data source through a transaction server, the computer program product comprising: a computer readable medium; an interface component module stored on the computer readable medium for providing a collection of interface components for use in providing access to a defined interface component for use in providing communication between the application and a local software configured to be resident on the mobile device; and a composer module coupled to the interface component module for defining a text file containing definitions expressed in a structured definition language, the definitions describing a message section and a data section and a user interface section of the application, the composer module further for inserting handler definitions in the text file such that the handler definitions are configured for calling the interface component of the interface component module.

In accordance with the present invention, data from an application executing at a computing device is presented at a remote wireless device, by providing the device an application definition file, containing definitions for a user interface format for the application at the wireless device; the format of network messages for exchange of data generated by the application; and a format for storing data related to the application at the wireless device. Using these definitions, the wireless device may receive data from said application in accordance with the definition and present an interface for the application.

Preferably, the application definition file is an XML file. Similarly, application specific network messages provided to the device are also formed using XML.

In the preferred embodiment, the data from the application is presented at the mobile device by virtual machine software that uses the application definition file.

In accordance with an aspect of the present invention, a method of presenting data from an application executing at a computing device at a remote wireless device, includes: receiving at the wireless device, a representation of a text file defining: a format of a user interface for the application at the wireless device; format of network messages for exchange of data generated by the application; a format for storing data related to the application at the wireless device. Thereafter, data from the application may be received in accordance with the format of network transactions, and presented at the wireless device using the user interface.

In accordance with another aspect of the present invention, a wireless mobile device includes a processor and computer readable memory in communication with the processor, storing virtual machine software controlling operation of the device. The virtual machine software includes a parser for receiving a text file; a screen generation engine, for presenting at least one screen at the device in accordance with the text file; an event handler for processing events arising in response to interaction with the at least one screen in accordance with the text file; and object classes corresponding to actions to be taken by the in response to interaction with the at least one screen.

A method of presenting data from an application executing at a computing device at a remote wireless device, comprising: receiving at said wireless device, a representation of a text file defining: a format of a user interface for the application at said wireless device; a format of network messages for exchange of data generated by said application; a format for storing data related to said application at said wireless device; receiving data from said application in accordance with said format of network transactions, and presenting said data at said wireless device using said user interface.

A wireless mobile device comprising: a processor; computer readable memory in communication with said processor, storing virtual machine software controlling operation of said device, said virtual machine software comprising: a parser for receiving a text file; a screen generation engine, for presenting at least one screen at said device in accordance with said text file; an event handler for processing events arising in response to interaction with said at least one screen in accordance with said text file; object classes corresponding to actions to be taken by said in response to interaction with said at least one screen.

A wireless mobile device comprising: a processor; computer readable memory in communication with said processor, storing software adapting said device to receive a representation of a text file defining: a format of a user interface for an application executing at a remote computing device, at said wireless device; a format of network messages for exchange of data generated by said application; a format for storing data related to said application at said wireless device; receive data from said application in accordance with said format of network transactions, and presenting said data at said wireless device using said user interface.

### BRIEF DESCRIPTION OF THE DRAWINGS

These and other features will become more apparent in the following detailed description of embodiments of the present invention, in which reference is made to the appended drawings wherein:

FIG. 1 illustrates an operating network environment for a device and an application design tool;

FIG. 2 schematically illustrates a middleware server of FIG. 1 including an application definitions database;

FIG. 3 schematically illustrates the formation of application definition files at the middleware server of FIG. 2;

FIG. 4 schematically illustrates a mobile device including virtual machine software of FIG. 1;

FIG. 5 further illustrates the organization of exemplary virtual machine software at the mobile device of FIG. 4;

FIG. 6 illustrates the structure of example application definitions of FIG. 1;

FIG. 7 is a further embodiment of the definitions of FIG. 6;

FIG. 8 is a block diagram of the tool for developing the applications of FIG. 1;

FIG. 9 is an example operation of simulation of the application using the tool of FIG. 8;

FIG. 10 is a block diagram of the tool architecture of FIG. 8;

FIG. 11 is an example display of the simulator module of FIG. 10;

FIG. 12 is a flow diagram illustrating the exchange of sample messages passed between a mobile device, middleware server and application server of FIG. 5;

FIGS. 13-15 illustrate steps performed at a mobile device under control of virtual machine software of FIG. 5;

FIG. 16 illustrates the format of messages exchanged in the message flow of FIG. 12;

FIG. 17 illustrates a presentation of a user interface for a sample application at a mobile device of FIG. 1;

FIG. 18 illustrates a sample portion of an application definition file defining a user interface illustrated in FIG. 17;

FIG. 19 illustrates the format of a message formed in accordance with the sample portion of an application definition file of FIG. 18;

FIG. 20A illustrates a sample portion of an application definition file defining a local storage at a mobile device of FIG. 1;

FIG. 20B schematically illustrates local storage in accordance with FIG. 20A;

FIG. 20C illustrates how locally stored data is updated by a sample message in accordance with the sample portion of an application file definition of FIG. 20A;

FIGS. 21 to 34 illustrate psuedo-code for implementing aspects of the interfaces of FIG. 9;

FIG. 35 illustrates steps performed at a mobile device under control of virtual machine software of FIG. 4;

FIGS. 36A and 36B illustrates a presentation of a user interface for a sample application at a mobile device of FIG. 4;

FIGS. 37, 38 and 39A-39B illustrate a sample portion of an application definition file defining a user interface illustrated in FIGS. 36A and 36B; and

FIG. 40 shows a block diagram of the communication between a local software and the virtual machine of FIG. 4.

### DETAILED DESCRIPTION

### Network System 8

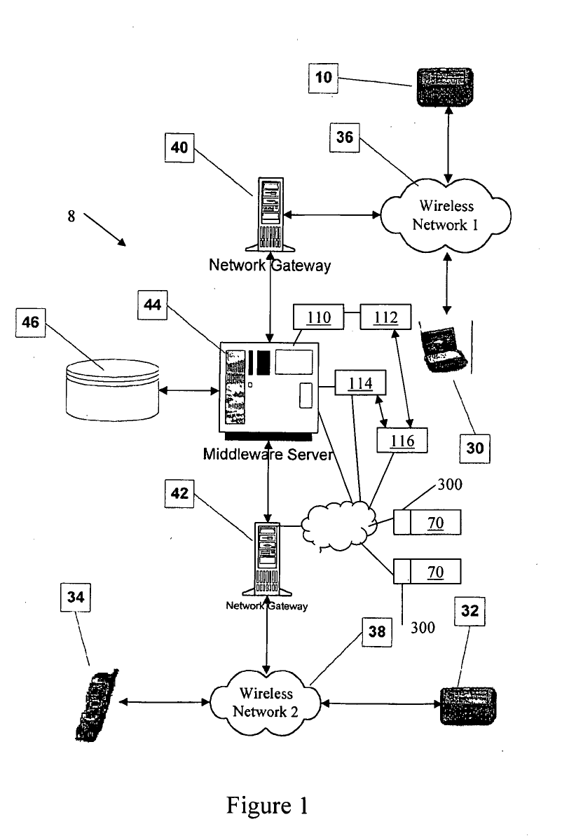

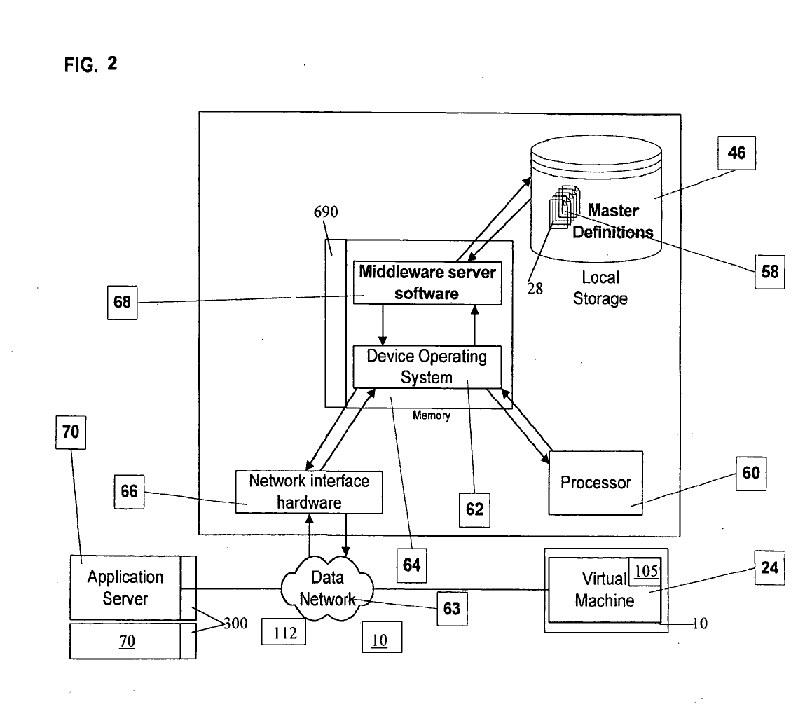

Referring to FIG. 1, a network 8 environment is shown for a mobile device 10 and an application development tool 116. The devices 10 execute applications 105 (see FIG. 2) generated by the tool 116. Further example mobile devices 30, 32 and 34 are also illustrated in FIG. 1. These mobile devices 30, 32 and 34 are similar to device 10 and also store and execute a virtual machine software 24 or other client runtime environment (see FIG. 2), further described below. The Virtual machine software 24 executes on each mobile device 10, 30, 32, 34 and can communicate with a middleware server 44 and a data source 70 through wireless networks 36 and 38 and network gateways 40 and 42, by way of example. The wireless applications 105 (see FIG. 2) are provisioned on the devices 10 and operate in the virtual machine 24, for providing interaction between the application 105 and a data source 70, as further described below. The data sources 70 communicate with the server 44 and the tool 116 via a defined interface 300 over a data network 63. The application design environment tool 116 is used to develop and test the operation of the applications 105 in conjunction with the defined interface 300, before the applications 105 are deployed to the network 8, as further described below. The network 8 can provide the example gateways 40 and 42 as a service for data access to the wireless networks 36, 38. An example of the network gateway 40, 42 is available from Broadbeam Corporation in association with the trademark SystemsGo!. The wireless networks 36 and 38 are further coupled to one or more computer data networks 63, such as the Internet and/or private data networks. Middleware server 44 is in turn in communication with the data network 63 that is coupled to the data source 70. The messaging used for network 8 communication can be via TCP/IP over an HTTP transport. As could be appreciated, other network protocols such as X.25 or SNA could equally be used for this purpose. It is recognised that the devices 10 can communicate directly with the data sources 70 via the networks 36, 38, 40, 42, 63, or in conjunction with the middleware server 44 acting as a gateway between the devices 10 and data sources 70. The following description will demonstrate communication between the devices 10 and data sources 70 via the middleware server 44, by way of example only.

Referring again to FIG. 1, the network system 8 comprises the mobile communication devices 10, 30, 32, 34, hereafter referred to using the reference numeral 10 for the sake of simplicity, for interacting with one or more backend data sources 70 (e.g. a schema based service such as web service or a database that provides enterprise services used by the application 105) via the wireless network 36, 38. The devices 10 are devices such as but not limited to mobile telephones, PDAs, two-way pagers, dual-mode communication devices. It is recognised that the middleware server 44 and data sources 70 are linked via the network 63 (e.g. the Internet) and/or intranets as is known in the art. The middleware server 44 can handle request/response messages initiated by the application 105 as well as subscription notifications pushed to the device 10 from the data sources 70, as desired. The middleware server 44 can function as a messaging server for mediating messaging between the device 10 (executing the application(s) 105) and a backend server of the data sources 70. The middleware server 44 can provide for asynchronous messaging for the applications 105 and can integrate and communicate with the legacy back-end data sources 70. The devices 10 transmit and receive, when in communication with the data sources 70, messaging associated with operation of the applications 105. The devices 10 can operate as web clients of the data sources 70 through execution of the applications 105 when provisioned on respective virtual machines 24 of the devices 10.

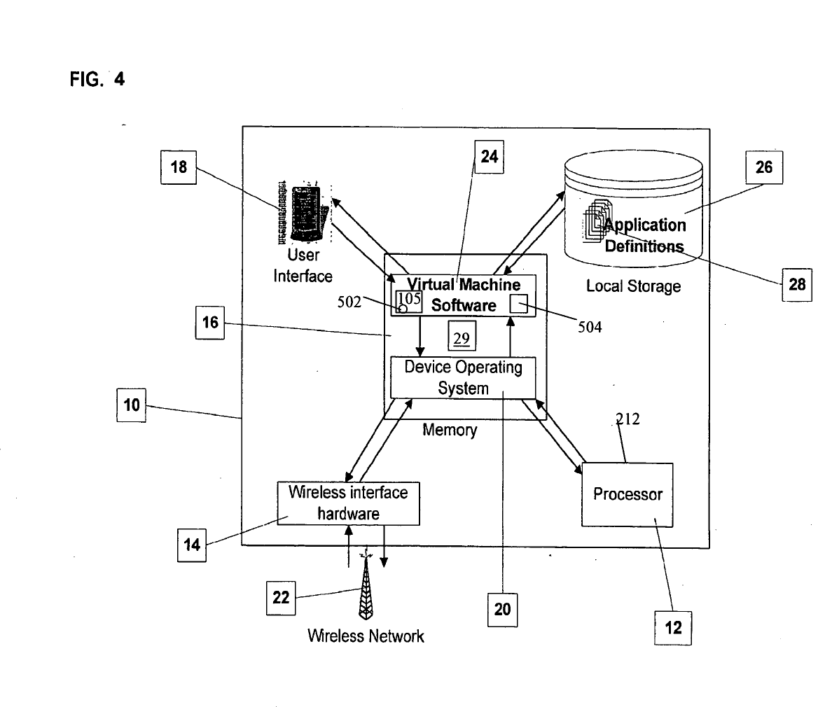

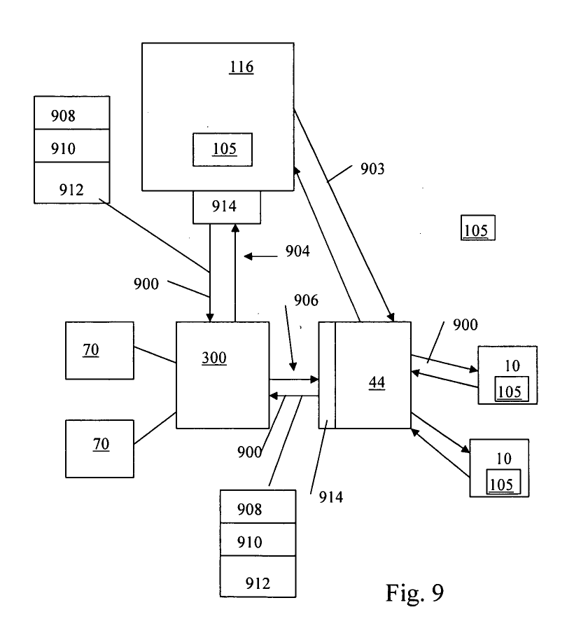

For satisfying the appropriate messaging associated with the applications 105, the middleware server 44 can communicate with the data sources 70 on behalf of the devices 10 or the devices 10 can communicate directly (not shown) with the data sources 70. In the case where the devices 10 communicate directly with the data sources 70, a communication interface 914 (similar to the interface 914 for the middleware server 44—see FIG. 9) would be part of the device operating system 20 and/or virtual machine 24 (see FIG. 4) configured for communication with the interface model 300. The messaging between the devices 10 and the data sources 70 is done through various protocols (such as but not limited to HTTP, SQL, and component API) for exposing relevant business logic (methods) to the applications 105 once provisioned on the devices 10. The applications 105 can use the business logic of the data sources 70 similarly to calling a method on an object (or a function). It is recognized that the applications 105 can be downloaded/uploaded in relation to data sources 70 via the network 36, 38, 40, 42, 63 directly to the devices 10.

For example, the middleware server 44 can be coupled to a provisioning server 108 and a discovery server 110 for providing a mechanism for optimized over-the-air provisioning of the applications 105, including capabilities for application 105 discovery from the device 10 as listed in a Universal Description, Discovery and Integration (UDDI), for example, a registry 112. The Registry 112 is a directory service where businesses can register and search for Web services (or other applications 105 associated with the data sources 70), and can be part of the Discovery Service implemented by the server 110. The registry 112 is used for publishing the applications 105. The application 105 information in the registry 112 can contain such as but not limited to a Deployment Descriptor DD (contains information such as application 105 name, version, and description) as well as the location of this application 105 in an application repository 114. The registry 112 can provide a directory for storing information about web services (as provided by the data sources 70) including a directory of web service interfaces described by WSDL, for example. Further, UDDI as a registry 112 can be based on Internet standards such as but not limited to XML, HTTP, and DNS protocols.

Referring again to FIG. 1, it is recognised there could be more than one middleware server 44 in the network 8, as desired. Once initialized, access to the applications 105 by the devices 10, as downloaded/uploaded, can be communicated via the middleware server 44 directly from the application repository 114, and/or in association with data source 70 direct access (not shown) to the repository 114.

### Middleware Server 44

Referring to FIG. 2, the devices 10 can communicate with the middleware server 44 in a number of different ways. One example is where the virtual machine software 24 at each device may query the middleware server 44 for a list of applications that a user of an associated mobile device 10 can make use of. If the user decides to use a particular application 105, the device 10 can download a text description, in the form of an application definition file 28, for the application 105 from the middleware server 44 over a network interface 66. As noted, the text description of the definition file 28 is preferably formatted using XML. In another example, the virtual machine software 24 may send, receive, present, and locally store data related to the execution of the applications 105 provisioned on the device 10 in accordance with the content of the application definition file 28 and/or send, receive, present, and locally store data in accordance with a device operating system 62 of the middleware server 44. The format of exchanged data for each application 105 is defined by the associated application definition file 28. Again, the exchanged data is formatted using XML, in accordance with the application definition file 28, as further described below.

The middleware server 44, in turn, can store text application definition files 28 for those applications 105 that have been enabled to work with the various devices 10, using the definition files 28 in a pre-defined format understood by the virtual machine software 24. Software providing the functions of the middleware server 44, in the exemplary embodiment is written in #C, using an SQL Server or MySQL database.

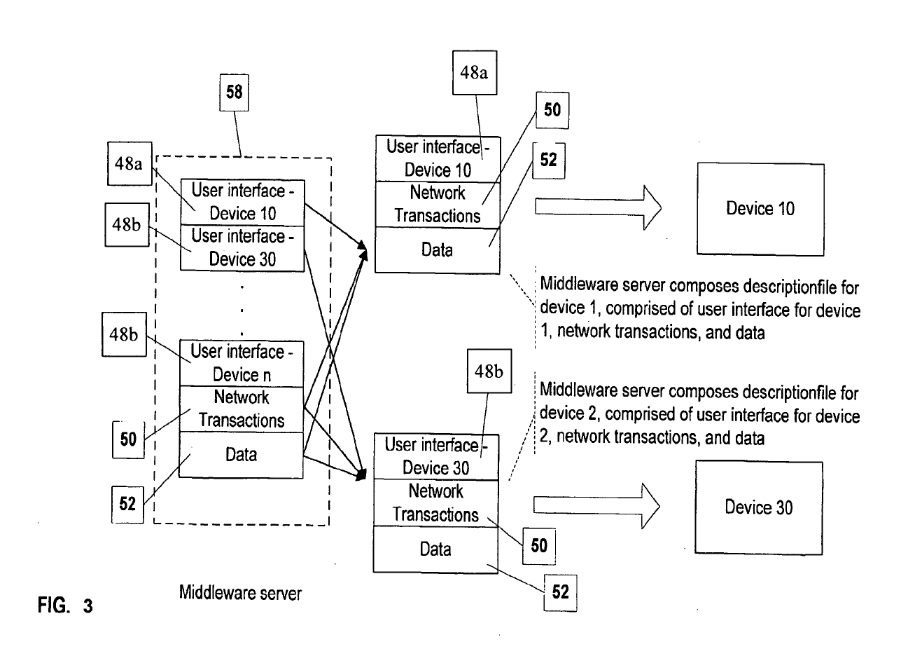

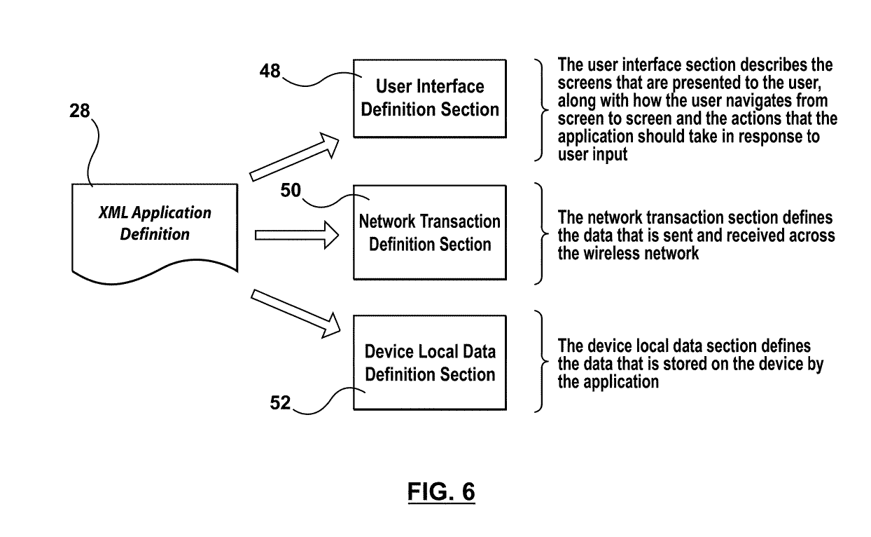

FIG. 3 illustrates the organization of a master application definition file 58 at middleware server 44, for example, and how the middleware server 44 may form an application definition file 28 (FIG. 6) for a given device 10. It is recognised that the applications 105 formed by individual ones of the definition files 28 could also be stored at the data source 70 and/or the repository 114 (and associated registry) as given above. Further, it is recognised that the applications 105 can be stored as the master definition file 58 or as a series of device 10 specific definition files 28. Typically, since network 8 transactions and local data are the same across devices 10, the only piece of the application definition file 28 that can vary for different devices 10 would be a user interface definition 48 (see FIG. 6), represented in FIG. 3 as interface version 48a and version 48b of the generic user interface definition 48.

So, for example, the middleware server 44 has access to the master definition 58 for a given server side application 105. This master definition 58 contains example user interface descriptions 48a, b for each possible mobile device 10; descriptions of the network transactions 50 that are possible and data descriptions 52 of the data to be stored locally on the mobile device 10. Preferably, the network transactions 50 and data descriptions 52 will be the same for all mobile devices 10.

For device 10, the middleware server 44 composes the application definition file 28 (for use in provisioning the corresponding application 105 on the virtual machine software 24) by querying the device type and adding the appropriate user interface description 48a for device 10 to the definitions for the network transactions 50 and the data 52. For device 30, the middleware server 44 composes the application definition file 28 by adding the user interface description 48b for device 30 to the definitions for the network transactions 50 and data 52, for example.

The master definition 58 for a given application 105 is created away from the middleware server 44 and loaded onto the middleware server 44 (or in the networked application repository 110) by administrative staff charged with deployment of the application 105 (represented as the definition file 28) to the network 8 environment. Master definition files 58 and/or definition files 28 are created by the tool 116. Such a tool 116 might generate part or all of the file 28, 58, using knowledge of the XML formatting rules and knowledge of the defined interface 300 and interface 914 (see FIG. 9) used by the data sources 70 and middleware server 44 (or tool 116) respectively.

Referring again to FIG. 2, an example organization of middleware server 44 and associated master definitions 58 with definition files 28 is shown. The middleware server 44 may be any conventional application server, modified to function in conjunction with the devices coupled to the network 8 environment. As such, middleware server 44 includes a processor 60, in communication with the network interface 66 and a storage memory 64. Middleware server 44 may be, for example, be a Windows NT server, a Sun Solaris server, or the like. Memory of middleware server 44 stores an operating system such as Windows NT, or Solaris operating system software 62. The network interface 66 enables the middleware server 44 to transmit and receive data over the data network 63. The transmissions are used to communicate with both the virtual machine software 24 (via the wireless networks 36, 38 and wireless gateways 40, 42) and one or more application servers of the data sources 70, that are the end recipients of data sent from the mobile client applications 105 and the generators of data that are sent to the mobile client applications 105 over the network 8 environment.

Memory at middleware server 44 further stores software 68 for enabling the middleware server 44 to understand and compose XML data packages (e.g. part of messages 900) that are sent and received by the middleware server 44, in response to communication between the data sources 70 and the applications 105 provisioned on the devices 10. These packages may be exchanged between middleware server 44 and the virtual machine software 24 of the devices 10, or between the middleware server 44 and the data sources 70. The communication protocol between the data sources 70 and the middleware server 44 is dependent upon the manner in which the application server of the data sources 70 is configured. For example, where the application server of the data sources 70 is configured so that it exposes a SOAP interface, communication between the application server of the data sources 70 and the transaction server 44 uses HTTP running on top of a standard TCP/IP stack. An HTTP connection between a service/application (e.g. web service) at the data source 70 and the middleware server 44 can be established in response to the application 105 messaging from the mobile device 10. The data source 70 service provides output to the middleware server 44 over this connection. The data source 70 service data is formatted into appropriate XML data packages understood by the virtual machine software 24 at the mobile device 10. This formatting can be done directly by the data source 70 service or can be done by the middleware server 44, once the data package of the data source 70 is received by the middleware server 44. It is therefore recognised that the middleware server 44 can provide translation between device 10 message formats and data source 70 message formats, as required.

That is, the middleware server 44 can format data output into XML in a manner consistent with the format defined by the application definition file 28 for the application 105. As well, knowledge of the format of data provided and expected by data source 70 (according to the defined interface 300) could also be produced by the middleware server 44 using techniques readily understood by those of ordinary skill. Accordingly, the middleware server 44 could translate XML messages and their data content from the mobile device 10 into the format understood by the data source 70 and vice a versa. The particular identity of the mobile device 10 on which the application 105 is to be presented may be identified by a suitable identifier, in the form of a header contained in the data source 70 output. This header may be used by middleware server 44 to forward the data to the appropriate mobile device 10. Alternatively, the identity of the connection could be used to forward the data to the appropriate mobile device 10.

### Example Data Source 70

Data sources 70 can be described, for example, using WSDL (Web Services Description Language) and therefore presented to the network as a service commonly referred to a web service. For example, WSDL is written in XML as an XML document used to describe Web services and to locate Web services, i.e. the XML document can specify the location of the web service and the operations (or methods) the service exposes to the network (e.g. Internet). The WSDL document defines the web service using major elements, such as but not limited to: <portType> being the operations performed by the web service (each operation can be compared to a function in a traditional programming language such that the function is resident on the web service itself); <message> being the message formats used by the web service; <types> being the data types used by the web service and being typically part of the messages themselves; and <binding> being the communication protocols used by the web service for communicating the messages between the web service and the middleware server 44. Further, a service element could be included in the WSDL document to identify the location (e.g. URL) of the web service itself and to manage the logical network connection between the middleware server 44 (for example) and the web service according to the communication protocols provided by the binding element.

The messaging between the devices 10 and the data sources 70 (preferably via the middleware server 44) can be a request-response operation type as the most common operation type, but can have other messaging operation types, such as but not limited to: One-way where the operation can receive a message but will not return a response; Request-response where the operation can receive a request and will return a response; Solicit-response where the operation can send a request and will wait for a response; and Notification where the operation can send a message but will not wait for a response. It is recognised that the interfaces 914 and 300 are configured to accommodate push (i.e. asynchronous messaging) using asynchronous messaging methods 908, 910, 912 (see FIG. 9).

### XML Transaction Message 900 Structure

Referring to FIG. 9, as noted, each XML Transaction message 900 between the data source 70 and the server 44 (or the tool 116 in the case of application simulation) adheres to a message format such as but not limited to XML standards, not only in terms of language, but also concerning the structure of the message 900 package. Each XML package composed includes package contents, which is the actual data that is being transmitted for use by the wireless device 10. Within this structure, XML packages will appear similar to the following example:

<PKG TYPE=“mytype”>(package information)</PKG>.
The middleware server 44 uses the communication interfaces 300, 914 to transfer message data between the device 10 and the data sources 70 accordingly via the messages 900 representing for example XML transactions.

The package contents include the actual data being transmitted for use by the device application 105. The content requirements of each XML package have data fields identified for the listed transactions using such as but not limited to package tags: <PKG> and </PKG>, which indicate the start and end of the package data, respectively, have only one attribute: TYPE. The TYPE field refers to a text string used to identify the type of package being sent. Contained within a data package would be the package contents, which the functionality of the data source 70 would be responsible for creating for messages 900 sent to the device 10 with embedded data. This XML formatted message 900 would be similar to the following example, which contains an example timesheet data.

<PKG TYPE=”TS”>
<TIMESHEET>
<SHEET>
<WEEKNO>{week number}</WEEKNO>
<APPROVER>{approver}</APPROVER>
</SHEET>
<DETAILS>
<LINE WEEKNO={week number}
ACTCODE={activity code}
MON={hours for monday}
TUES={hours for tuesday}
WEDS={hours for wednesday}
THUR={hours for thursday}
FRIDAY={hours for friday}
SAT={hours for saturday}
SUN={hours for Sunday}></LINE>
</DETAILS>
</TIMESHEET>
</PKG>

### Communication Interface Model 300

The interface model 300, referring to FIG. 9, can be exposed by a number of network 8 environment communication formats, such as but not limited to COM, .NET, .NET Remoting and/or SOAP. It is noted that the interface model 300 and the communication interface 914 represent a framework for communication between the tool 116 and/or the middleware server 44 with the data sources 70. For example, the interface model 300 and interface 914 can be used to push messages 900 (e.g. representing device 10 and/or tool 116 communications) to the data source 70 as well as push (i.e. asynchronous) messages 900 (e.g. representing data source 70 communications) to the devices 10 and/or to the tool 116. Further, it is recognised that the interface model 300 could also be used to pull information by the device 10 from the data source 70 and/or pull by the data source 70 from the device 10. It is recognised that the middleware server 44 and the tool 116 are configured through the communication interface 914, as further described below, to communicate the asynchronous messages 900 directly with the data sources 70 via the interface model 300.

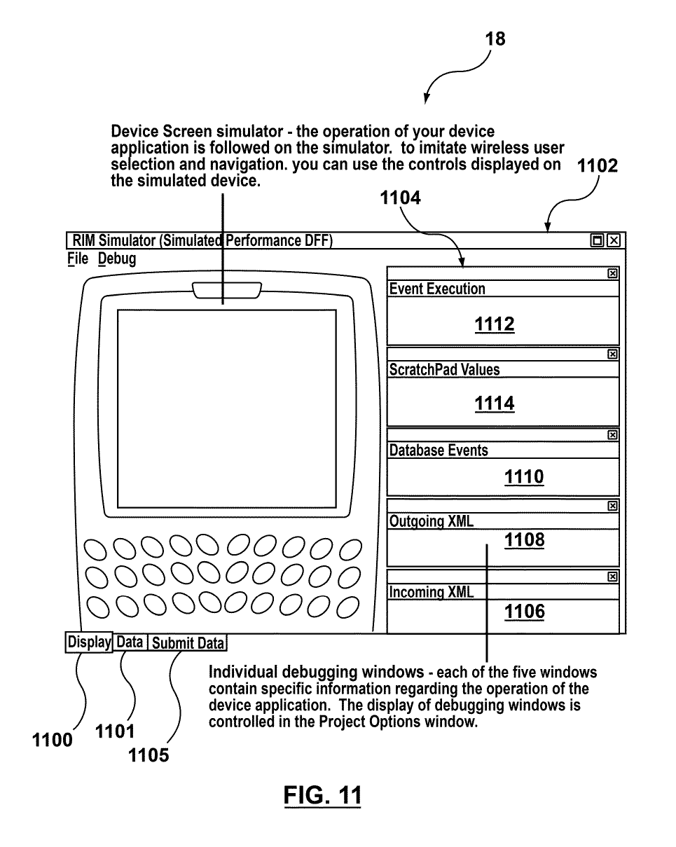

The tool 116 can simulate the communication messages 900 with the data sources 70 in two example ways, communication with the enterprise application of the data source 70 or through a “wrapper program”. In either case, the tool 116 can talk to the enterprise application of the data source 70 over the network 8 environment through network link 904, or the tool 116 sends and receives XML Transaction messages internally (i.e. no external messages 900 are sent over the network 8 environment). In both cases the interface model 300 in conjunction with the communication interface 914 are used to provide for communication formats for the messages 900, either internally to the tool 116 or externally between the tool 116 and the data sources 70 over the network 8 environment. Referring again to FIG. 11, there is a “Submit” tab 1105 that is available on the simulator interface 1102. This tab 1105 provides for the developer to paste XML into the input area of the interface 1102 and then submit it to the device 10 just as though it came externally from the data source 70 over the network 8 environment. Further, the tool 116 can simulate the interface 914 (e.g. SOAP) of the middleware server 44 using a very basic server through a simple API (see Appendix B).

There are methods exposed in the interface model 300 such as but not limited to:

ReceiveData method 908—called when data and associated message 900 that was sent by the mobile device 10 (or emulated device 10 by the simulator module 629) has arrived at the interface model 300;

DeliveryError method 910—called when the device 10 rejects the message 900 sent from the data source 70; and

DeliveryNotify method 912—called when the message 900 is successfully delivered to the mobile device 10 (or emulated device 10 by the simulator module 629).

Included below are examples on how to implement the interface model 300 in such as but not limited to Visual Basic, Delphi, C# and Java. Also included with these examples are the “.tlb” file for implementation in COM, the .NET (.NET Remoting) Assembly for implementation in C# or VB.NET, and sample SOAP interface files for the describing the interface model 300. The methods 908, 910, 912 that are exposed in the interface model 300 for use by the data sources 70, the middleware server 44, and the tool 116 are given below.

### Receive Data Method 908

This method will be called via the interfaces 300, 914 when the message 900 is sent from the mobile device 10 arrives at the server 44 to be processed by the data source 70, such as but not limited to:

{COM}—public ReceiveData ([in] appID:long, [in] mobileID:BSTR, [in] data:BSTR): [out] BOOL;
{.NET}—public ReceiveData ([in] appID:System.Int32, [in] mobileID:System.String, [in] data:System.String): [out] System.Boolean; and
{SOAP}—public ReceiveData ([in] appID:(xsd:int), [in] mobileID:(xsd:string), [in] data:(xsd:string)): [out] (xsd:boolean).

The method 908 is where the application logic of the data source 70 is placed to handle XML transaction data received from the mobile devices 10. The parameters listed above are such as but not limited to: appID —integer numeric identifier for the application 105 by the middleware server 44; mobileID —string value representing a mobile device 10 identifier; and data—string value representing the data that was sent from the mobile device 10. The return value of this push method 908 is configured for being implemented and to return a BOOLEAN value by way of example. A TRUE return value for example would signify that the data in the transaction message 900 has successfully been delivered to the data source 70 interface. The return value should not be used to specify if the data source 70 successfully processed the received transaction message 900. If the message 900 returned from the interface model 300 returns FALSE then the middleware server 44 will continue to send the data source 70 the same transaction message 900 until the data source 70 returns a TRUE value. Therefore, the data source 70 would not receive the next transaction message sent from the mobile device 10 until the data source 70 returns a TRUE value in accordance with the method 908. It is recognised that the method 908 can be used for network 8 environment communication between the server 44 and the data source 70 or between the data source 70 and the tool 116.

### Delivery Error Method 910

This method 910 will be called via the interfaces 300, 914 when the message 900 sent from the data source 70 is rejected by the mobile device 10. The most common reason for rejection could be that the device 10 does not yet have the application 105 that the message 900 is destined for registered on their device 10. Or the device 10 may have switched hardware.

{COM}—public AIRIXDeliveryError ([in] appID:long, [in] mobileID:BSTR, [in] data:BSTR, [in] errorcode:long, [in] errorDescription:BSTR): [out]BOOL;
{.NET}—public AIRIXDeliveryError ([in] appID:System.Int32, [in] obileID:System.String, [in] data:System.String, [in] errorCode:System.Int32, [in] rrorDescription:System.String): [out]System.Boolean; and
{SOAP}—public AIRIXDeliveryError ([in] appID:(xsd:int), [in] mobileID:(xsd:string), [in] data:(xsd:string), [in] errorCode:(xsd:int), [in] errorDescription:(xsd:string)): [out](xsd:boolean).

This push method 910 is where the data source 70 can optionally place application logic to handle data rejections from mobile devices 10.

The parameters of the method 910 are as follows:

appID —integer numeric identifier for the application 105;

mobileID —string value representing the mobile device 10 identifier;

data—string value representing the data that was originally sent to the device 10 from the data source 70 which was rejected;

errorCode—integer value representing the error that caused the rejection; and

errorDescription—string value representing the error that caused the rejection.

The Return Value of this method 910 when implemented returns a BOOLEAN value. A TRUE return value signifies that the data in the transaction message 900 has successfully been delivered to you're the data source 70. The return value does NOT specify if the data source 70 successfully processed the transaction message 900. If the return value returns FALSE then the middleware server 44 will continue to send the data source 70 the same transaction message 900 until the data source 70 returns TRUE. Therefore, the data source 70 will not receive the next transaction message 900 sent from the mobile device 10 until the data source 70 returns from the interface model 300 a TRUE value in response to the method 910. It is recognised that the method 910 can be used for network 8 environment communication between the server 44 and the data source 70 or between the data source 70 and the tool 116.

### Delivery Notify Method 912

This method 912 is called via the interfaces 300, 914 when the message sent from the data source 70 is successfully received by the mobile device 10.

{COM}—public AIRIXDeliveryNotify ([in] appID:long, [in] mobileID:BSTR, [in] data:BSTR): [out] BOOL;
{.NET}—public AIRIXDeliveryNotify ([in] appID:System.Int32, [in] mobileID:System.String, [in] data:System.String): [out] System.Boolean; and
{SOAP}—public AIRIXDeliveryNotify ([in] appID:(xsd:int), [in] mobileID:(xsd:string), [in] data:(xsd:string)): [out] (xsd:boolean).

This is where the data source 70 can optionally place their application logic to handle delivery notifications from mobile devices 10. While this method 912 is implemented, it is up to the developer on if they want to implement any logic on this notification with respect to application 105 operation on the device 10.

Parameters for this method are as follows:

appID —integer numeric identifier for the application 105;

mobileID —string value representing the mobile device 10 identifier; and

data—string value representing the data that was originally sent to the device 10 from the data source 70 which has successfully been received by the device 10.

The Return Value of this method 912 when implemented returns a BOOLEAN value. A TRUE return value signifies that the data in the transaction message 900 has successfully been delivered to the data source 70, however does NOT specify if the data source 70 successfully processed the transaction message 900. If the interface model 300 of the data source 70 returns FALSE then the middleware server 44 will continue to send the data source 70 the same transaction message 900 until the data source 70 returns TRUE. Therefore, the data source 70 will not receive the next transaction message 900 sent from the mobile device 10 until the data source 70 returns a TRUE value. It is recognised that the method 912 can be used for network 8 environment communication between the server 44 and the data source 70 or between the data source 70 and the tool 116.

### Server/Tool Interface 914

Referring to FIG. 9, the flow of data between the middleware server 44 and the data sources 70 can be improved if the transaction server (e.g. the middleware server 44) can push XML packages 9 e.g. messages 900) to the application server of the data sources 70, rather than only sending packages when polled. To provide for this, the data sources 70 implement the exposed interface 300 which acts as a destination for incoming messages 900 from one or more applications 105 via the server 44. The interface 300 is constructed as a listening interface which can process any package messages that the interface 300 receives for forwarding on to the respective data source 70 coupled to the application 105 related to the message 900. Suitable communication protocols to expose the interface 300 are Component Object Model (COM), Distributed COM, Simple Object Access Protocol (SOAP), .NET, and .NET Remoting. The interface 300 itself is constructed (in any suitable language, such as Visual Basic, Delphi, C#, or Java) so that it will process any package messages 900 the interface 300 receives.

The interface 300 is configured to operate with the interface 914 exposed by the server 44 and the tool 116. It is recognised that the interface 914 of the tool 116 may or may not employ queuing as is preferably employed by the middleware server 44. The middleware server 44 queues messages 900 received from mobiles 10 that are intended for a given data source 70 on a queue, for example a first-in-first-out (FIFO) queue. Each time a new message 900 for the given data source 70 arrives, the middleware server 44 queues it, endeavours to obtain a lock on the exposed interface 300 through the interface 914, then dequeues and logs the first message 900 on the queue and pushes it to the interface 300. Dequeuing, logging, and pushing continues until the queue is empty or until a push message 900 fails. A push message 900 is judged to have failed if the application server of the data source 70 returns a response message 900 indicating the push message 900 failed or if any communications protocol layer generates a time-out failure in conjunction with a push attempt. If the push of a given message 900 fails, the logged copy of the message 900 can be rolled back to the front of the queue and the dequeuing and pushing operation can be aborted. Once dequeuing and pushing ceases, either due to the queue being emptied or the operation being aborted, the lock on the exposed interface 300 of the data source 70 is released.

It is recognised that the use of queue 690 by the emulated interface 914 of the tool 116 is optional. For example, the queue 690 may not be included as part of the emulated interface 914 of the tool 116. For example, for testing/simulation of a single one of the application 105, queuing of messages 900 may not be necessary and therefore sequential (e.g. one at a time) simulation of the messages 900 may be utilized by the tool 116 (i.e. use of multiple messages 900 communicated between the interface 300 and the interface 914 on behalf of the simulated application 105 may not be necessary for application 105 simulation by the tool 116). However, it is also recognised that the tool 116 can take advantage of the queue 690 (where included in the simulated interface 914 or otherwise used) and the associated dequeuing, logging, and locking/delocking features (for example), if desired by the developer when using the tool 116.

While dequeuing and pushing to the given data source 70 recommences upon the queuing of each new message for the given data source 70, since messages to the data source 70 may be only sporadically received, the transaction server 44 can also re-initiate de-queuing and pushing after a retry interval. Further details of the interface 914 and associated methods 908, 910, 912 are found in the section Example Interface 914, given below.

Referring to FIG. 9, it is recognised that the object classes 29 COULD communicate with external software 500, but the classes 29 does not HAVE to. Object classes 29 could also contain logic themselves, for example. The following are examples of each of the above described scenarios.

The first scenario is where the object classes 29 implement logic themselves (for example the class logic would calculate the area described by the supplied coordinates of the message 506). In this example case, the object class 29 is instantiated as an object 29′. The Process method is called against the instantiated object 29′. The input string 506 is XML containing four x, y co-ordinates. The instantiated Object 29′ would perform the math to calculate the area embodied by the four co-ordinates. The instantiated Object class object 29′ would return the area in the output string of the message 508. Further, it is recognised that the object class 29 (i.e. interface component) could be part of the operating system 20 of the device 10.

The second scenario is where the object class 29 acts as a proxy to GPS software 500 (this example retrieves the current GPS coordinates of the device 10). The object class 29 is instantiated through the corresponding interface 129. The Process method is called against the instantiated object and thus forwarded to the interface 129. The input string 506 could be a blank string. The instantiated object would call, for example, the GetCurrentCoordinates method against the existing GPS software 500. The implementation of this interaction between the instantiated Object class interface 129 and the GPS software 500 is left to the designer/developer. The instantiated Object interface 129 would receive the return value from the GPS software 500, package the value into a meaningful (to the application 105) string format and return it via the output string message 508.

### Device 10

Referring to FIG. 4, an example architecture of the mobile devices 10 is shown. The mobile device 10 may be any conventional mobile device 10, modified to function in conjunction with the network 8 environment. As such, the mobile device 10 includes a processor 12, in communication with a network interface 14, storage memory 16, and a user interface 18 typically including a keypad and/or touch-screen. The computer processor 12 manipulates the operation of the network interface 14, the user interface 18 and a display by executing related instructions, which are provided by an operating system 20 and the executing application application 105. The network interface 14 is coupled to the processor 12 and enables the device 10 to transmit and receive data over the wireless network 36, 38. The mobile device 10 may be, for example, be a Research in Motion (RIM) two-way paging device, a WinCE based device, a PalmOS device, a WAP enabled mobile telephone, or the like. The memory 16 of device 10 stores a mobile operating system such as the PalmOS, or WinCE operating system software 20. Operating system software 20 typically includes graphical user interface 18 and network interface 14 software having suitable application programmer interfaces (“API”s) for use by other applications executing at device 10. The user interface 18 can include one or more user input devices such as but not limited to a keyboard, a keypad, a trackwheel, a stylus, a mouse, a microphone, and is coupled to a user output device such as a speaker (not shown) and a screen display. If the display is touch sensitive, then the display can also be used as the user input device as controlled by the processor 12. The user interface 18 is employed by the user of the device 10 to interact with the application 105 executing on the virtual machine 24.

Memory 16 at device 10 further stores virtual machine software 24 for enabling device 10 to present an interface for the applications 105 provided, for example, by the middleware server 44. Specifically, the virtual machine software 24 interprets the text application definition file 28 defining: the user interface 18 controlling application 105 functionality, and the display format (including display flow) at device 10 for a particular application 105; the format of data to be exchanged over the wireless network 36, 38 for the application 105; and the format of data to be stored locally at device 10 for the application 105. The virtual machine software 24 uses the operating system 20 and associated APIs to interact with device 10, in accordance with the received application definition file 28. In this way, the device 10 may present interfaces on the display for a variety of the applications 105 enabled for interaction with selected data sources 70. Moreover, multiple wireless devices 10 each having similar virtual machine software 24 may use a common data source 70 in combination with the application definition file 28, to present the corresponding user interface screens and program flow specifically adapted for the device 10. Further, it is recognized that the device 10 can include a computer readable storage medium 212 coupled to the processor 12 for providing instructions to the processor 12 and/or to load the applications 105 also resident (for example) in the memory module 16. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid state memory card, or RAM provided in the memory module 16. It should be noted that the above listed example computer readable mediums 212 can be used either alone or in combination. Further, it is recognised that the definition files 28 could be stored in the memory 16 or in a designated application definition file memory 26, as desired.

As such, and as will become apparent, the exemplary virtual machine software 24 is specifically adapted to work with the particular mobile device 10. Thus if device 10 is a RIM pager, virtual machine software 24 is a RIM virtual machine. Similarly, if device 10 is a PalmOS or WinCE device, virtual machine software 24 would be a PalmOS or a WinCE virtual machine. As further illustrated in FIG. 4, virtual machine software 24 is capable of accessing local storage 26.

Other applications, libraries, and software, hereafter referred to as local software 500 considered separate from the virtual machine 24 and the provisioned applications 105, may also be present within memory 16 or local storage 26. For example, device 10 may store and execute personal information management (PIM) software 500, including calendar and contact management applications 500. Similarly, device 10 could store and execute software 500 allowing device 10 to perform a number of functions. Software 500 could, for example such as but not limited to, interact with the hardware of the device 10 to allow device 10 to act as a multimedia player; allowing device 10 to print; allowing device 10 to interact with other incorporated hardware not specifically illustrated, including but not limited to a Bluetooth interface; a Global Positioning Satellite (GPS) Receiver; and the like. In the depicted embodiment, memory 16 stores interface components 29, for example in the form of object classes 29, that may be used to extend the functionality of virtual machine software 24. This extension of functionality can provide for internal communication (i.e. not over the network 8) between the virtual machine 24 and the software 500 (for example ultimately between the provisioned applications 105 and the software 500). As will become apparent, these interface components in the form of object classes 29 allow virtual machine software 24 to become extensible so as to provide for the virtual machine 24 to call and/or otherwise interact with the local software 500. Object classes 29 may, for example, allow virtual machine software 24 to access additional hardware or software 500 local to device 10.

As detailed below, an exemplary application definition file 28 may be formed using a markup language, such as but not limited to XML. Defined XML entities of the definition file 28 are understood by the virtual machine software 24. Defined XML entities are detailed in Appendix “A”, hereto. The defined XML entities are interpreted by the virtual machine software 24, and may be used as building blocks to provision the application 105 at mobile device 10, so as to generate and operate an executable version of the definition file 28 as the application 105.

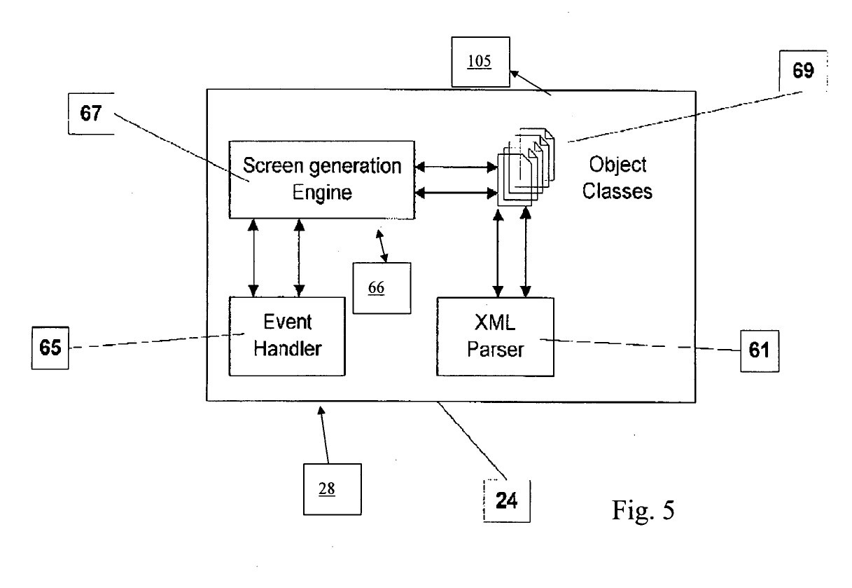

Specifically, as illustrated in FIG. 5, virtual machine software 24 includes a conventional XML parser 61; an event handler 65; a screen generation engine 67; and object classes 69 corresponding to XML entities supported by the virtual machine software 24, and possibly contained within an application definition file 28. Supported XML entities are detailed in Appendix “A” hereto enclosed. A person of ordinary skill will readily appreciate that those XML entities identified in Appendix “A” are exemplary only, and may be extended, or shortened as desired.

XML parser 61 may be formed in accordance with the Document Object Model (DOM), for example, available at http://www.w3.org/DOM/, the contents of which are hereby incorporated by reference. Parser 61 enables virtual machine software 24 to read the application description file 28, once received by the device 10. Using the parser 61, the virtual machine software 24 may form a binary representation (i.e. the application 105), for example, of the application definition file 28 for storage at the mobile device 10, thereby eliminating the need to parse text each time the corresponding application 105 is used. The parser 61 may convert each XML tag contained in the application definition file 28, and its associated data to tokens and/or java byte code, for later processing during execution of the application 105 by the virtual machine software 24 or other capabilities of the device 10 resources. As will become apparent, the conversion of the definition file 28 contents to the tokenized/byte code representation may avoid the need to repeatedly parse the text of an application definition file 28.

Screen generation engine 67 displays initial and subsequent screens at the mobile device, in accordance with an application description file 28, as detailed below. The event handler 65, of virtual machine software 24 allows device 10 under control of virtual machine software 24 to react to certain external events. Example events include user interaction with presented screens or display elements, incoming messages received from a wireless network, or the like. Object classes 69 define objects that support the device 10 to process each of the supported XML entities at the mobile device 10. Each of object classes 69 includes attributes used to store parameters defined by the XML file 28, and functions allowing the contained XML entities to be processed at the mobile device 10, as detailed in Appendix “A”, for each supported XML entity. So, as should be apparent, supported XML entities are extensible. Virtual machine software 24 may be expanded to support XML entities not detailed in Appendix “A”. Corresponding object classes could be added to virtual machine software 24, as desired.

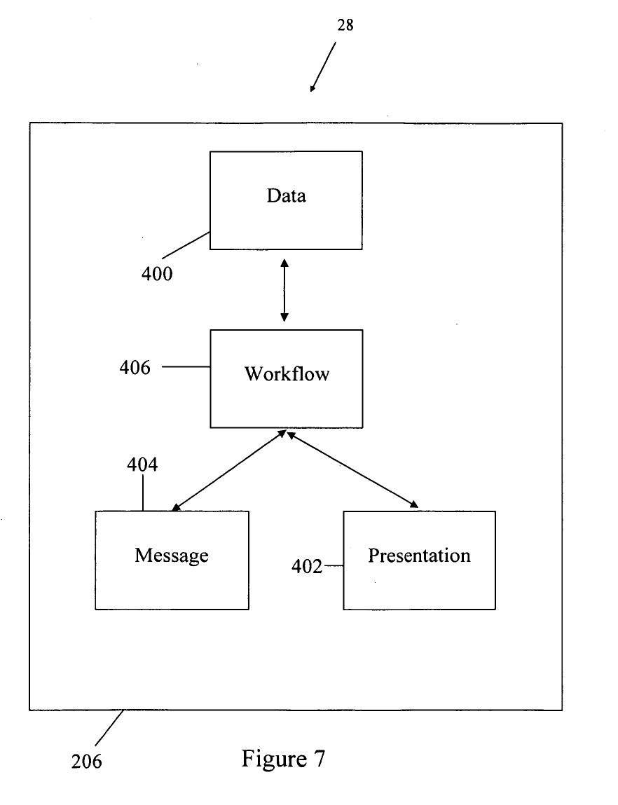

As detailed below, upon invocation of a particular application at mobile device 10, the virtual machine software 24 presents an initial screen on the user interface 18 based on the contents of the application definition file 28. Screen elements are created by the screen generation engine 67 by creating instances of corresponding object classes for defined elements, as contained within object classes 69. The object instances are created using attributes contained in the application definition file 28. Thereafter the event handler 65 of the virtual machine software 24 reacts to actions/events for the application 105. Again, the event handler 65 consults the contents of the application definition file 28 for the application 105 in order to properly react to events. Events may be reacted to by creating instances of associated “action” objects, from object classes 69 of virtual machine software 24. Further, it is recognised that events/actions related to the XML definitions of screens, data, and messages can be coordinated by workflow elements 406 (see FIG. 7) expressed in a scripting language, in addition to or as an alternative to the event handler 65. In this case, these workflow elements 406 could also be part of, or associated with, the definition file 28 for processing on the device 10 by a script interpreter 66, for example.

Similarly, object classes 69 of virtual machine software 24 further include object classes corresponding to data tables and network transactions defined in the Table Definition and Package Definition sections of Appendix “A”. At run time, instances of object classes corresponding to these classes are created and populated with parameters contained within application definition file 28, as required.

Using this general description, persons of ordinary skill in the art will be able to form virtual machine software 24 for any particular device 10. Typically, virtual machine software 24 may be formed using conventional object oriented programming techniques, and existing device libraries and APIs, as to function as detailed herein. As will be appreciated, the particular format of screen generation engine 67 and object classes 69 will vary depending on the type of virtual machine software 24, its operating system and API available at the device 10. Once formed, a machine executable version of virtual machine software 24 may be loaded and stored at a mobile device 10 (including downloading from the network 36, 38, using conventional techniques. It can be embedded in ROM, loaded into RAM over the network, or from the computer readable medium 212. Although, in the preferred embodiment the virtual machine software 24 is formed using object oriented structures, persons of ordinary skill will readily appreciate that other approaches could be used to form suitable virtual machine software 24. For example, the object classes forming part of the virtual machine 24 could be replaced by equivalent functions, data structures or subroutines formed using a conventional (i.e. non-object oriented) programming environment. Operation of virtual machine software 24 under control of an application definition file 28 containing various XML definitions exemplified in Appendix “A”, is further detailed below.

As so far described, in particular in section Operation of the Application 105 set-up and Device Communication given below, operation of virtual machine software 24 is limited by those object classes 69 forming part of virtual machine software 24. However, the interface components 29 (e.g. the object classes 29), for example not forming part of virtual machine software 24, are further loaded within memory 16 of device 10. The interface components 29 can be loaded in the memory 16 of the device 10 in response to known capabilities of the definition file 28. For example, if the definition file 28 contains INTEGRATION tags (e.g. a handler definition 502) configured for calling applications/software 500 external to the application 105 (when provisioned in the virtual machine 24) then the appropriate classes 29 could be uploaded to the device 10 (for example from the server 44) as an accompaniment to the XML descriptors of the definition file 28. These classes 29 would enable the applications 105 to take advantage of potential software 500 located locally in the memory 16 of the device 10. Conveniently, the object classes 29 may be created by a user (or administrator) of device 10 and therefore may not have to rely on access to the source code for virtual machine software 24. It should be recognised that communication interfaces 129 (e.g. optional instantiated object interfaces 129 of the classes 29) can provide for inter-application 105, 500 communication on the device 10 external to the network 8 environment. For example, the software 500 can be applications not derived from definition files 28, however the definition file 28 contains the handler definition 502 for calling the interface component 29 that coordinates access to the software 500 local to the device 10 through the interface 129.

The virtual machine software 24 includes a software code portion 504 (e.g. communication service) that instantiates identified ones of object classes 29, as called by the handler definition 502 of the application 105, and the called class 29 then executes methods through the interface 129 for effecting communication between the application 105 and the software 500 resident on the device 10. The software 500 is typically external to the virtual machine 24 and associated applications 105 provisioned from definition files 28. As such, the virtual machine software 24 may be extended through the addition of additional object classes 29, so as to allow the applications 105 and the virtual machine 24 itself to communicate with the software 500 through the interface 129.

Although, in the preferred embodiment the virtual machine software 24 and object classes 29 (for forming the communication interfaces 129) are formed using object oriented structures, persons of ordinary skill will readily appreciate that other approaches could be used to form suitable virtual machine software 24 and object classes 29. For example, object classes 69 forming part of the virtual machine 24 could be replaced by equivalent functions, data structures or subroutines formed using a conventional (i.e. non-object oriented) programming environment. Object classes 29 could be similarly replaced with other software components in the form of libraries, sub-routines, programs, combinations thereof, or the like.

### Inter-Application Interface Components 29

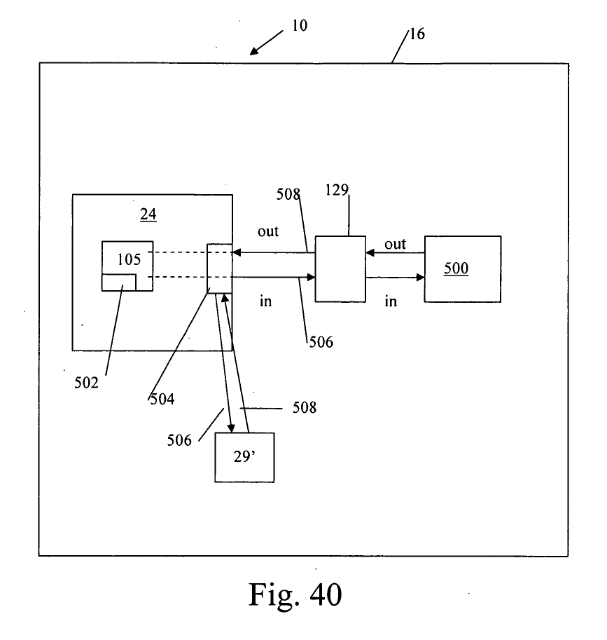

Referring to FIG. 40, an INTEGRATION tag (i.e. handler definition 502) of the definition file 28 (incorporated in the application 105 as provisioned) takes as arguments, the name of an external one of classes 29 to be instantiated assigned to CLSID=class_name, for example, and the name of a local variable, returnvar, used by virtual machine software 24 in which results passed by the execution of the software 500 should be stored. As well, the value assigned to SAVE may be boolean and specify whether or not the data returned by the instantiated class 29 should be saved. The request message 506 from the virtual machine 24 is passed to the external software 500, which then returns a response message 508 to the communication interface 129 which is then passed to the service 504 and eventually, for example associated with the handler definition 502 that originally called for the software 500.

For example, class_name identifies one of classes 29 by name. The name of the class is assigned as described below. For example, the name of the local variable corresponds to the name of a variable associated with the handler definition 502 defined in section 52 of the application definition 28. Finally, the contents of the ACTION element (i.e. my input text) is passed to the instantiated one of classes 29, as detailed below.

The exact way in which external accessible objects 129 (associated with the classes 29) are formed and may be accessed by virtual machine software 24 will typically depend on the operating system software 20 of device 10 in association with which virtual machine software 24 is executing. Virtual machine software 24 should, however, be able to identify the external object class 29 and instantiate it. Optionally, virtual machine software 24 should be able to verify that the external object class 29 has the interface 129 that conforms to virtual machine software 24. For example, for virtual machine software 24 written and executing in a WindowsCE environment, object classes 29 can be developed using the component object model (COM). The component object model (COM) is described at http://msdn.microsoft.com/library/default.asp?url=/library/en-us/dnanchor/html/componentobjectmodelanchor.asp and D. Box, Essential COM, (1997: Addison-Wesley Professional) ISBN: 0201634465, the contents of which are hereby incorporated by reference. It is recognised that object classes 29 are definable using COM, for interpretation then by the service 504 and the external software 500 so as to coordinate the sending and receiving of the messages 506, 508.

Briefly, for completeness, object classes 29 developed using COM are registered with the WindowsCE operating system 20. The operating system 20 maintains a list of the COM objects that have been created. Additionally, object classes 29 developed in accordance with the COM include one or more defined interfaces 129. Other operating systems 20 executing on mobile devices 10 expose classes 29 that may be accessible by virtual machine software 24 in different ways. For example, RIM and PalmOS operating systems 20 expose various PIM object stores as Java Classes or C++ classes 29. A person of ordinary skill will readily appreciate how such classes 29 may be used by virtual machine software 24 created for such an operating system 20. It is recognised however that the definition file 28 should contain handler definitions 502 so as to help coordinate the workflow of the executing application 105 via the service 504 and the classes 29 when access to external software 500 is desired.

Object classes 29 written in accordance with the COM may register their name with the underlying operating system 20, and further include the interface 129. In the preferred embodiment, the interface 129 takes a name known by virtual machine software 24. For example, the interface 129 of the class 29 may take the name IAIRIXIntegrationPoint. In the preferred embodiment the interface 129 defines a function with name HRESULT that takes parameter hWndParent, InputString, and OutputString. Variables InputString (i.e. message 506), and OutputString (i.e. message 508) are populated by values passed to and from the virtual machine software 24 identifying attributes of the string SAVE_NAME.

The value of hWndParent identifies the main window generated by virtual machine software 24 as a result of the application definition file 28 instantiating the object class 29. The value may be used by the method of the instantiated class 29 to embed controls on or as a parent window to sub windows that the method creates as per application 105 execution. To summarize, the interface 129 of the class 29 takes the form, such as but not limited to:
interface IAIRIXIntegrationPoint: IDispatch
{[id(1), helpstring(“method Process”)] HRESULT Process(VARIANT hWndParent, BSTR InputString, BSTR* OutputString);}.

As will be appreciated, IDispatch signifies a standard COM interface; id(1) signifies that the method Process is listed as the first method exposed on the interface 129; and helpstring may be used by a debugging tool, for example associated with the tool 116. The method Process (e.g. the software 500), in turn, performs the function to be implemented by the external object class 29 to perform the functionality of the software 500 desired by the application 105, thus extending the functions performed by virtual machine software 24 and related applications 105. For example, method “Process” could provide the interface 129 (optional) to other object classes 29, or hardware at device 10. The method “Process” could for example gather a signature, a fingerprint, GPS co-ordinates, or virtually any other function that can be performed by device 10. Conveniently, the method “Process” may make use of the string data (of message 506) contained as my input text and forming part of the XML element giving rise to the instantiating of the class 29.

Upon completion of the method, results should be formatted by the method and placed in the variable OutputString (e.g. message 508), so the results may be passed back to virtual machine software 24 (and the requesting application 105) through the interface 129 (optional) for further processing. In the exemplary embodiment, the content of OutputString is XML formatted, so that it may be easily further processed by machine software 24 (or alternatively middleware server 44).

The value of Process returned by the method call may identify successful execution of the method. In response to an error code, virtual machine software 24 may log an error and report that error to the user of device 10 through a standard error message dialog. As will be apparent, the name of each class 29 is identified in the PROGID variable used as each class 29 is created and will be registered in accordance with COM, for example.

### Operation of the Interface Components 29

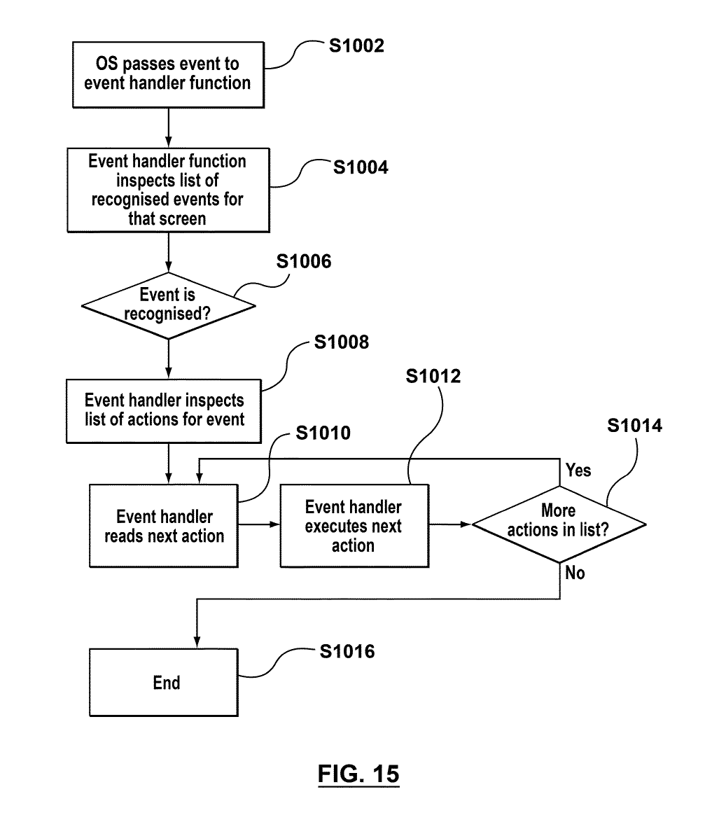

Referring to FIG. 35, in particular, if the NAME tag associated with the action identifies INTEGRATION tag (e.g. the handler definition 502), virtual machine software 24 performs steps S1100, as a result of executing the next action in step S1012 of FIG. 15. As illustrated, virtual machine software 24 compares the value provided to the CLSID variable to the names of accessible classes 29 preferably not forming part of virtual machine software 24.

In step S1102, virtual machine software 24 queries the list of available accessible object classes. If objects classes 29 were created using COM, as detailed above, this is accomplished by querying the WindowsCE registry. If an object class 29 corresponding to the class identified in the CLID (i.e. CLID=class_name) variable is found as determined in steps S1104, the class 29 is queried in step S1106, to verify that the class 29 indeed extends virtual machine software 24 to access the software 500 as determined by the class 29 associated with the handler definition 502. Querying may be accomplished by querying the class 29 to determine if it provides the interface 129 (optional) expected by virtual machine software 24. Specifically, the class 29 may be queried to determine if it has the interface 129 having a chosen name or type. The interface 129 may be queried using the COM method QueryInterface( ). In the example the object class 29 is queried to locate the interface 129 having the name IAIRIXIntegrationPoint. If the class 29 does not have the interface 129 (i.e. there is no software 500 corresponding to the handler definition 502 as identified by the executing application 105, the INTEGRATION action is terminated by machine software 24 and an error message could optionally be generated (i.e. the user of the device 10 may be shown an error screen on the user interface 18 indicating that the requested method (software 500) is not available).

If the class 29 has the interface 129 (optional), the class 29 is instantiated in step S1110 and a method having a chosen name (i.e. Process software 500) is executed by virtual machine software 24 in step S1112. Parameters hWndParent and the input and output strings formed (i.e. my input text, returnvar passed to variable SAVENAME) part of the tag and XML element are passed to the method. As noted, the actual function of the method is entirely determined by the author of the class, and not the provider of virtual machine software 24. Upon completion of the executed method, the results of the method are passed back to virtual machine software 24, by assigning the result to the variable OutputString. If the SAVE variable is set to true, the results returned by the method can be stored in the variable identified assigned to the SAVENAME variable in step S1114. If the identified class does not include the expected interface 129 as determined in step S1108, the INTEGRATION action is terminated. Again, an error message could be generated as described above.

Conveniently, once data returned by the method call the data is stored locally in the variable defined in application definition 28 (according to the handler definition 502) and then becomes otherwise accessible by virtual machine software 24. It is recognised that one or more applications 105 could call a single object class 29 which optionally calls the software 500 through interface 129. Otherwise, the called object class 29 could become the instantiated object 29′. Of course, the contents of the variable may be acted upon as otherwise dictated by the application definition 28. Thus, contents of the variable may be presented as part of the user interface 18, or sent back to middleware server 44, for example as part of a message defined in portion 50 of the application definition 28 as identified by the <DATA> tag, as detailed in Appendix “A”.

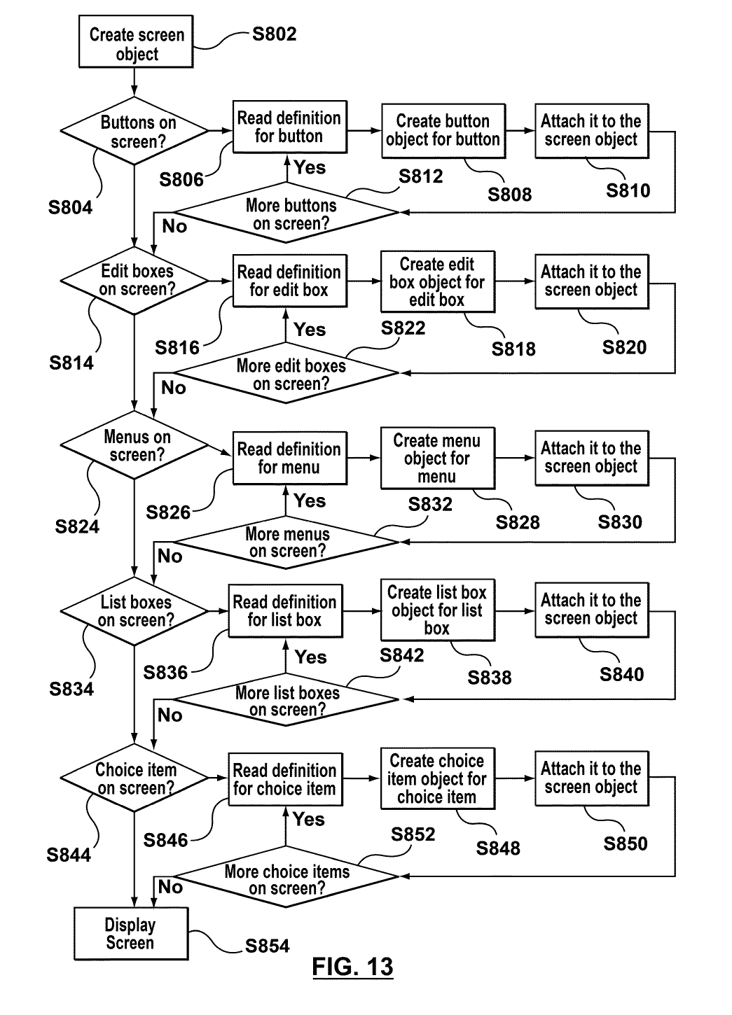

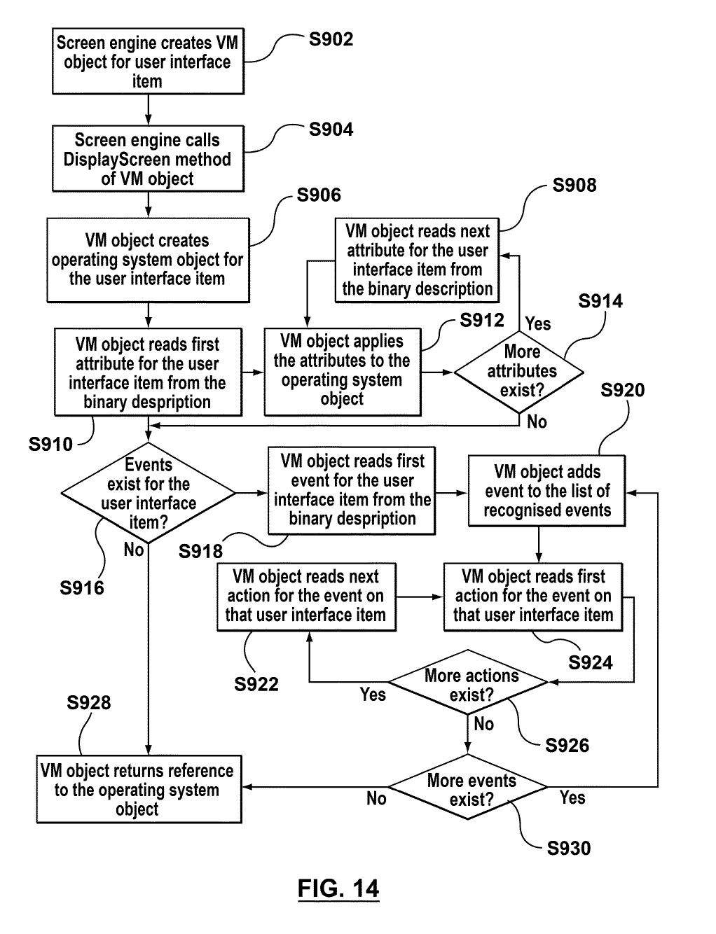

After execution of the method of the external class 29, additional screens may be created by invocation of the screen generation engine 67, as detailed in FIGS. 13 and 14. In this manner the navigation through the screens of the application 105 is accomplished according to the definition embodied in the XML application definition file 28.

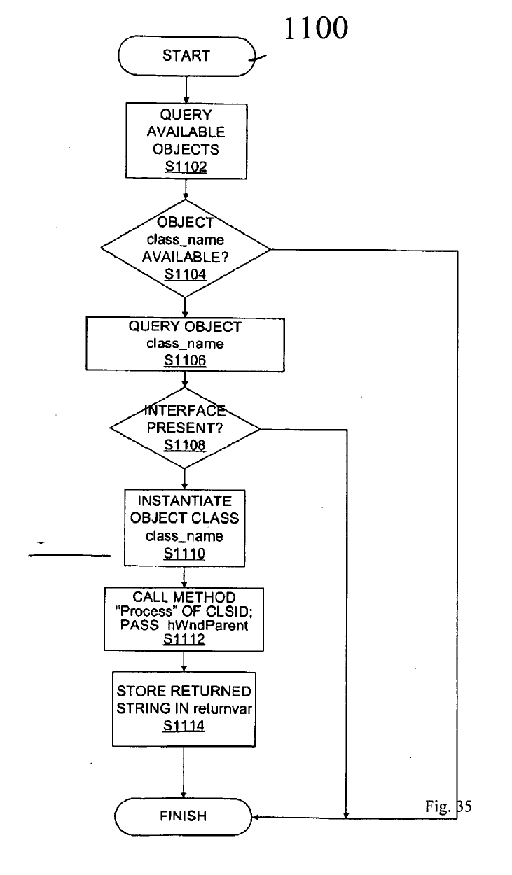

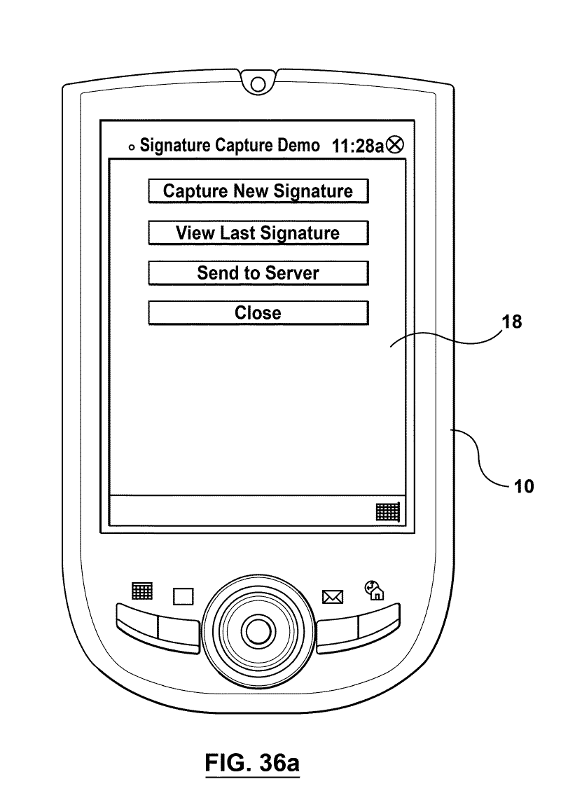

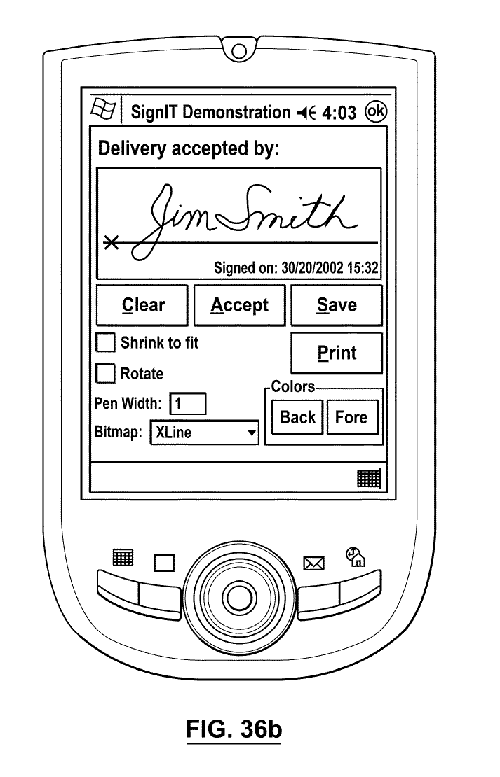

For the purposes of illustration, FIGS. 36A, B illustrates the presentation of the user interface 18 for a sample screen on a Windows CE Portable Digital Assistant device 10, that has invoked an externally generated signature capture dialog (i.e. class 29), as a result of an externally instantiated object 129. The signature data is stored in a variable LASTSIG, and sent back to application server 44.

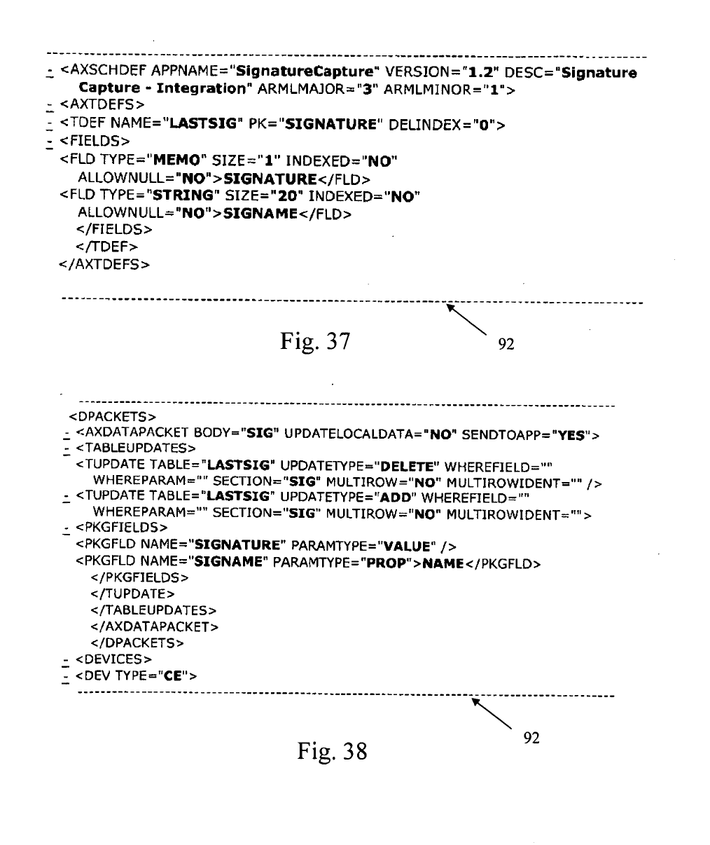

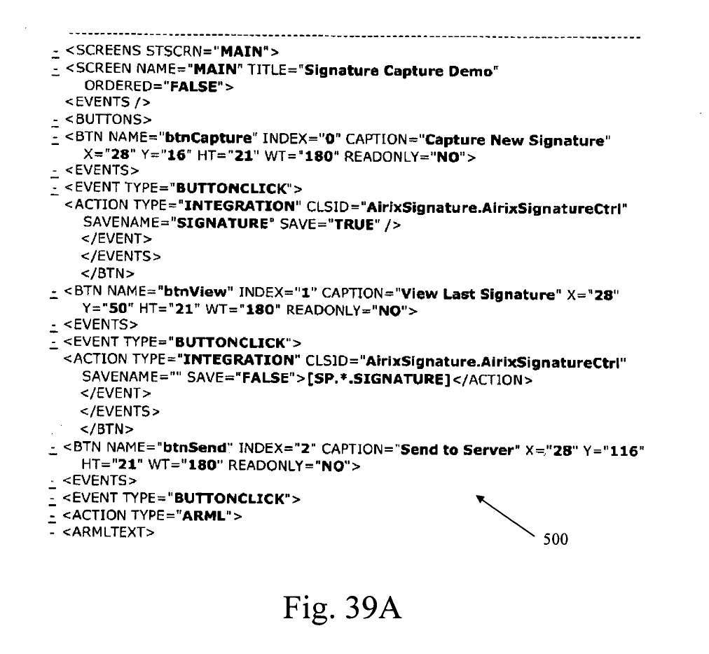

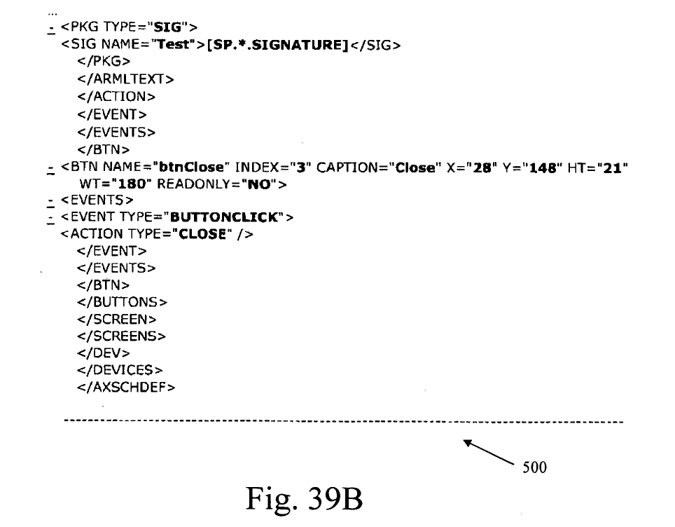

An example application definition file 92 (of the format of application definition 28) is illustrated in FIGS. 37, 38 and 39A-39B defines the class 29 entitled SignatureCapture, including a definition of local data in the form of a table titled LASTSIG (FIG. 37), a format of the user interface 18 having a single screen entitled MAIN (FIGS. 39A-39B) and the format of network transactions (FIG. 38), corresponding to portions 52, 50 and 52, respectively of the application definition 28.

The screen has four single buttons identified by the ‘BTN NAME’=“btnCapture”, BTN NAME′=“btnView”, ‘BTN NAME’=“btnSend”, BTN NAME=“btnClose”. Upon invocation of this class 29 at the local device 10, screen generation engine 67 (see FIG. 5) of virtual machine software 24 at the device process the screen definition, as detailed with reference to FIGS. 13 and 14. That is, for each BTN tag, screen generation engine 67 creates a button object instance, in accordance with steps S804-S812. The created buttons will have captions Capture New Signature, View Last Signature, Send to Server, and Close.

The resulting screen at the mobile device 10 is illustrated in FIG. 36A. Each of the screen items is identified with reference to the XML segment within XML definition file 92 giving rise to the screen element.

Call-backs associated with the presented buttons cause graphical user interface 18 of the class 29 and operating system software 20 at the mobile device 10 to return control to the event handler 65 of virtual machine software 24 at the device. Thus, as the user interacts with the class 29, the user may input data within the presented screen of the application 105 using the mobile device API.

Notably, if the button btnSend is pressed, a package of type SIG (as defined in FIG. 38) is sent back to middleware server 44. However, if the buttons btnCapture or btnView are captured steps S1100 are performed to instantiate an external object class 29 named AirixSignature.AirixSignatureCtrl, with arguments,

SAVENAME=“SIGNATURE” SAVE=“TRUE” for btnCapture, and
SAVENAME=“” SAVE=“FALSE”>[SP.*.SIGNATURE]</ACTION>,
for btnView.

An object class 29 named AirixSignature.AirixSignatureCtrl, of course needs to exist, be registered and expose the interface 129 of the forme IAIRIXIntegrationPoint, as detailed above. Its method Process, in turn, causes device 10 to capture a signature or present the signature. These functions may for example be provided using software written for the WindowsCE platform, in a manner appreciated by a person of ordinary skill. In the case of the btnCapture INTEGRATION action, the results of the method return a captured signature, which is stored in variable SIGNATURE by virtual machine software 24. In the case of the btnView the previously captured value stored in the variable SIGNATURE will be passed to the instance of the object class. The screen presented at device 10 in response to performing the Process method of the AirixSignature.AirixSignatureCtrl object class is displayed in FIG. 36B.

As can be appreciated from the preceding description and example, use of external interface components in the form of object classes 29 provides for the virtual machine software 24 to be expanded, almost arbitrarily. Conveniently, applications 105 may still be defined using an application definition file 28 in a manner relatively abstracted from the underlying device 10. Conveniently, as local software or hardware functions are added to devices 10, virtual machine software 24 and applications 105 defined in an application definition 28 may take advantage of the new functionality using external object classes 29 with associated handler definitions 502 as part of the definition file 28.

### Application Design User Interface or Tool 116

Referring to FIGS. 1 and 2, the definition files 28 representing the applications 105 can be stored in the repository 114 as a series of packages that can be created by the Studio developer tool 116, which is employed by developers of the definition files 28 (e.g. XML definitions for screens, messages, and data as well as action/event and definitions/script). The developer design tool 116 can be a RAD tool used to develop the definition file 28 packages, in conjunction with simulation capabilities of the application 105 on the tool 116 using a simulated version of the communication interface 914 (described above—see FIG. 9) that defines communication between the message elements of the application(s) 105, the middleware server 44, and various message and data structures of the data sources 70 via their interface model 300. The tool 116 can provide support for a drag-and drop graphical approach for the visual design of the application 105, including simulation of application 105 operation as well as simulation of server 44 communication with the data sources 70.

For example, in a component based XML-Script application model, the application 105 packages can be represented as metadata (XML) that can be generated automatically by the tool 116 through an automatic code generation process. The tool 116 can provide for the automatic generated code to include application workflow descriptions using an industry standard scripting language (e.g. JavaScript) or other scripting/programming languages known in the art, as well as using XML tag implemented rules interpreted by the handler 65 (see FIG. 5). For example, the design editors 600, wizards 604, dialogs 605 and viewers 602 can be used to access an interface component model 301, which could contain all descriptions of the interface components 29 and related interfaces 129 that would/should be available on the device 10 in order to access related software 500 or to be used as instantiated objects 29′. it is recognised that the model 301 could be structured so as to make available stored classes 29 (e.g. interface components) and software 500 on the tool 116, or the model 301 could be used to simulate the interface components 29 though dialog boxes so as to allow the developer to emulate the classes 29 and relate software 500 if not resident on the tool 116. For design time, the developer would use the model 301 to enter in the name of the object class 29 that the application 105 will call and then select. For runtime, the developer would use the model 310 to enter an edit field input that the developer wants the application 105 to call and then the application would try to instantiate the object class 29 specified. theis instantiation can be done directly if the object class 29 is resident on the tool 116 or can be simulated through the dialog boxes. The availability of the definition file 28 packages of the repository 114 can be published via the discovery service of the server 110 in the registry 112. It is recognized that there can be more than one repository 114 and associated registries 112 as utilized by the particular network 8 configuration of the middleware server 44 and associated data sources 70.

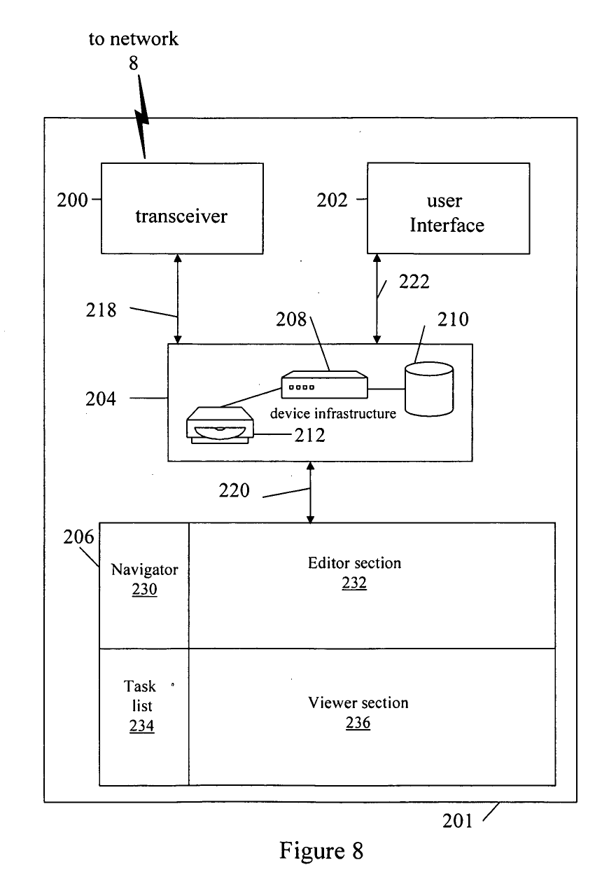

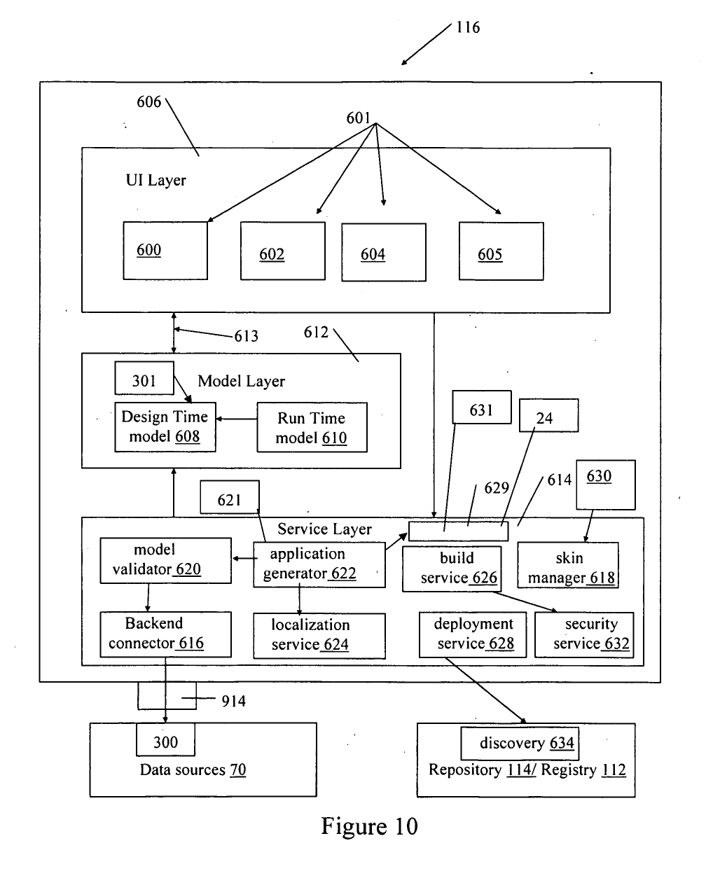

Referring to FIG. 8, the tool 116 is operated on a computer 201 that can be connected to the network 8 environment via a network connection interface such as a transceiver 200 coupled via connection 218 to a device infrastructure 204. The transceiver 200 can be used to upload completed application programs 105 to the repository 114 (see FIG. 1), as well as access the registry 112 and selected data sources 70. Referring again to FIG. 8, the developer design tool 116 also has a user interface 202, coupled to the device infrastructure 204 by connection 222, to interact with a user (not shown). The user interface 202 includes one or more user input devices such as but not limited to a keyboard, a keypad, a trackwheel, a stylus, a mouse, a microphone, and is coupled to a user output device such as a speaker (not shown) and a screen display 206. If the display 206 is touch sensitive, then the display 206 can also be used as the user input device as controlled by the device infrastructure 204. The user interface 202 is employed by the user of the tool 116 to coordinate the design of definition files 28, 58 in conjunction with the application 105 simulation using the communication interfaces 300, 914 (see FIG. 9) using a series of editors 600 and viewers 602 (see FIG. 10) and using a plurality of wizards 604 to assist/drive in the workflow of the development process. The communication interfaces 300, 914 are used during application 105 simulation to link data structures of the network communication messages 900 expected to and from the data sources 70. It should be noted that the tool 116 emulates the interface 914 (normally used by the server 44) so as to interact directly with the data sources 70 through the interface 300.

Referring again to FIG. 8, operation of the tool computer 201 is enabled by the device infrastructure 204. The device infrastructure 204 includes a computer processor 208 and the associated memory module 210. The computer processor 208 manipulates the operation of the network interface 200, the user interface 202 and the display 206 of the tool 116 by executing related instructions, which are provided by an operating system and definition file 28 and/or communication interface model 300 design editors 600, wizards 604, dialogs 605 and viewers 602 resident in the memory module 210. Further, it is recognized that the device infrastructure 204 can include a computer readable storage medium 212 coupled to the processor 208 for providing instructions to the processor 208 and/or to load/design/simulate the applications 105 also resident (for example) in the memory module 210. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid state memory card, or RAM provided in the memory module 210. It should be noted that the above listed example computer readable mediums 212 can be used either alone or in combination.

Referring again to FIG. 2, the design tool 116 is operated on the computer 201 as a development environment for developing the applications 105 and/or application 105 simulation through interaction with the data sources 70 via the communication interface model 300. The development methodology of the tool 116 can be based on a visual “drag and drop” system of building the application visual, data, messaging behaviour, and runtime navigation model 610. The tool 116 can be structured as a set of plug-ins to a generic integrated design environment (IDE) framework, such as but not limited to the Eclipse framework, or the tool 116 can be configured as a complete design framework without using plug-in architecture. For exemplary purposes only, the tool 116 will now be described as a plug-in design environment using the Eclipse framework.

Referring to FIG. 10, Eclipse makes provisions for a basic, generic tool 116 environment that can be extended to provide custom editors, wizards, project management and a host of other functionality. The Eclipse Platform is designed for building integrated development environments (IDEs) that can be used to create applications as diverse as web sites, embedded Java™ programs, C++ programs, and Enterprise JavaBeans™. The navigator view 230 shows files in a user's (e.g. developer) workspace; a text editor section 232 shows the content of a file being worked on by the user of the tool 116 to develop the application 105 in conjunction with the interface model 300 in question; the tasks view section 234 shows a list of to-dos for the user of the tool 116; and the outline viewer section 236 shows for example a content outline of the application 105 being designed/edited/simulated, and/or may augment other views by providing information about the currently selected object such as properties of the object selected in another view. It is recognised that the tool 116 aids the developer in creating and modifying the coded definition content of the definition files 28 in view of the application 105 simulation via a simulator module 629, for example in a structured definition language (e.g. in XML). Further, the tool 116 also aids the developer in creating, modifying, simulating, and validating the interdependencies of the definition content between the application message/data and/or screen/data relationships included in the definition files 28 and the communication interface model 300. It is also recognised that presentation on the display of wizard 604 and dialog 605 content for use by the developer (during use of the editors 600 and viewers 602) can be positioned in one of the sections 230, 232, 234, 236 and/or in a dedicated wizard section (not shown), as desired.

The Eclipse Platform is built on a mechanism for discovering, integrating, and running modules called plug-ins (i.e. editors 600 and viewers 602). When the Eclipse Platform is launched via the UI 202 of the computer 201, the user is presented with an integrated development environment (IDE) on the display 206 composed of the set of available plug-ins, such as editors 600 and viewers 602. The various plug-ins to the Eclipse Platform operate on regular files in the user's workspace indicated on the display 206. The workspace consists of one or more top-level projects, where each project maps to a corresponding user-specified directory in the file system, as stored in the memory 210 (and/or accessible on the network 10), which is navigated using the navigator 230. The Eclipse Platform UI paradigm is based on editors, views, and perspectives. From the user's standpoint, a workbench display 206 consists visually of views 602 and editors 600. Perspectives manifest themselves in the selection and arrangements of editors 600 and views 602 visible on the display 206. Editors 600 allow the user to open, edit, and save objects. The editors 600 follow an open-save-close lifecycle much like file system based tools. When active, a selected editor 600 can contribute actions to a workbench menu and tool bar. Views 602 provide information about some object that the user is working with in the workbench. A viewer 602 may assist the editor 600 by providing information about the document being edited. For example, viewers 602 can have a simpler lifecycle than editors 600, whereby modifications made in using a viewer 602 (such as changing a property value) are generally saved immediately, and the changes are reflected immediately in other related parts of the display 206. It is also recognised that a workbench window of the display 206 can have several separate perspectives, only one of which is visible at any given moment. Each perspective has its own viewers 602 and editors 600 that are arranged (tiled, stacked, or detached) for presentation on the display 206.

### Designer Tool 116 Architecture

FIG. 10 illustrates the overall designer tool 116 structure for designing applications 105 and/or simulating the applications 105 using the associated interface 300 (accessible over the network 8 environment) and emulating interface 914. The designer tool 116 user interface (UI 202 and display 206—see FIG. 8) is primarily a user facing module 601 (i.e. composer modules) collection of graphical and text editors 600, viewers 602, dialogs 605 and wizards 604. The large majority of external interactions are accomplished through one or more of these editors 600, with the developer/user, using a system of drag and drop editing and wizard driven elaboration. The secondary and non-user facing system interface is that of the “Backend”, whereby the tool 116 connects to and digests data source 70 services such as Web Services and SQL Databases through simulation of the application 105 via the interfaces 300, 914. As described above, the tool 116 can be built on the Eclipse platform, whereby the user interface system components can be such as but not limited to components of editors 600, viewers 602, dialogs (not shown) and wizards 604, which are plug-in modules 601 that extend Eclipse classes and utilize the Eclipse framework, for example. As shown, the tool 116 communicates with backend data sources 70 and may communicate with the UDDI repositories 114 and registries 112.

### UI Layer 606

The tool 116 has a UI Layer 606 composed mainly of the editors 600 and viewers 602, which are assisted through the workflow wizards 605. The layer 606 has access to an extensive widget set and graphics library known as the Standard Widget Toolkit (SWT), for Eclipse. The UI layer 606 modules 601 can also make use of a higher-level toolkit called JFace that contains standard viewer classes such as lists, trees and tables and an action framework used to add commands to menus and toolbars. The modules 601 can be used to insert the handler definitions 502 in the definition file 28, in accordance with the object classes 29 of the interface model 301. It is recognised that knowledge of the associated interfaces 129 of the classes 29 can be used by the developer in developing the definition file 28 so as to take advantage of known software 500 available on the device 10. As well, the developer can also update the contents of the interface model 301 (for the latest in available software 500) so as to help in developing upgrades to existing definition files as per existing design time models 608. The tool 116 can also use a Graphical Editing Framework (GEF) to implement diagramming editors. The UI layer 606 modules 601 can follow the Model-View-Controller design pattern where each module 601 is both a view and a controller. Data models 608, 610 represents the persistent state of the application 105 and are implemented in the data model layer 612 the tool 116 architecture. The separation of the layers 606, 612 keeps presentation specific information in the various views and provides for multiple UI modules 601 (e.g. editors 600 and viewers 602) to respond to data model 608, 610 changes. Operation by the developer of the editors 600 and viewers 602 on the display 202 (see FIG. 2) can be assisted by the wizards 604 for guiding the development of the application 105 and/or simulation through the interfaces 300, 914.

Referring to FIG. 6, the UI Layer 606 is comprised of the set of editors 600, viewers 602, wizards 604 and dialogs 605. The UI Layer 606 uses the Model-View-Controller (MVC) pattern where each UI module 601 is both a View and a Controller. UI Layer modules 601 interact with data models 608, 610 with some related control logic as defined by the MVC pattern. The editors 600 are modules 601 that do not commit model 608, 610 changes until the user of the tool 116 chooses to “Save” them. Viewers 602 are modules 601 that commit their changes to the model 608, 612 immediately when the user makes them. Wizards 604 are modules 601 that are step-driven by a series of one or more dialogs 605, wherein each dialog 605 gathers certain information from the user of the tool 116 via the user interface 202 (see FIG. 8). No changes are applied to the design time model 608 using the wizards 604 until the user of the tool 116 selects a confirmation button like a “Finish”. It is recognised in the example plug-in design tool 116 environment, modules 601 can extend two types of interfaces: Eclipse extension points and extension point interfaces. Extension points declare a unique package or plug-in already defined in the system as the entry point for functional extension, e.g. an editor 600, wizard 604 or project. Extension point interfaces allow the tool 116 to define its own plugin interfaces, e.g. for skins 618 and backend 616 connectors, as further described below.

### Data Models 608, 610, 301

The tool 116 data models 608, 610, 301 are based, by example, on the Eclipse Modeling Framework (EMF). The framework provides model 608, 610, 310 change notification, persistence support and an efficient reflective API for manipulating EMF objects generically. The code generation facility is used to generate the model 608, 610, 301 implementation and create adapters to connect a model layer 612 with the user interface modules 601 of the UI layer 606.

Referring again to FIG. 6, modules 601 (primarily Editors 600 and Viewers 602) in the tool 116 are observers of the data models 608, 610, 301 and are used to interact or otherwise test/simulate and modify the data models 608, 610, 301 of the application (e.g. components 400, 402, 404, 406—see FIG. 4) in question. When the data model 608, 610, 301 changes, the models 608, 610, 301 are notified and respond by updating the presentation of the application 105. The tool 116 uses the Eclipse Modeling Framework (EMF), for example, to connect the Eclipse UI framework to the tool 116 data model 608, 610, 301, whereby the modules 601 can use the standard Eclipse interfaces to provide the information to display and edit an object on the display 206 (see FIG. 2). In general, the EMF framework implements these standard interfaces and adapt calls to these interfaces by calling on generated adapters that know how to access the data model 608, 610, 301 and example communication methods 908, 910, 912 (see FIG. 9) of the interface 914 residing in memory 210. The design time Data Model 608 is used to represent the current version of the application 105 (e.g. an application module) in development and is accessed by the users employing the modules 601 to interact with the associated data of the model 608. Modules 601 can also trigger validation actions on the Design Time Data Model 608. Modules 601 can also cause some or all of the application 105 to be generated from the Design Time Data Model 608 resident in memory 210. In general, the Design Time Data Model 608 accepts a set of commands via the UT 202 (see FIG. 2) that affect the state of the model 608, and in response may generate a set of events. Each module 601 (editor 600 and viewer 602) described includes the set of commands and the events that affect the module 601 and data model 608 pairing.

Referring to FIG. 10, the Runtime Data Model 610 represents the state of an emulated/simulated application 105 under development by the tool 116, in conjunction with the simulator module 629, using as a basis the contents of the design time data model 608. The runtime data model 610 stores values for the following major items, such as but not limited to: Data Components 400 (see FIG. 7); Global Variables; Message Components 404; Resources; Screen Components 402 and Styles as well as definition sections 48, 50, 52 where desired. The Runtime Data Model 610 collaborates with the Design Time Data Model 608 and a Testing/Preview viewer of the simulator module 629 during emulation/simulation of application 105 for testing and preview purposes (for example). The viewer also collaborates with the skin manager 616 for emulating/simulating the runtime data model 610 for a specified device 10 type. The Runtime Data Model 610 also notifies, through a bridge 613, the viewer as well as any other modules 601 of the UI layer 606 associated with changes made to the model 610. For example, an API call can be used as a notifier for the associated modules 601 when the state of the model 610 has changed. The Design Time Data Model 608 represents the state of an application 105 development project and interacts with the modules 601 of the UI layer 606 by notifying modules 601 when the state of the model 608 has changed as well as saving and loading objects from storage 210. The model's 608 primary responsibility is to define the applications 105 including such as but not limited to the following items: Data Component 400 Definitions; Global Variable Definitions; Message Component 404 Definitions; Resource 304, 306 Definitions; Screen Component 402 Definitions; Scripts 406; Style Definitions and definition sections 48, 50, 52 where appropriate. The Design Time Data Model 608 responds to commands of each editor 600, viewer 602. The Design Time Data Model 608 also fires events to modules 601 in response to changes in the model 608, as well as collaborating/communicating with the other modules 601 (module 601-module 601 interaction) by notifying respective modules 601 when the data model 608 has changed. The data model 608 depends on an interface in order to serialize model 608 content retrieval and storage to and from the memory 210.

The interface model 301 contents are used to guide the developer in inserting handler definitions 502 in the definition file 28. the handler definitions 502 are formatted, for example as given above by example, so as to be recognizable and processed by the service 504 of the virtual machine 24. It is recognised that the developer can use the interface model 301 as a library of available handler definitions 502 and their related interfaces 129 and software 500.

The above describes the mechanism used by the tool 116 editors 600 and viewers 602 to interact with the models 608, 610 and methods 908, 910, 912 of the interfaces 300, 914. The EMF.Edit framework is an optional framework provided by the Eclipse framework. The tool 116 can use the EMF.Edit framework and generated code (for example) as a bridge or coupling 613 between the Eclipse UI framework and the tool models 608, 610, 300. Following the Model-View-Controller pattern, the editors 600 and viewers 602 do not know about the models 608, 610 directly but rely on interfaces to provide the information needed to display and edit.

### Service Layer 614

Referring again to FIG. 6, a service layer 614 provides facilities for the UI layer 606 such as validation 620, localization 624, generation 622, build 626, simulator module 629 and deployment 628, further described below. The tool 116 can make use of the Eclipse extension point mechanism to load additional plug-ins for two types of services: backend connectors 616 and device skin managers 618 with associated presentation environments 630.

The backend connector 616 defines an Eclipse extension point to provide for the tool 116 to communicate with or otherwise obtain information about different backend data sources 70, in order to obtain the message format (e.g. as provided by WSDL definitions) of the selected data source 70 and/or to communicate with the respective data source 70 of the application 105 (under development) during simulation via the simulation module 629. The backend connector 616 can be used as an interface to connect to and to investigate backend data source 70 services such as Web Services and SQL Databases via the emulated interface 914 through the communication interface 300 (of the data sources 70). The backend connector 616 facilitates simulating the suitable application message and data set 900 to permit communication with these services from the application 105 when simulated running on the device 10. Further, it is recognised that the backend connector 616 and/or the simulator module 629 can be used to emulate the communication interface 914, also used by the server 44 when the application 105 is eventually deployed to the network 8 environment. The backend connector 616 can support the access to multiple different types of data sources 70 through the interfaces 300914, such as but not limited to exposing respective direct communication interfaces through a communication connector based architecture. At runtime the tool 116 reads the plug-in registry to add contributed backend extensions to the set of backend connectors 616, such as but not limited to connectors for Web Services.

The Backend Connector 616 can be responsible for such as but not limited to: connecting to a selected one (or more) of the backend data sources 70 (e.g. Web Service, Database) through the interfaces 300, 914; providing an interface for accessing the description of the backend data source 70 (e.g. messages, operations, and data types); and/or providing for the identification of Notification services (those which push notifications over the network 8 to the device 10—see FIG. 1). The Backend Connector 616 can provide an interface to the communicate with the backend data source 70 (e.g. a web service, SQL Database or other) and can provide a level of abstraction between implementation specific details of the backend messaging and generic messaging processing of the messages 900 of the data source business logic 902 situated in the data source 70 behind the interface model 300.

The device skin manager 618 defines an Eclipse extension point, for example, to allow the tool 116 to emulate different devices 10 (see FIG. 1), such that the look and feel of different target devices 10 (of the application 105) can be specified. At runtime the tool 116 reads the plug-in registry to add contributed skin extensions or presentation environments 630 to the set of device environments 630 coordinated by the manager 618, such as but not limited to environments 630 for a generic BlackBerry™ or other device 10. The Skin Manager 618 is used by the Testing/Preview viewer 806 to load visual elements of the data model 608, 610 that look appropriate for the device 10 that is being emulated, i.e. elements that are compatible with the specified environment 630. Different skins or presentation environments/formats 630 are “pluggable” into the manager 618 of the tool 116, meaning that third parties can implement their own presentation environments 630 by creating new unique SkinIds (an Eclipse extension point), for example, and implementing an appropriate interface to create instances of the screen elements supported by the runtime environment RE of the emulated device 10. In order to load a new presentation environment 630, the Testing/Preview viewer 806 first asks the Manager 618 for an instance of the specified environment 630. The Manager 618 then instantiates the environment 630 and the Testing/Preview viewer 806 uses the specified environment 630 to construct the screen elements according to the screen components of the model 608, 610. For example, the presentation environments 630 (e.g. SkinPlugins) are identified to the SkinManager 618 through a custom Eclipse extension point using the Eclipse framework.

Further, the tool 116 can have a software module 621 for providing software 500 for interaction with the embedded handler definitions 502 of the simulated application 105. The software 500 can be instantiated in the memory 210 of the computer 201 of the tool 116 and/or the developer can have dialog boxes 605, for example, to simulate the presence of the software 500 during simulation of the application 105. For example, the dialog boxes 605 would visualize on the user interface 202 (see FIG. 8) the input and required output data of the messages 506, 508 (see FIG. 40) as the simulated software 500 is in communication with the simulated application 105.

The model validation 620 of the service layer 614 provides facilities for the UI layer 606 such as validating the design time data model 608 in conjunction with the interface model 300. The ModelValidator 620 is used to check that the representation of application 105 messages is in line with the backend data source 70 presentation of messaging operations via the interface model 300. The Model Validator 620 can be responsible to validate the model 608 representation (i.e. content of definition files 28) of the application 105 to be generated, for example such as but not limited to elements of: workflow sanity of the workflow elements; consistency of parameters and field level mappings of the components data, message and screen elements; screen control mappings and screen refresh messages of the screen elements; message and/or data duplications inter and intra screen, message, data, and workflow elements. Another function of the validation 620 can be to validate the interface model's 300 representation of backend data source 70 messaging relationships as implemented by the emulated application 105. In order to achieve its responsibilities, the validator 620 can collaborate with the Design Time Data Model 608, the interfaces 300, 914, an application generator 622, the simulator module 629 and the backend connector 616. The Model Validator 620 utilizes as part of the validation task the Design Time Data Model 608 (for application 105 validation) and the message structures 900 (for interfaces 300, 914 compatibility validation), as well as the backend connector 616, which supports the interface to the backend data sources 70 through the defined communication interfaces 300, 914.

Referring again to FIG. 10, the localization Service 624 has responsibilities such as but not limited to: supporting a build time localization of user visible strings; supporting additional localization settings (e.g. default time & date display format, default number display format, display currency format, etc); and creating the resource bundle files (and resources) that can be used during preparation of the deployable application 105 (e.g. an application jar file) by a BuildService 626. For example, the localization service 624 can be implemented as a resource module for collecting resources that are resident in the design time data model 608 for inclusion in the deployable definition file 28. The JAR file can be a file that contains the class, image, and sound files for the application gathered into a single file and compressed for efficient downloading to the device 10. The Localization Service 624 is used by the application Generator 622 to produce the language specific resource bundles, for example. The BuildService 626 implements preparation of the resource bundles and packaging the resource bundles with the deployable application definition file 28. The Localization Service 624 interacts (provides an interface) with the tool editors 600 and viewers 602 for setting or otherwise manipulating language strings and locale settings of the application 105.

Referring to FIG. 10, the Generator 622 can be responsible for, such as but not limited to: generation of the application XML from the components definition sections 48, 50, 52 (and components 400, 402, 404 as desired); optimizing field ordering of the component/section descriptors; and generation of dependencies and script transformation (for action/event operation) as desired for storage in the memory 210. The Generator 622 collaborates with the Design Time Data Model 608 to obtain the content of the developed definition sections 48, 50, 52 (and components 400, 402, 404 as desired) comprising the application 105, as well as cooperating with the selected communication interface model 300 to generate the messages 900 for use by the middleware server 44. The Generator 622 utilizes the Model Validator 620 to check that both the application definitions (of the file 28) are correct. The Generator 620 then produces the XML code of the file 28, with inclusions and/or augmentations of the script/handler of the workflow elements. The Generator 622 uses the Localization Service 624 to produce language resource bundles, through for example a Resource Bundles interface (not shown). The Generator 622 generation process can be kicked off through a Generate interface accessed by the developer using the UI 202 of the tool 116 (i.e. by user input events such as mouse clicks and/or key presses). It is recognised that the generator 622 can be configured as a collection of modules, such as but not limited to a code module for generating the XML (which may include associated script). It is recognised that the generator module 622 could also generate the required classes 29 as per the embedded handler definitions 502 of the file 28. These classes 29 could be associated with the definition file 28, for example published or otherwise made available to the users of the device 10 and the services of the data source 70 related to the definition file 28.

The deployment service 628 is used to deploy the appropriate application definitions file 28 with respect to the repository 114 and registry 112 and/or middleware server 44. The Build Service 626 provides a mechanism for building the deployable form of the definitions file 28. The Build Service 626 produces via a build engine the deployable application file 28. These files 28 are made available to the deployment service 628 via an output interface of the tool 116. The security service 632, has the ability to sign the application file 28 to prevent tampering with their contents, and to provide the identity of the originator. There can be two example options for signing, either making use of DSA with SHA1 digest, or RSA with MD5, as is know in the art. For example, the security service 632 can handle certificates that are used for application file 28 signing. The security service 632 can have the ability to request, store and use a public/private key pair to help ensure the validity of both the originator and content of the application files 28 as deployed. It is recognised that the service 628 could also deploy the interface model 301 to the repository 114 and registry 112 and/or middleware server 44.

### Simulator Module 629 and Interfaces 300, 914

The simulator module 629 uses the simulated interface 914 along with the interface 300 to provide for direct communication of the simulated application 105 with the data source 70, via the back end connector module 616, preferably over the network 8 environment. The interface 300 and simulated interface 914 can be defined as a framework for organizing and representing messaging information used by the middleware server 44 and/or tool 116 to facilitate communication between the application 105 and the data sources 70. In the context of the developer tool 116, the interface 300 and simulated interface 914 provide for direct communication between the tool 116 and the respective data source 70 during simulation of the application 105 under development. It is recognised that the interfaces 300, 914 can be used for application 105 simulation while the definitions file 28 is in development, or can be used once the definitions file 28 development is complete.

The tool 116 is equipped with the simulator module 629 that simulates device applications 105 on their respective intended wireless device 10 types. The simulator module 629 in conjunction with the backend connector 616 for connecting over the network 8 environment to the respective data source 70 (via the interfaces 300, 914), provides the opportunity to test the application 105 (as represented by the description file 28 under development) without using the actual intended wireless device 10. The simulator module 629 can use a version of the virtual machine software 24 to simulate operation of the application 105 as well as to provide run-time debugging information, which can be used to minimize errors in the application's 105 operation on the actual device 10 real-time.

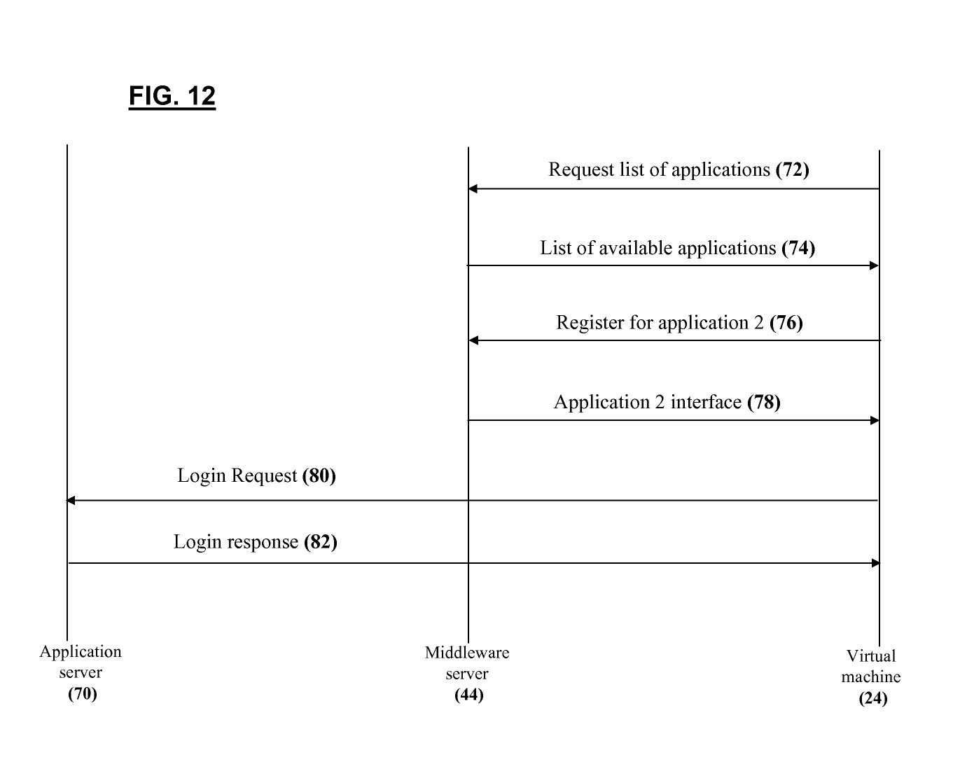

Referring to FIG. 9, the simulator module 629 provides for mimicking the XML message transactions 900 normally occurring between the middleware server 44 and the data source 70 once the application 105 is deployed to the device 10. It should be recognised that the middleware server 44 does not have to be present to simulate the application 105 using the tool 116, rather the application 105 connection point (i.e. network address) is temporarily directed to the network address of the tool 116 (represented as network link 904) when simulating the interface 914. Before the tested application 105 is eventually deployed to the network 8 environment and installed on the device 10, the connection point associated with the definition file 28 (of the application 105) is reset to the address of the interface 914 of the middleware server 44 (represented as network link 906), which is in communication with the data source 70. Accordingly, rather than directing the enterprise application of the data source 70 to the middleware Server 44, the IP address of the computer 201 hosting the simulator module 629 is used for messaging 900 via the link 904. Further, by example only, SOAP files of the interface 914 can be used by the simulator module 629 to emulate the basic communications of the interface 914 normally operated by the middleware Server 44. However, it should be recognised that in both cases (pre- and post-application 105 deployment) that the interfaces 300, 914 (and associated communication protocols/methods 908, 910, 912—see FIG. 12) are used both during application 105 development and after deployment. It is recognised that the data source 70 is configured for use of the communication methods 908, 910, 912 in conjunction with the interface model 300.

Using the simulator module 629, the device application 105 under development can through a first scenario communicate directly with the enterprise application of the data source 70, through the emulated server interface 914, as the application 105 would normally operate when deployed on the wireless device 10. In this case the actual middleware server 44 used to assist in communication between the data source 70 (through the interface 914) and the device 10 is not used. It is recognised that the tool 116 could also communicate in a second scenario through the actual middleware server 44 during simulation of the application 105 by the tool 116, if desired. In the second scenario, the connection for the point for the simulated application 105 would be the middleware server 44, represented by the network link 903 as understood by a person skilled in the art. In this second scenario, the tool 116 would be emulating network communication of the device 10 when in actual operation of the application 105, while the actual middleware server 44 of the network 8 environment would be responsible for communication through the interfaces 300, 914 with the data source 70. In either scenario, use of the interfaces 300, 914 is employed, either by the tool 116 directly or by the middleware server 44 directly.

The simulator module 629 in conjunction with the skin manager 618 and selected environments 630 can provide different simulator environments 630 for each of the wireless device 10 types supported by the data source 70. Much like the devices 10 themselves, the different simulator environments 630 have varying navigation characteristics, which provide for respective imitation of actions of the wireless user for a respective device 10 type. Listed below is an example of an RIM simulator environment 630 for representing the screen display of the application 105 when in communication with the data source 70, based on the type of wireless device 10 selected and the specified device skin simulator environment 630. Referring to FIG. 11, two viewing tabs 1100, 1101 are available from the main simulator interface 1102 of the user interface 202 (see FIG. 8). Display tab selection 1100, for example the default simulator view, provides for control and navigation of the device application 105 under simulation. The data tab selection 1101 displays the data that is currently held in the application's 105 local data tables (intended for storage in the memory 16 of the device 10—see FIG. 4), in a graphical database form for example. The Data view can be updated continuously as the simulator module 629 runs the device application 105.

Referring again to FIG. 11, the Simulator module 629 can be set to a number of different display options using a Project Options window 1104. One significant display setting involves the debugging windows 1104, which display various details regarding the operation of the device application 105 during the simulation. Any combination of the five (for example) debugging windows 1104 can be displayed in the user interface 202 (see FIG. 8), depending on developer preferences. For example, choosing not to view any of the windows 1104 may be appropriate during sales presentations and demonstrations, as it gives the simulator module's 629 display characteristics most similar to the actual wireless device 10. The following windows 1104 can be displayed as a part of the simulator module operation, such as but not limited to:

Incoming XML 1106—displays the XML Transactions received by the device application 105;

Outgoing XML 1108—displays the XML Transactions that are constructed and sent from the device application 105;

Query Execution 1110—displays any queries, in the form of SQL statements (for example) that have been executed on the device 10 data tables;

Event Execution 1112—lists the events and actions that are executed during the application's 105 operation; and

Scratchpad Values 1114—displays the current status of the device scratchpad, identifying any values currently retained by the application 105.

Selecting an item listed in any of the five debugging windows 1104 can display any additional information to the above, if available.

### Operation of the Application 105 Simulation

A method for simulating the application 105 for subsequent deployment on the mobile device 10, the mobile device 10 configured for using the deployed application 105 to communicate over the network 8 with the data source 70 through the transaction server 44, the method comprising the steps of, such as but not limited to: executing the simulated application 105 to generate at least one message configured for receipt by the simulated communication interface 914 of the transaction server 44; simulating the server communication interface 914 for receiving the message and for transmitting the asynchronous message 900 intended for transmission to the data source 70 via the interface 300; establishing a connection to the network 8 by the tool 116 and transmitting the asynchronous message 900 over the network 8 to the data source 70; wherein the simulated server communication interface 914 is used to monitor the status (i.e. return value if any) of the transmitted asynchronous message 900.

### Application 105 and Associated Definition File 28

As noted, the text definition files 28 defining application definitions and data may be formatted in XML. For example XML version 1.0, detailed in the XML version 1.0 specification second edition, dated Oct. 6, 2000 and available at the internet address “http://www.w3.org/TR/2000/REC-xml-2000-1006”, the contents of which are hereby incorporated herein by reference, may be used. However, as will be appreciated by those of ordinary skill in the art, the functionality of storing XML definition files 28 is not dependent on the use of any given programming language or database system. Each application definition file 28 is formatted according to defined rules and uses pre-determined XML markup tags, known by both virtual machine software 24, and complementary middleware server software 68. Tags define XML entities used as building blocks to present the application 105 at the mobile device 10. Knowledge of these rules, and an understanding of how each tag and section of text should be interpreted, allows virtual machine software 24 to process the XML application definitions of the file 28 and thereafter execute the application 105, as described below. Virtual machine software 24 effectively acts as an interpreter for a given application definition file 28.

FIG. 6 illustrates an example format for the XML application definition file 28. As illustrated, the example application definition file 28 for a given device 10 and data source 70 service includes three components: a user interface definition section 48, specific to the user interface 18 for the device 10, and defining the format of screen or screens for the application 105 and how the user interacts with them; a network transactions definition section 50 defining the format of data to be exchanged with the data source 70; and a local data definition section 52 defining the format of data to be stored locally on the mobile device 10 by the application 105.

Defined XML markup tags correspond to XML entities supported at the device 10, and are used to create the application definition file 28 using the tool 116 (see FIG. 1). The defined tags may broadly be classified into three categories, corresponding to the three sections 48, 50 and 52 of the application definition file 28. Example XML tags and their corresponding significance are detailed in Appendix “A”. As noted above, virtual machine software 24 at the mobile device 10 includes object classes corresponding to each of the XML tags. At run time, instances of the objects are created as required to execute the definition file 28 as the application 105.

Broadly, the following example XML tags may be used to define the user interface definition 48, such as but not limited to:

SCREEN—this defines a screen. A SCREEN tag pair contains the definitions of the user interface elements (buttons, radio buttons, and the like) and the events associated with the screen and its elements;

BUTTON—this tag defines a button and its associated attributes;

LIST—this tag defines a list box;

CHOICEBOX—this tag defines a choice item, that allows selection of a value from predefined list;

MENU—the application developer using the tool 116 will use this tag to define a menu for a given screen;

EDITBOX—this tag defines an edit box;

TEXT ITEM—this tag describes a text label that is displayed;

CHECKBOX—this tag describes a checkbox;

HELP—this tag can define a help topic that is used by another element on the screen;

IMAGE—this tag describes an image that appears on those displays that support images;

ICON—this tag describes an icon;

EVENT—this defines an event to be processed by the virtual machine software 24. Events can be defined against the application as a whole, individual screens or individual items on a given screen. Sample events would be receipt of data over the wireless interface, or a edit of text in an edit box; and

ACTION—this describes a particular action that might be associated with an event handler. Sample actions would be navigating to a new window or displaying a message box

The second category of example XML tags describes the network transaction section 50 of application definition file 28. These may include the following example XML tags such as but not limited to;

TABLEUPDATE—using this tag, the application developer using the tool 116 can define an update that is performed to a table in the device's 10 local storage. Attributes allow the update to be performed against multiple rows in a given table at once; and

PACKAGEFIELD—this tag is used to define a field in a data package that passes over the wireless network 36, 38;

The third category of XML tags used to describe the application 105 are those used to define a logical database that may be stored at the mobile device 10. The tags available that may be used in this section are such as but not limited to:

TABLE—this tag, and its attributes, define a table. Contained within a pair of TABLE tags are definitions of the fields contained in that table. The attributes of a table control such standard relational database functions as the primary key for the table; and

FIELD—this tag describes a field and its attributes. Attributes of a field are those found in a standard relational database system, such as the data type, whether the field relates to one in a different table, the need to index the field, and so on.

As well as the above described example XML tags for the definition file 28, the virtual machine software 24 may, from time to time, need to perform certain administrative functions on behalf of the user of the device 10. In order to do this, one of object classes 69 can have its own repertoire of tags to communicate its needs to the middleware server 44. Such tags differ from the previous three groupings in that they do not form part of the application definition file, but are solely used for administrative communications between the virtual machine software 24 and the middleware server 44. Data packages using these tags are composed and sent due to user interactions with the virtual machine's configuration screens. The tags used for this can include such as but not limited to:

REG—this allows the application 105 to register and deregister the user for use with the middleware server 44;

FINDAPPS—by using this operation, users can interrogate the server 44 for the list of applications that are available to them;

APP REG—using this operation, the end-user can register (or deregister) for the data source 70 service and have the application 105 interface downloaded automatically to their device 10, via the definition file 28, (or remove the interface description from the device's 10 local storage); and

SETACTIVE—If the user's preferred device 10 is malfunctioning, or out of power or coverage, they will need a mechanism to tell the Server 44 to attempt delivery to a different device 10. The SETACTIVE command allows the user to set the device 10 that they are currently using as their active one.

One specific type of ACTION understood by virtual machine software 24 is referred to as a “INTEGRATION” action. This action is identified as an ACTION having an ACTION TYPE=“INTEGRATION” tag Specifically, the format of the TYPE tag identifying the INTEGRATION action takes the form

<ACTION TYPE =”INTEGRATION” CLSID = “ class_name”
SAVENAME=”returnvar” SAVE=”true/false”> my input
text</ACTION>,

as further described above with respect to the section Inter-Application Interface Components 29.

A further embodiment of the application 105 can, for example, the applications 105 can be packaged definition files 28 for transmission to, and subsequent execution on, the device 10 having application elements or artifacts such as but not limited to XML definitions, communication interface 300, 914 definitions, application resources, and optionally resource bundle(s) for localization support. XML file definitions of the file 28 can be XML coding of application data, messages, screens components (optionally workflow components), part of the raw uncompiled application 105. It is recognised that XML syntax is used only as an example of any structured definition language applicable to coding of the applications 105. The XML definitions may be produced either by the tool 116 generation phase, described above, or may be hand-coded by the developer as desired. The application XML definitions can be generically named and added to the top level (for example) of ajar file.

The resources are one or more resources (images, soundbytes, media, etc. . . . ) that are packaged with the definition file 28 as static dependencies. For example, resources can be located relative to a resources folder (not shown) such that a particular resource may contain its own relative path to the main folder (e.g. resources/icon.gif, resources/screens/clipart_{—}1.0/happyface.gif, and resources/soundbytes/midi/inthemood.midi). The resource bundles can contain localization information for each language supported by the application 105. These bundles can be located in a locale folder, for example, and can be named according to the language supported (e.g. locale/lang_en.properties and locale/lang_fr.properties).

For example, the runtime environment machine 24 of the device 10 can be the client-resident container within which the applications 105 are executed on the device 10. The container can manage the application 105 lifecycle on the device 10 (provisioning, execution, deletion, etc.) and is responsible for translating the metadata (XML) of the definition file 28, representing the application 105 (in the case of raw XML definitions), into an efficient executable form on the device 10. The application 105 metadata is the executable form of the XML definitions and can be created and maintained by the runtime environment machine 24. The machine 24 can also provide a set of common services to the application 105, as well as providing support for optional JavaScript or other scripting languages. These services include support for such as but not limited to UI control, data persistence and asynchronous client-server messaging. It is recognised that these services could also be incorporated as part of the application 105, if desired.

Referring to FIG. 7, as an example only, the definitions file 28 can be component architecture based software applications 105 which can have artifacts written, for example, in eXtensible Markup Language (XML) and a subset of ECMAScript. XML and ECMAScript are standards-based languages, which allow software developers to develop the component applications 105 in a portable and platform-independent way. A block diagram of the component application 105, as the definitions file 28, comprises data components 400, presentation components 402 and message components 404, which are coordinated by workflow components 406 through interaction with the client runtime environment machine 24 of the device 10 (see FIG. 1) once provisioned thereon. The structured definition language (e.g. XML) can be used to construct the components 400, 402, 404 as a series of metadata records, which consist of a number of pre-defined elements representing specific attributes of a resource such that each element can have one or more values. Each metadata schema typically has defined characteristics such as but not limited to; a limited number of elements, a name of each element, and a meaning for each element. Example metadata schemas include such as but not limited to Dublin Core (DC), Anglo-American Cataloging Rules (AACR2), Government Information Locator Service (GILS), Encoded Archives Description (EAD), IMS Global Learning Consortium (IMS), and Australian Government Locator Service (AGLS). Encoding syntax allows the metadata of the components 400, 402, 404 to be processed by the runtime environment RE (see FIG. 1), and encoding schemes include schemes such as but not limited to XML, HTML, XHTML, XSML, RDF, Machine Readable Cataloging (MARC), and Multipurpose Internet Mail Extensions (MIME). The client runtime environment machine 24 of the device 10 can operate on the metadata descriptors of the components 400, 402, 404 to provision an executable version of the application 105, as described above by example with relation to the virtual machine 24 of FIG. 5.

Referring again to FIG. 7, the data components 400 define data entities, which are used by the application 105. Data components 400 define what information is required to describe the data entities, and in what format the information is expressed. For example, the data component 400 may define information such as but not limited to an order which is comprised of a unique identifier for the order which is formatted as a number, a list of items which are formatted as strings, the time the order was created which has a date-time format, the status of the order which is formatted as a string, and a user who placed the order which is formatted according to the definition of another one of the data components 400.

Referring again to FIG. 7, the message components 404 define the format of messages used by the component application 105 to communicate with external systems such as the web service of the data source 70. For example, one of the message components 404 may describe information such as but not limited to a message for placing an order, which includes the unique identifier for the order, the status of the order, and notes associated with the order. It is recognised that data definition content of the components can be shared for data 400 and message 404 components that are linked or otherwise contain similar data definitions. The message component 404 allows the message content to be evaluated to determine whether mandatory fields have been supplied in the message and to be sent to the data source 70 via the middleware server 44.

Referring again to FIG. 7, the presentation components 402 define the appearance and behavior of the component application 105 as it displayed by the user interface 18 of the devices 10. The presentation components 402 can specify GUI screens and controls, and actions to be executed when the user interacts with the component application 105 using the user interface. For example, the presentation components 402 may define screens, labels, edit boxes, buttons and menus, and actions to be taken when the user types in an edit box or pushes a button. It is recognised that data definition content of the components can be shared for data 400 and presentation 402 components that are linked or otherwise contain similar data definitions.

Referring to FIGS. 1 and 7, it is recognized that in the above described client component application 105 definitions hosting model, the presentation components 402 may vary depending on the client platform and environment of the device 10. For example, in some cases Web Service consumers do not require a visual presentation. The application definition of the components 400, 402, 404, 406 of the component application 105 can be hosted in the Web Service repository 114 as a package bundle of platform-neutral data 400, message 404, workflow 406 component descriptors with a set of platform-specific presentation component 402 descriptors for various predefined client runtimes machines 24. When the discovery or deployment request message for the application 105 is issued, the client type would be specified as a part of this request message. In order not to duplicate data, message, and workflow metadata while packaging component application 105 for different client platforms of the communication devices 10, application definition files 28 can be hosted as a bundle of platform-neutral component definitions linked with different sets of presentation components 402. For those Web Service consumers, the client application 105 would contain selected presentation components 402 linked with the data 400 and message 404 components through the workflow components 406.

Referring again to FIG. 7, the workflow components 406 of the component application 105 define processing that occurs when an action is to be performed, such as an action specified by a presentation component 402 as described above, or an action to be performed when messages arrive from the middleware server 44 (see FIG. 1). Presentation, workflow and message processing are defined by the workflow components 406. The workflow components 406 can be written as a series of instructions in a programming language (e.g. object oriented programming language) and/or a scripting language, such as but not limited to ECMAScript, and can be (for example) compiled into native code and executed by the runtime environment 206, as described above. An example of the workflow components 406 may be to assign values to data, manipulate screens, or send/receive messages. As with presentation components, multiple workflow definitions can be created to support capabilities and features that vary among devices 10. ECMA (European Computer Manufacturers Association) Script is a standard script language, wherein scripts can be referred to as a sequence of instructions that is interpreted or carried out by another program rather than by the computer processor. Some other example of script languages are Perl, Rexx, VBScript, JavaScript, and Tcl/Tk. The scripting languages, in general, are instructional languages that are used to manipulate, customize, and automate the facilities of an existing system, such as the devices 10.

Referring to FIG. 7, the application 105 is structured, for example, using component architecture such that when the device 10 (see FIG. 1) receives a response message from the middleware server 44 containing message data, the appropriate workflow component 406 interprets the data content of the message according to the appropriate message component 404 definitions. The workflow component 406 then processes the data content and inserts the data into the corresponding data component 400 for subsequent storage in the device 10. Further, if needed, the workflow component 406 also inserts the data into the appropriate presentation component 402 for subsequent display on the display of the device 10. A further example of the component architecture of the applications 105 is for data input by a user of the device 10, such as pushing a button or selecting a menu item. The relevant workflow component 406 interprets the input data according to the appropriate presentation component 404 and creates data entities, which are defined by the appropriate data components 400. The workflow component 406 then populates the data components 400 with the input data provided by the user for subsequent storage in the device 10. Further, the workflow component 406 also inserts the input data into the appropriate message component 404 for subsequent sending of the input data as data entities to the data source 70, web service for example, as defined by the message component 404.

An example component application 105 represented in XML and mEScript could be as follows, including data components 400 as “wcData” and message components 404 content as “wcMsg”:

```
<wcData name=“User”>
    <dfield name=“name” type=“String” key=“1”/>
    <dfield name=“passwordHash” type=“String”/>
    <dfield name=“street” type=“String”/>
    <dfield name=“city” type=“String”/>
    <dfield name=“postal” type=“String”/>
    <dfield name=“phone” type=“String”/>
</wcData>
<wcData name=“OrderStatus”>
    <dfield name=“confNumber” type=“Number” key=“1”/>
    <dfield name=“status” type=“String”/>
    <dfield name=“datetime” type=“Date”/>
</wcData>
<wcData name=“Order”>
    <dfield name=“orderId” type=“Number” key=“1”/>
    <dfield name=“special” type=“String”/>
    <dfield name=“user” cmp=“true” cmpName=“User”/>
    <dfield name=“datetime” type=“Date”/>
    <dfield name=“orderStatus” cmp=“true” cmpName=“OrderStatus”/>
</wcData>
<wcData name=“Special”>
    <dfield name=“desc” key=“1” type=“String”/>
    <dfield name=“price” type=“Number”/>
</wcData>
<wcMsg name=“inAddSpecial” mapping=“Special”>
</wcMsg>
<wcMsg name=“inRemoveSpecial” pblock=“mhRemoveSpecial”>
    <mfield name=“desc” mapping=“Special.desc”/>
</wcMsg>
<wcMsg name=“inOrderStatus”>
    <mfield name=“orderId” mapping=“Order.orderId”/>
    <mfield name=“status” mapping=“Order.orderStatus”/>
</wcMsg>
<wcMsg name=“inUserInfo” mapping=“User”>
</wcMsg>
<wcMsg name=“outOrder”>
    <mfield name=“special” mapping=“Order.special”/>
    <mfield name=“user” mapping=“Order.user”/>
    <mfield name=“datetime” mapping=“Order.datetime”/>
</wcMsg>
```

As given above, the XML wcData element content defines the example data component 400 content, which is comprised of a group of named, typed fields. The wcMsg element content defines the example message component 404, which similarly defines a group of named, typed fields.

### Example Interface 914

Referring to FIG. 9, the application server 70 may either be configured to poll the transaction server 44 for messages queued to an application on server 70 or the transaction server 44 may push messages on a queue toward the application on the server 70. To support the latter operation, the server 44 or the tool 116 uses the exposed listening interface 300 in combination with the interface 914. The interface 300 may be one of a COM, DCOM, SOAP, .NET, or .NETRemoting interface 300 which has been configured for listening for asynchronous messages.

In the following, the transaction server 44 is sometimes referred to as an ATS. Further, the application server 70 is sometimes referred to as an enterprise server (since the application server and the mobiles 10 which utilise applications 105 on the data base 70 are often part of the same enterprise). Additionally, the defined XML entities of the definition file 28 supported by the VM 24 of the mobiles 10 may be referred to hereinafter as ARML entities.

The requirement is quite simply to PUSH the message 900 from the ATS to the Enterprise server. The following three components are used by the PUSH mechanism of the interface 914:
1) The ARML application defines a delivery type (e.g. push via COM, SOAP, .NET, etc), and the associated details;
2) The ATS implements the logic to push the message 900; and
3) The ATS implements a mechanism by which message 900 delivery is guaranteed, even when the data base 70 is temporarily offline during an attempt to push the message 900. Therefore, the ATS can implement some form of automatic retry logic.

In addition, the ATS ensures that all messages 900 delivered to enterprise applications of the data source 70 are delivered in the order in which they were received. Incoming messages 900 from mobiles 10 are handled by the ATS in the same manner irrespective of whether the ATS forwards these messages 900 on to the enterprise server 70 as a result of polling or by pushing. In this regard, the method 908, 910, 912 for example (which may be named the AIRIXEnterpriseRouter.SendApplicationMessage) is called, which results in the data source 70-bound message 900 being placed in the queue of queues 690 (FIG. 2) which is specific for the data source 70 (TBLAPPLICATIONQUEUE) to which the message 900 is bound through the interface 300. If the enterprise server 70 polls, then this is all the ATS does—it leaves the message 900 in the Queue 690 for the enterprise server 70 to pick up via the PULL delivery type.

If the ATS is aware that a given application on the enterprise server 70 is configured to accept PUSHES of a particular delivery type (e.g., SOAP delivery type), then in addition to the above logic, a _Send method in an AIRIXEnterpriseRouter object will now call the a new AIRIXEnterpriseWakeup component (coupled to the interface 914) asynchronously. This new component (described in greater detail hereinafter) will be responsible for pushing all queued messages 900 for the data source 70 out. The AIRIXEnterpriseWakeup component will in turn call one of several new push specific components, namely such as but not limited to:

AIRIXEnterprisePushCOM;

AIRIXEnterprisePushSOAP; and

AIRIXEnterprisePushRemoting.

These new components may be part of an application namespace called Nextair.AIRIX.Server.Enterprise.Push.

Without any special handling, this solution could easily result in duplicate messages 900 being pushed to the enterprise application of the data source 70. To help combat this problem, the AIRIXEnterpriseWakeup components first attempt to obtain a lock for the application it wants to push to through the interface 300. If this lock is successfully obtained, the AIRIXEnterpriseWakeup component of the interface 914 proceeds to push all queued messages 900 for the enterprise application of the data source 70, and release the lock of the interface 300 when finished. Otherwise, if the AIRIXEnterpriseWakeup component cannot obtain the lock, it will do nothing (immediately exit, without error). Finally, where the Transaction Server 44 is scaled sideways (i.e. works in a clustered environment), the enterprise application of the data source 70 locks are held in a central location—otherwise it could be possible for different machines (referencing the same backend 70 database) to attempt pushing the same messages 900 at once—resulting in duplicate (and possibly out of order) messages 900. The details for the proposed locking mechanism are discussed hereinafter.

In the case where an enterprise application of the data source 70 is currently offline when the ATS attempts to push to it, the pushing attempt will terminate and the remaining messages 900 will be left in the application queue 690. Again, without special handling, an attempt to push these remaining messages 900 to the enterprise application of the data source 70 would not occur until the next message 900 was received from the mobile 10 for that enterprise application of the data source 70 (which, for low volume installations, could be quite a long time). In order to help prevent this from happening, an automatic retry mechanism of the interface 914 may be implemented whereby the ATS will automatically check for old queued messages 900 every X minutes (on a timer). If old queued messages are found, the AIRIXEnterpriseWakeup object of the interface 914 will be fired for the appropriate application.

Upon successful insertion of the application-bound message into the ATS Application Queue, the AIRIXEnterpriseRouter of the interface 914 can:
Lookup the delivery type and push details for the appropriate enterprise application of the data source 70; and
If the enterprise application of the data source 70 is a PUSH delivery type (anything other than PULL), call the AIRIXEnterpriseWakeup component of the interface 914, asynchronously, triggering a push of the new message 900 (and any other queued messages for the enterprise application of the data source 70).

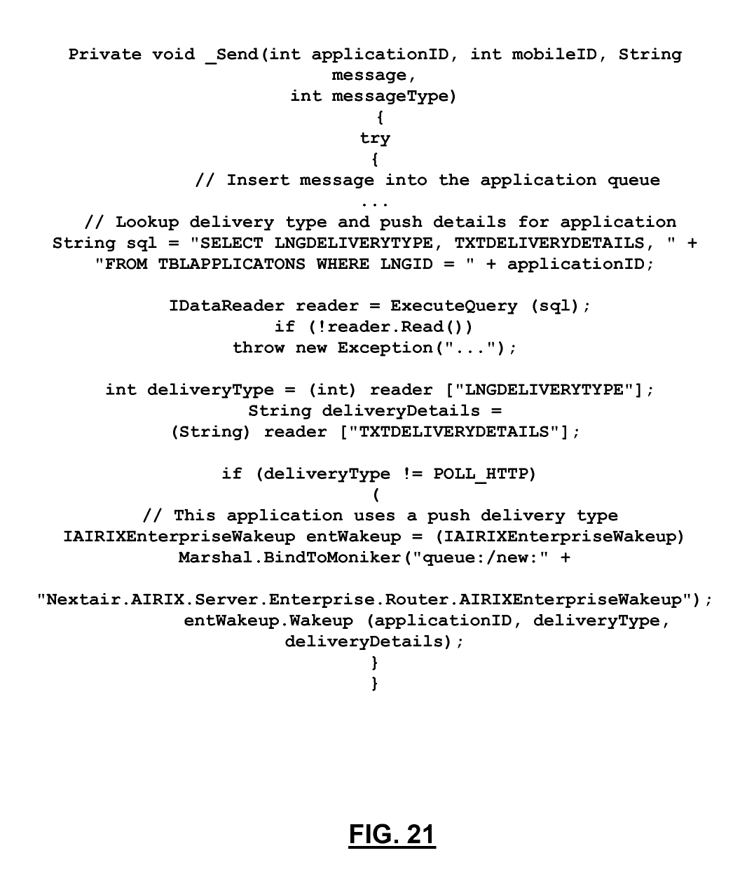

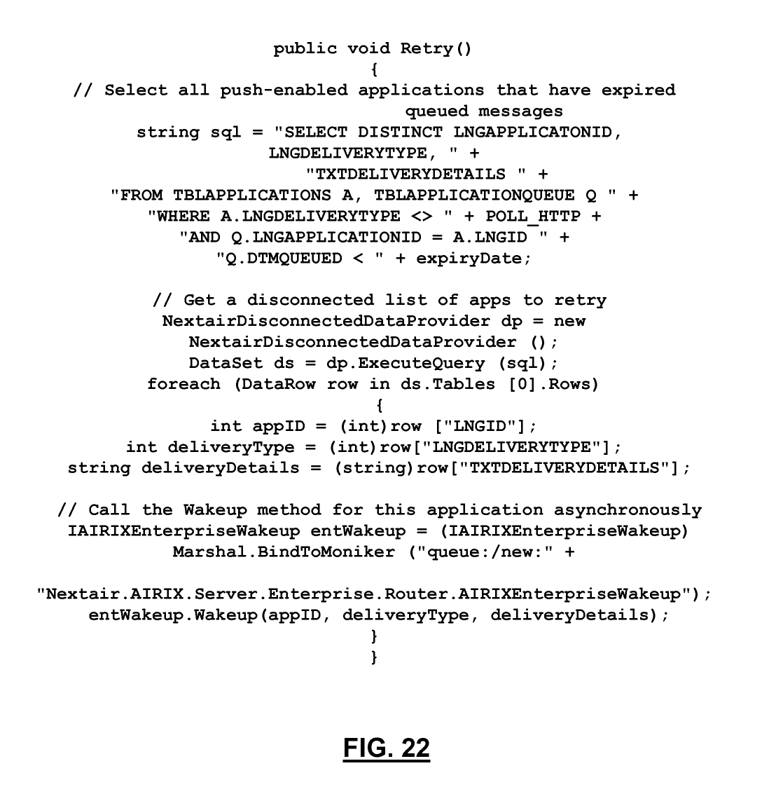

FIG. 21 illustrates pseudo-code for implementing the asynchronous call to the AIRIXEnterpriseWakeup component from the AIRIXEnterpriseRouter _Send method 908, 910, 912. The AIRIXEnterpriseRouter can also contain a new method called Retry. This method may be called by a Retry Service (further detailed hereinafter) to automatically retry sending/pushing any expired queued messages 900. The method will simply retrieve a list of push-enabled applications that have outstanding queued messages 900, and call the Wakeup method against the AIRIXEnterpriseWakeup component for each enterprise application of the data source 70. A simple implementation (without error handling) is set out in FIG. 22.

Ideally, an error trying to create the AIRIXEnterpriseWakeup component in the _Send method should not result in the transaction being rolled back. Instead, an error can be logged, and the retry left up to the built-in automatic retry mechanism of the ATS. The AIRIXEnterpriseWakeup .NET queued component is responsible for initiating pushing to enterprise applications of the data source 70. This component ideally can be called asynchronously by other components to ensure that lengthy enterprise pushes do not hinder other code from executing. This class will belong to the Nextair.AIRIX.Server.Enterprise.Router namespace.

AIRIXEnterpriseWakeup can be a .NET queued component containing a single exposed method called Wakeup. This method will be called primarily by the AIRIXEnterpriseRouter component of the interface 914 when the data source 70-bound message 900 comes in from the mobile 10. The automatic push retry mechanism of the ATS will also call this component on a regular configurable interval. A call to the Wakeup method of this component signifies a request to push all currently queued messages 900 for the enterprise application of the data source 70. Because the AIRIXEnterpriseWakeup component can be a COM+ (pooled) component, it is possible that (without some special handling) two or more AIRIXEnterpriseWakeup components could be attempting to push messages 900 to a single enterprise application of the data source 70 at the same time. To help resolve this issue, the Wakeup method can try to obtain a “push lock” via the interface 300 for the enterprise application of the data source 70 it needs to push to, before actually doing the work. If the lock can be obtained, this component will proceed to attempt to push all queued messages 900 for the enterprise application of the data source 70. Otherwise, if the lock cannot be obtained, the Wakeup method will do nothing (because another Wakeup component may currently own the lock).

In order to help support sideways scaling of the Transaction Server 44 (for high volume, hosting type installation scenarios), the ATS can be capable of holding these “locks” in a central location—one that all AIRIXEnterpriseWakeup components, on all participating Transaction Servers 44 can use to obtain and release locks of the interface 300. At the same time, since it is much more likely that the Transaction Server 44 will not be scaled sideways, ideally there could also be a faster, and less dependent locking mechanism that does not need to communicate across application (or machine) boundaries. The locking implementation for both of these scenarios is explained below.

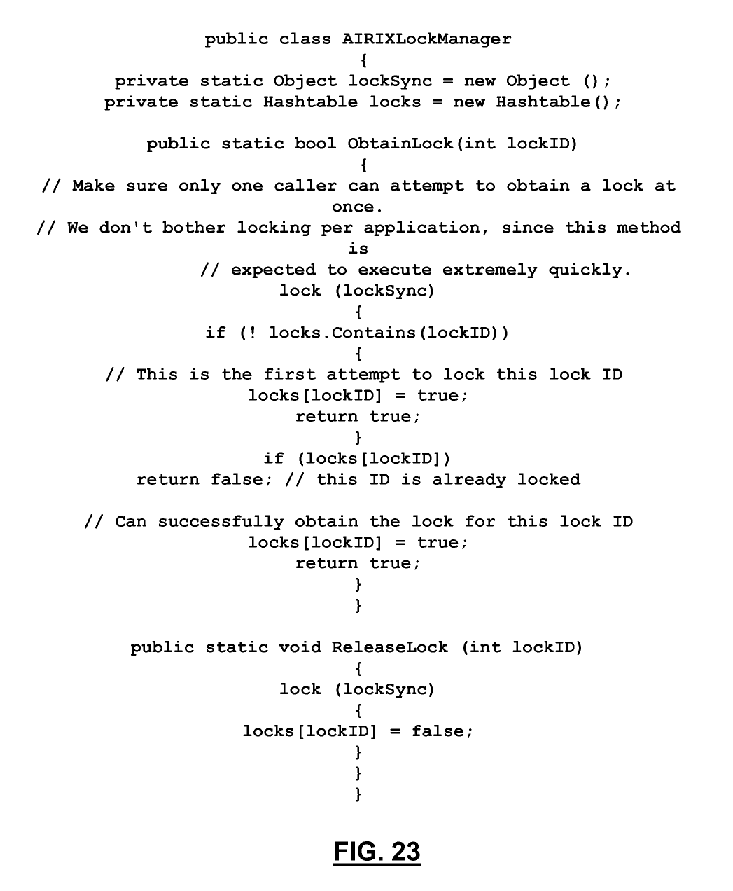

An AIRIXLockManager Class (which is a .NET class) can contain the logic required for obtaining and releasing locks for multiple resources, where a resource is a push-enabled application activated on an ATS. Since pushing to one enterprise application of the data source 70 should not be dependent on pushing to other enterprise applications of the data source 70, this class will be able to keep track of and manage independent locks for multiple enterprise applications of the data source 70. The basic implementation for this class is shown in FIG. 23.

Both the AIRIXEnterpriseWakeup component and a Remote Locking Service (detailed hereafter) of the interface 914 can use the above lock class to hand out application locks. Since the AIRIXEnterpriseWakeup component and the Transaction Server can be hosted in different application spaces, they may not share the static members of the lock class. The reason for having this lock object located in both places is so that the Transaction Server 44 can use a central locking location (i.e. located in the Remote Locking Service) in the rare case where the ATS needs to be scaled to multiple machines. The Remote Locking Service can expose the lock object via a .NET Remoting interface 300, which all cooperating ATS machines will need to query for obtaining and releasing locks. However, since .NET Remoting can require extra overhead (i.e. TCP/IP communication over a specific port), it is also preferable to have the ability to obtain locks without having this Remoting overhead. Therefore, the lock object located in the AIRIXEnterpriseWakeup component can be used when the ATS is installed solely on a single server machine.

The COM+ construct string for the AIRIXEnterpriseWakeup component will contain an XML configuration string indicating:
Whether the ATS should run in clustered mode (off by default).
If specified to run in clustered mode (above), the computer name (or IP address) and port for the Remote Locking Service interface 300 to be used as the central lock provider (normally one of the machines in the cluster).

When called, the Wakeup method in the AIRIXEnterpriseWakeup component will perform the following:

Attempt to obtain a lock for the specified enterprise application of the data source 70

If the lock can be obtained (i.e. is not already obtained by another caller), then:
Create an instance of the appropriate AIRIXEnterprisePushBase descendent component (depending on the passed in delivery type).
Call the Push method on the created push component, passing it the application ID, delivery type, and delivery details for the application to push messages 900 out to.

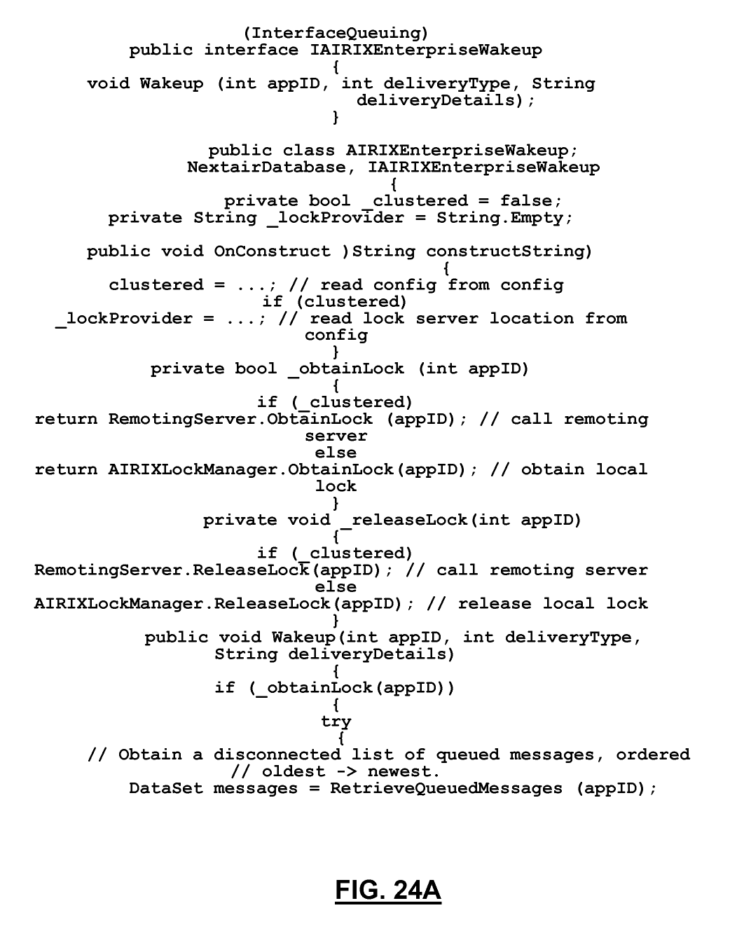

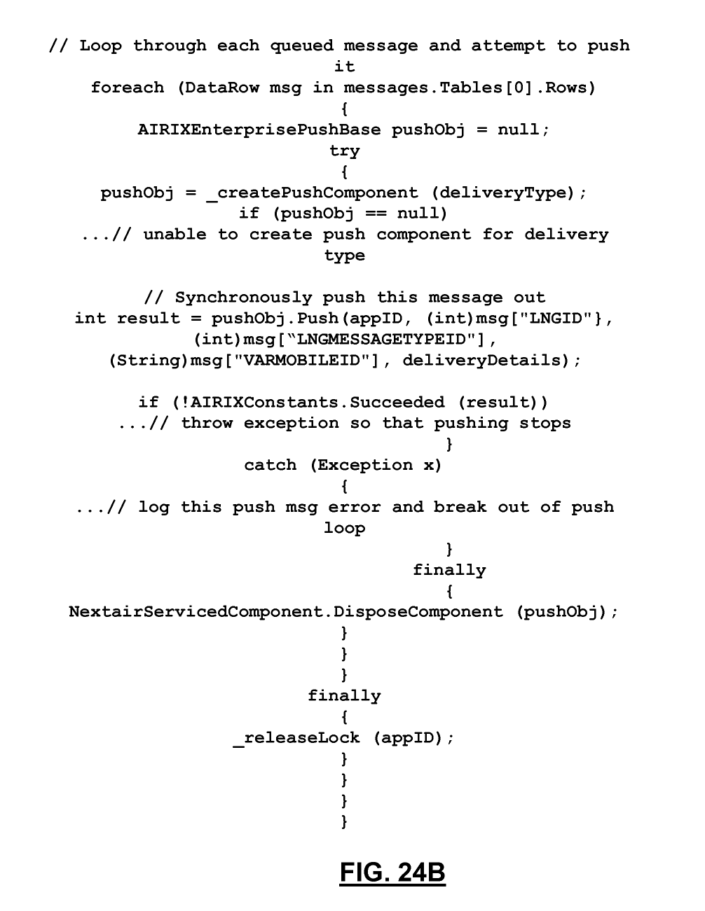

A basic implementation of the AIRIXEnterpriseWakeup component is shown in FIGS. 24A and 24B This component could have attributes such that object pooling is enabled, object construction is enabled, and it has a transactional type of “Required”.Any single push message 900 failure during the execution of the Wakeup method could result in the termination of the pushing attempt, followed by a release of the enterprise application of the data source 70 lock. of the interface 300. This will provide that messages 900 are sent sequentially (in the order they were received). The push attempt will be retried either the next time an application-bound message is received from a mobile 10 for that enterprise application of the data source 70, or when the automatic push retry is executed (whichever comes first). In this regard, it will be recalled that a push message failure is judged to have occurred when the enterprise server 70 returns a message indicating the failure or when, during a push attempt, a communications protocol layer times out.

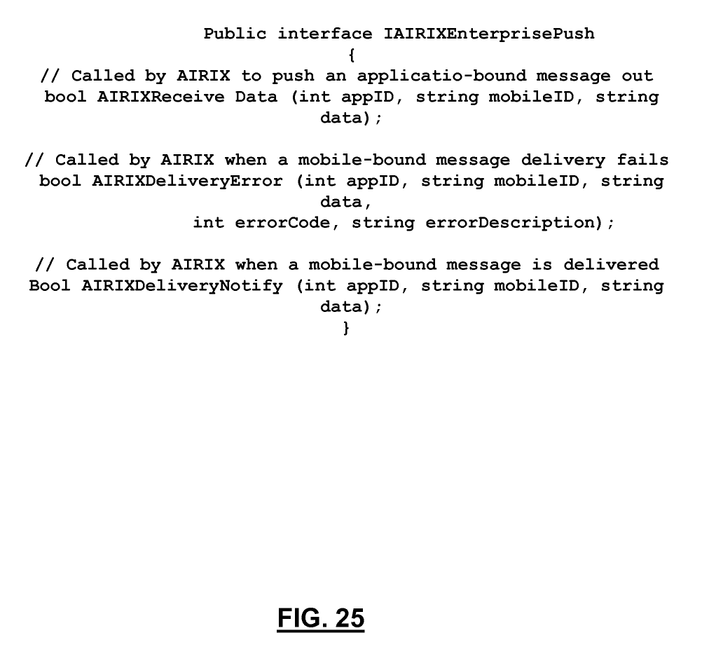

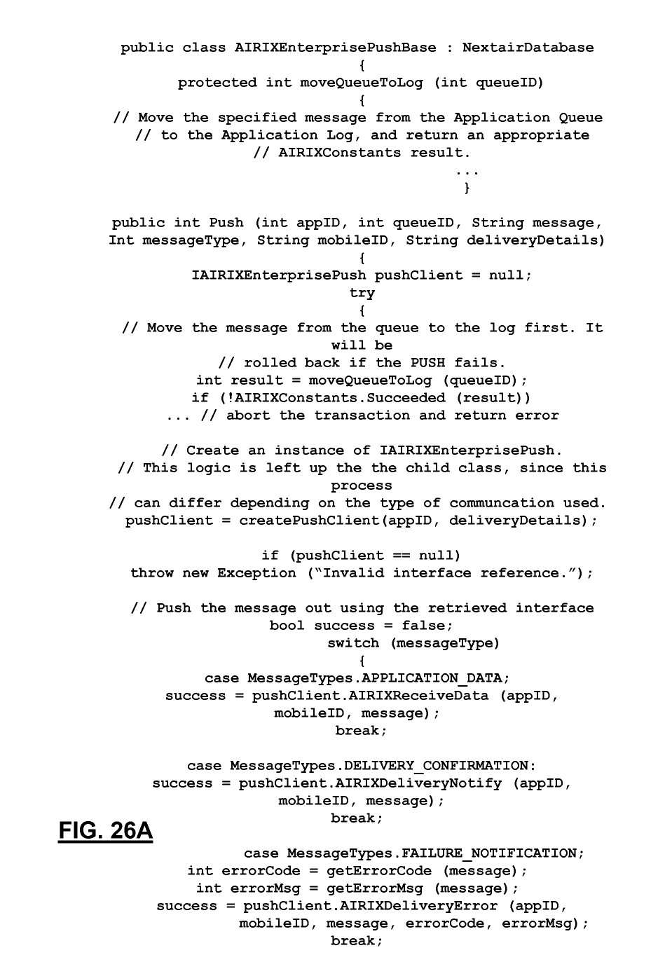

An interface called IAIRIXEnterprisePush of the interface 914 may serve as a base type for all descendent classes that need to implement PUSH functionality. This class may belong to a namespace identified as the Nextair.AIRIXServer.Enterprise.Push. The actual use of this class is documented hereinafter, however, the C# source code for this interface definition is shown in FIG. 25.

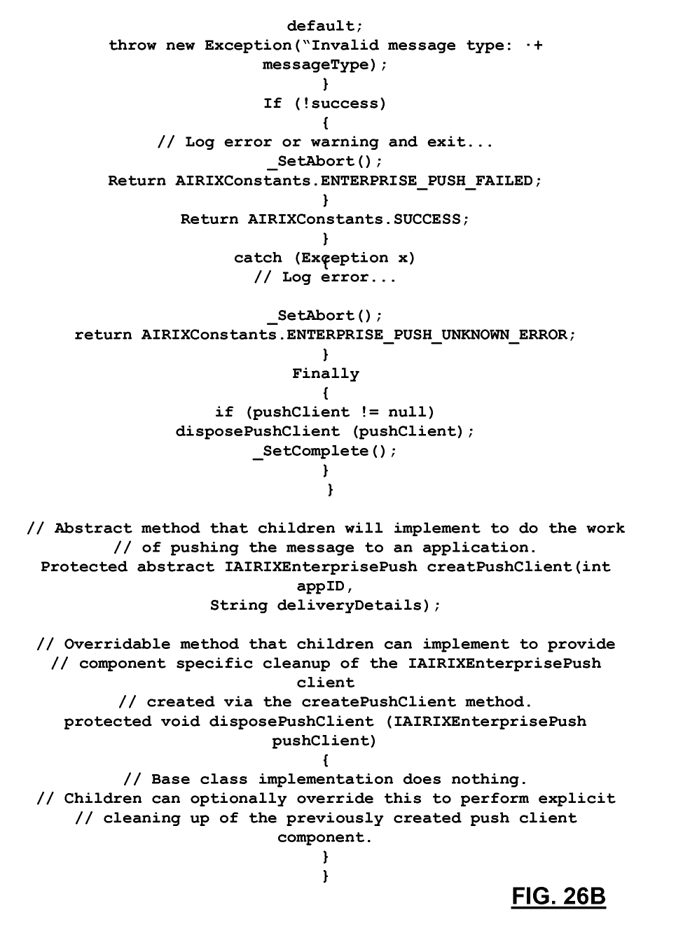

An enterprise push abstract base class can be created, which will parent all push implementation classes. This abstract class can provide common functionality to all of its child classes. The class can belong to a namespace identified as Nextair.AIRIX.Server.Enterprise.Push namespace. The AIRIXEnterprisePushBase class can inherit NextairDatabase, which provides general database access and component services routines. This abstract base class can provide basic functionality required from all push components. The class will initially provide a single public method (called Push). The Push method will provide a base implementation of the message 900 push. It can call the abstract createPushClient method to do the actual work of connecting to and/or obtaining a reference to an IAIRIXEnterprisePush object that can be used to push a message 900 out to the interface 300. Since this method is abstract, all children classes will implement it. The template of FIGS. 26A and 26B suggests a basic implementation for this class.

Since the sending of an actual message 900 to the enterprise application of the data source 70 is a non-transactional request, the moveQueueToLog method should be called before attempting to push a message 900 out (as can be seen in the sample implementation above). If the push fails, the transaction will be aborted, causing moveQueueToLog to be rolled back. Note that if this were done in the reverse order, the push could succeed, then MoveQueueToLog could fail—in which case the push would not be able to be rolled back (because it is non-transactional), and a duplicate message would eventually be delivered to the enterprise application of the data source 70. In the event that MoveQueueToLog fails, the transaction should be aborted and the caller (child class) should not attempt to push the message.

The following discusses suitable implementations for the delivery types COM, DCOM, SOAP, .Net, and .NetRemoting of the interface 300.

### COM and DCOM

To configure the Transaction Server 44 so as to be able to push data source 70-bound messages 900 to enterprise server applications via COM, a COM push can be created in a namespace identified as Nextair.AIRIXServer.Enterprise.Push. The COM interface 300 can be exposed by enterprise applications of the data sources 70 wishing to receive inbound data via COM interface 300. This interface 300 may be deployed with the Transaction Server 44 (in a “lib” directory), and can be a simple COM type library file (.tlb) that can be imported by Enterprise Application developers and implemented.

The COM interface 300 in conjunction with the interface 914 will declare the following methods:
AIRIXReceiveData 908—Called by the ATS when a message is to be pushed to an enterprise application.
AIRIXDeliveryError 910—Called by the ATS when an error occurs trying to deliver a message to a mobile.

AIRIXDeliveryNotify 912—Called by the ATS when a message is successfully delivered to a mobile.

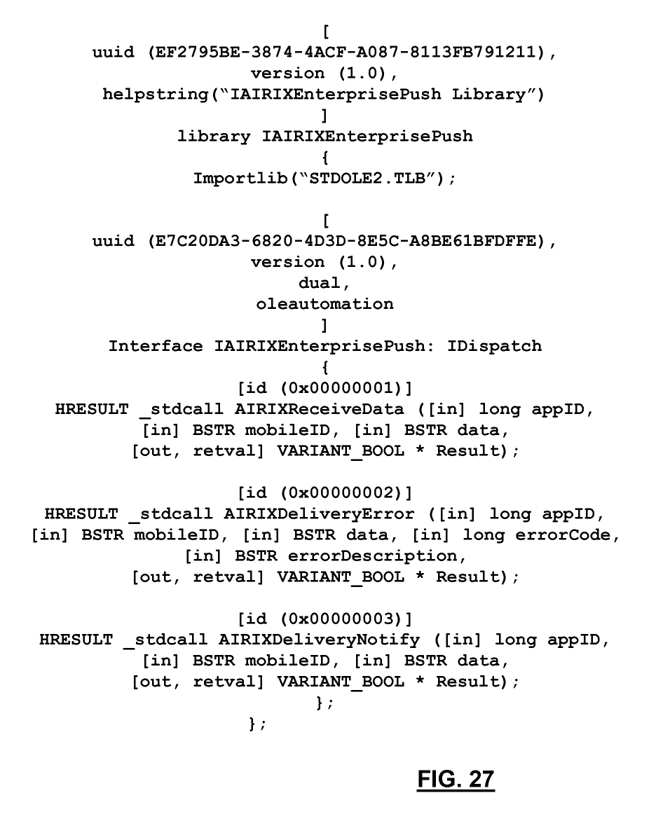

The MIDL skeleton code of FIG. 27 declares the COM interface 300 enterprise applications of the data source 70 can to implement to receive COM PUSH messages 900 from the interface 914 of the ATS.

In order for the ATS to push the message 900 to the COM based enterprise applications of the data source 70, the COM component developed for the enterprise application of the data source 70 should meet the following:
1) Implement the IAIRIXEnterprisePush COM interface 300 exposed by the Transaction Server 44 (in the ATS “lib” directory) according to the interface 914.
2) Register the COM component on the Transaction Server 44 machine. Note that communication over DCOM is also possible provided the appropriate DCOM settings are applied to the component on the ATS machine.
3) Specify the ProgID (Class and CoClass) of the COM component (for example, “DispatchForce.AIRIXReceive”) in the delivery details of the enterprise application of the data source 70, which is provisioned via the Transaction Server 44 Console.

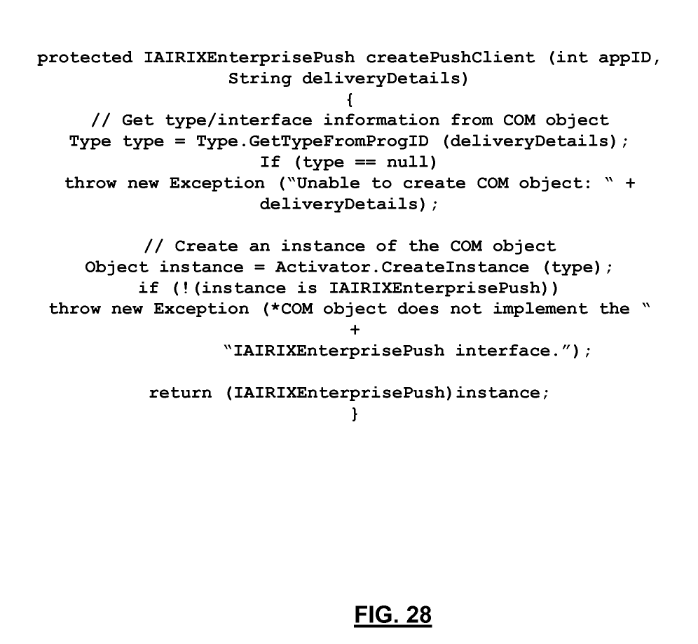

A .NET Serviced Component named AIRIXEnterprisePushCOM inherits from AIRIXEnterprisePushBase and handles the actual pushing of data (via COM) to enterprise application of the data source 70. The implementation of the AIRIXEnterprisePushBase createPushClient method for this class can create an instance of the COM component that is specified in the delivery details of the associated enterprise application of the data source 70. The “delivery details” string for COM PUSH enabled enterprise applications of the data source 70 is simply the ProgID (Class.CoClass) of the COM component to push to. The pseudo-code of FIG. 28. shows a basic implementation of the createPushClient method for the AIRIXEnterprisePushCOM component (without error handling).

### Soap

To allow pushing via SOAP, a push component of the interfaces 300, 914 capable of executing method calls against a Web Service via SOAP over HTTP is used. The location (URL) and identity of the web service will be retrieved at runtime. This class can also belong to the Nextair.AIRIX.Server.Enterprise.Push namespace.

The SOAP PUSH delivery method will help enterprise application developers to integrate with the Transaction Server 44 from virtual any platform. This delivery type is intended for use by enterprise applications of the data source 70 that meet one or more of the following criteria: 1) Are not hosted on a Microsoft Windows-based platform (or that run on top of a non-Microsoft virtual machine, such as a Java VM); 2) Are not written in a .NET compatible language (i.e. legacy C++, VB, Delphi, etc); and 3) Require secure communications between the Transaction Server 44 and the enterprise application of the data source 70 (sometimes required when the Enterprise Application is not located on the same LAN as the ATS).

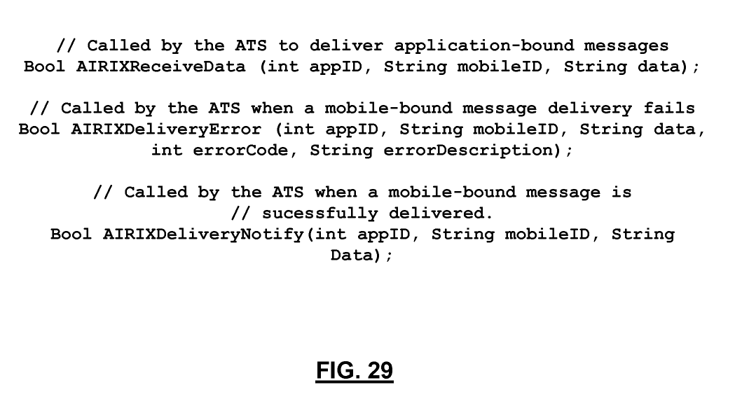

Enterprise Applications of the data source 70 wishing to use the SOAP PUSH delivery type expose a WSDL interface containing the interface methods shown in FIG. 29 (which are the same as the methods declared in the IAIRIXEnterprisePush interface).

Once the above methods 908, 910, 912 are implemented in an exposed web service (e.g. data source 70), the enterprise application of the data source 70 tells the Transaction Server 44 where to find the WSDL file and what the name of the exposed service is. This information may be specified in the delivery details configuration for the ATS application definition as follows:

<Service Url=“http://myweb/testsvc.asm×” Name=“ . . . ”/>

Enterprise Application developers and/or ATS administrators will not need to know the format of the above construct string, as the Transaction Server Console can provide an intuitive interface for entering this information if the SOAP PUSH Delivery type is selected.

The new AIRIXEnterprisePushSOAP ATS component will extend AIRIXEnterprisePushBase. Its “createPushClient” implementation will do the work of pushing the specified message to the enterprise application of the data source 70 using the application configured WSDL location and Web Service Name. In order to help prevent having to parse and reload the entire WSDL document every request (which could be extremely time consuming), the Transaction Server 44 can perform intelligent caching of a pre-compiled proxy assemblies for each SOAP PUSH enabled application. This caching may work as follows:
The first time an enterprise application's WSDL file is accessed, the ATS loads the WSDL file and compiles it into a binary proxy assembly on the ATS machine. This proxy is then used to send SOAP requests to the enterprise application without having to re-parse the entire WSDL document each request.
The AIRIXEnterprisePushSOAP component contains a static HashTable of compiled SOAP proxy assemblies for applications. Since this HashTable is static, it will be shared between all instances of AIRIXEnterprisePushSOAP components. To prevent multiple components from modifying the HashTable simultaneously, the AIRIXEnterprisePushSOAP component should synchronize access to this table.

### .NET

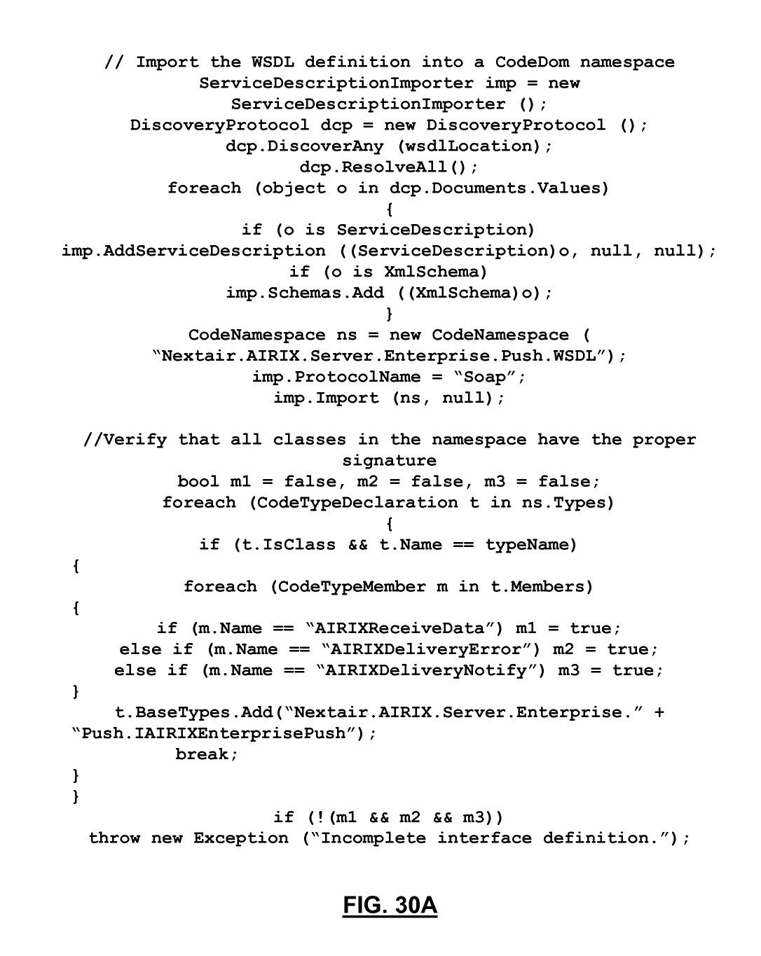

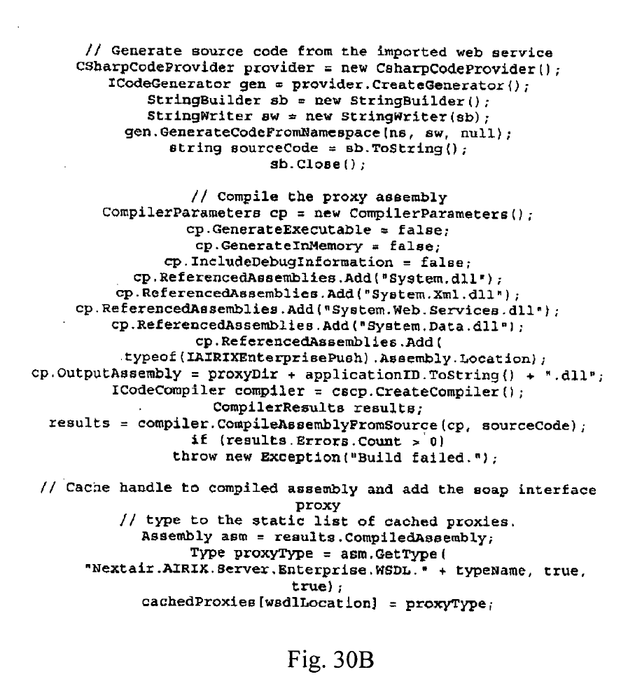

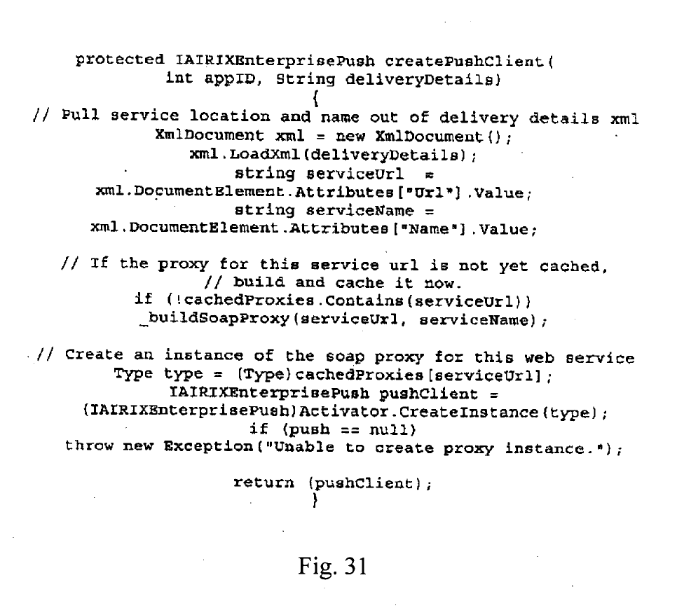

The code snippet of FIGS. 30A and 30B indicates how this proxy assembly compilation can be accomplished in .NET (note that for simplicity, this code does not contain any error handling). As noted from the source code in FIGS. 30A and 30B, when initially building the proxy assembly, the compiled proxy class can be forced to implement the IAIRIXEnterprisePush interface 914 and 300. This will both validate that the enterprise application SOAP interface 300 is compliant and it will allow the ATS to communicate to enterprise applications via the interface 914 through a handle to this interface 300. The pseudo-code of FIG. 31 provides a basic implementation of the AIRIXEnterprisePushSOAP.createPushClient method.

Failure to load and/or build the proxy assembly for an enterprise application's WSDL interface 300 should result in exceptions being generated and logged in the ATS 44. For simplicity, this implementation can require that any interface changes to an enterprise application's WSDL file result in the Transaction Server 44 Component Services application being restarted (so that the WSDL proxy assembly is rebuilt).

### .NET Remoting

For a push component capable of executing method 908, 910, 912 calls against a .NET Remoting interface 300 over a TCP connection, the location (server name or IP address) and identity of the Remoting service can be retrieved at runtime. Again, this class can belong to the Nextair.AIRIX.Server.Enterprise.Push namespace. .NET Remoting allows the data source 70 and the server 44 to communicate across application, machine, and network boundaries. Although Remoting calls can be made over a variety of different underlying network protocols, the most prevalent is TCP.

For present purposes, the Remoting clients and servers will communicate over TCP/IP on a specified port number. From a high level, Remoting servers act like an Object Broker. That is, they simply provide one or more objects to clients. The fact that Remoting is capable of passing objects by reference (instead of requiring complete object serialization like other similar technologies) means that enterprise applications wishing to integrate with the ATS via Remoting can experience better performance than they would with SOAP. Also, the binary nature of communication also can make Remoting a more network friendly protocol than SOAP.

In order for an Enterprise Application of the data source 70 to receive push messages 900 via Remoting, the enterprise application of the data source 70 should meet the following requirements:
Expose a service type (object/interface) that implements the IAIRIXEnterprisePush class (located in the Nextair.AIRIX.Server.Enterprise.Push namespace/assembly).
Provide the following information to the Transaction Server 44 (via the Transaction Server Console application provisioning screens):
   Remoting Service Name
   Remoting Service Port Number
   Machine Name or IP Address

Whether or not the Remoting server interface 300 is registered as a SingleCall or Singleton type is entirely up to the enterprise application developer.

The delivery details string for Remoting push enabled applications can be in the following format:

<Service Name=“ . . . ” Port=“ . . . ” Location=“ . . . ”/>

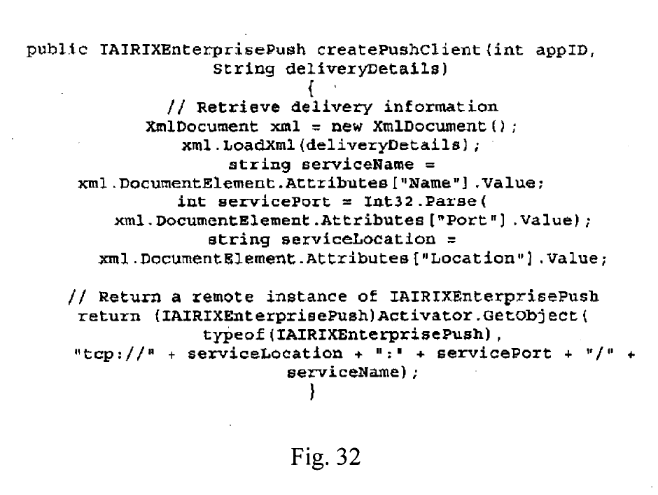

Implementation of the AIRIXEnterprisePushRemoting component should be relatively straightforward. The Transaction Server 44 simply needs to retrieve the appropriate delivery details from the configuration string, create an instance of a remote IAIRIXEnterprisePush component, and attempt to call the appropriate interface 300 method 908, 910, 912. The pseudo-code of FIG. 32 suggests a basic implementation.

If the push client (IAIRIXEnterprisePush) cannot be created, the createPushClient method should throw an exception. As will be understood by those skilled in the art, push delivery can also be extended to additional delivery types.

It is possible with this proposed Push design, that the message 900 could essentially be “stuck” in the application queue 690. The queues 690 (FIG. 2) may be First-In First-Out and the delivery of all queued messages for a particular application of the data source 70 initiated by the queuing of another message 900. If an attempted push to the Enterprise fails, the message 900 will remain queued until the next message 900 destined for that particular data source 70 is queued. Therefore, all queued messages 900 will be “stuck” in the application queue 690 until the next message 900 arrives. This suggests a need for a mechanism by which an attempt to push the message can be initiated by the Transaction Server 44 automatically (even with no new incoming messages) via the interface 914.

A service application (simply named Retry Service) can be provided with two main functions:
1) It will initiate a push retry check for applications on a configurable interval.
2) It will expose an interface whereby it can serve as a central “application lock provider”. That is, in a clustered type of environment, the service can hand out application locks to push components on one or more machines.

The service can be part of the Nextair.AIRIX.Server namespace. The service can contain a timer that fires on some configurable interval. This interval can be set in a configuration file for the service. When the timer fires, the service will simply create an instance of the AIRIXEnterpriseRouter component, and call its Retry method. This, in turn, will check for expired messages for all push-enabled applications and attempt to push those messages out. The retry configuration setting of the configuration file for the service will look as follows:

<Retry Interval=“RETRY_INTERVAL_SECS”
MsgExpiry=“EXPIRY_TIME_SECS” />

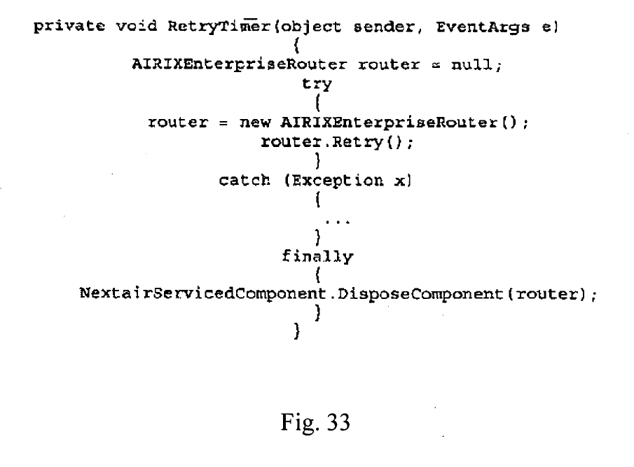

The code snippet of FIG. 33 suggests how this retry timer method could be implemented. Since the AIRIXEnterpriseRouter Retry method already implements all required retry logic, this is all that is done of the Retry Service to enable automatic retries. Also, since the Retry method in turn calls the AIRIXEnterpriseWakeup component to push messages 900 out, it does not have to worry about pushing duplicate messages 900 (or any other special handling)—this is all done in the Wakeup component of the interface 914.

A Remote Locking Service can contain an interface that is capable of acting as a central application lock provider, distributing application locks to callers from possibly multiple machines. This interface is needed for the rare occasion where a customer will want to scale the Transaction Server 44 sideways (in a clustering environment). Although this interface will exist, by default it may not be used since most ATS installations will consist of a single ATS machine only.

The Remote Locking Service will expose the AIRIXRemotingLockManager object (which will be a remotable interface to the AIRIXLockManager class) via the Remoting interface 300. When clustering is enabled, this interface will be called by the AIRIXEnterpriseWakeup component to obtain application locks of the interface 300 before attempting to push messages 300 to the application of the data source 70. The Remote Locking Service configuration will contain a section that specifies the port number to expose the locking interface on, as follows:

<LockInterface Port=“XXXX”/>

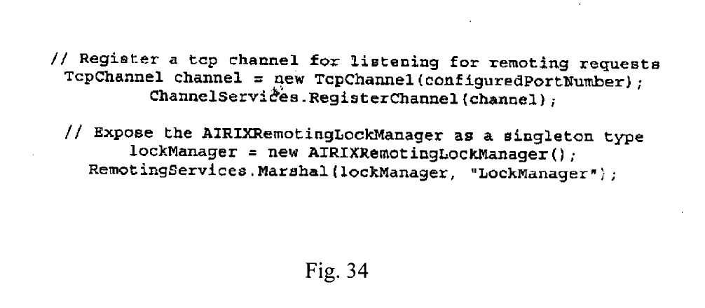

The actual code for exposing the AIRIXLockManager to clients is quite simple, and can be implemented in service startup, such as illustrated in FIG. 34.

Note from FIG. 34 that the object is registered as a Singleton type, which means that only one instance of the object will ever be created. This is fine for present purposes since synchronizing occurs inside the locking component, and only a single caller is ever allowed to obtain or release a lock simultaneously. Also, since the AIRIXLockManager contains only static methods and properties, an AIRIXRemotableLockManager class may simply be a marshal-by-reference object that wraps calls to the static AIRIXLockManager class.

Failure to register the AIRIXRemotableLockManager object on the configured port should result in an error being logged. The same goes for a failure to create and call the AIRIXEnterpriseRouter Retry method. The Transaction Server may be installed on a Windows 2000 or 2003 server platform; the Enterprise application can run on virtually any platform as long as it supports one of COM, SOAP or .NET Remoting.

While the transaction server 44 has been described as queuing an incoming message and then trying to push each message 900 on the queue 690, the approach could be modified such that an incoming message is pushed directly to the application of the data source 70 if the queue 690 for that application is empty. In this modified approach, if the direct push of the incoming message 900 failed, that message 900 would then need to be queued. further, it is recognised that the above described interfaces 300, 914 may be implemented via the tool 116 without using queuing 690, as desired.

### Operation of the Application 105 Set-Up and Device Communication

FIG. 12 illustrates a flow diagram detailing data (application data or application definition files 28) flow between mobile device 10 and middleware server 44, in manners exemplary of an embodiment of the present invention.

For data requested from middleware server 44, device 10, under software control by virtual machine software 24 makes requests to middleware server 44 (also illustrated in FIG. 5), which passes over the wireless network 36 through network gateway 40. Network gateway 40 passes the request to the middleware server 44. Middleware server 44 responds by executing a database query on its database 46 that finds which applications are available to the user and the user's mobile device. For data passed from middleware server 44 to device 10, data is routed through network gateway 40. Network gateway 40 forwards the information to the user's mobile device over the wireless network 36.

FIG. 12 when considered with FIG. 1 illustrates a sequence of communications between device 10, and middleware server 44 that may occur when the user of a mobile device 10 wishes to download an application definition file 28 for a server side application.

So, initially, device 10 interrogates server 44 to determine which applications are available for the particular mobile device being used. This may be accomplished by the user instructing the virtual machine software 24 at device 10 to interrogate the server 44. Responsive to these instructions the virtual machine software 24 sends an XML message to the server requesting the list of applications (data flow 72); as illustrated in FIG. 12 the XML message may contain the <FINDAPPS> tag, signifying to the middleware server 44, its desire for a list available application. In response, middleware server 44 makes a query to database 46. Database 46, responsive to this query, returns a list of applications that are available to the user and the mobile device. The list is typically based, at least in part, on the type of mobile device making the request, and the applications known to middleware server 44. Middleware server 44 converts this list to an XML message and sends to the virtual machine (data flow 74). Again, a suitable XML tag identifies the message as containing the list of available applications.

In response, a user at device 10 may choose to register for an available server side application. When a user chooses to register for an application, virtual machine software 24 at device 10 composes and sends an XML registration request for a selected application (data flow 76) to middleware server 44. As illustrated in FIG. 13, an XML message containing a <REG> tag is sent to middleware server 44. The name of the application is specified in the message. The middleware server 44, in response, queries its database for the user interface definition for the selected application for the user's mobile device. Thereafter, the middleware server creates the application definition file, as detailed with reference to FIG. 1. Then, middleware server 44 sends to the mobile device (data flow 78) the created application definition file 28.

The user is then able to use the functionality defined by the interface description to send and receive data.

At this time, parser 61 of virtual machine software 24 may parse the XML text of the application definition file to form a tokenized version of the file. That is, each XML tag may be converted a defined token for compact storage, and to minimize repeated parsing of the XML text file. The tokenized version of the application definition file may be stored for immediate or later use by device 10.

Thereafter, upon invocation of a particular application for which the device 10 has registered, the screen generation engine 67 of the virtual machine software 24 at the device causes the virtual device to locate the definition of an initial screen for that application. The initial screen is identified within the application definition file 28 for that application using a <SCREEN> tag, and an associated attribute of <First screen=“yes”>.

Steps performed by virtual machine software 24 in processing this screen (and any screen) are illustrated in FIG. 13. As illustrated, screen generation engine 67, generates an instance of an object class, defining a screen by parsing the section of the XML application definition file corresponding to the <SCREEN> tag in step S802. Supported screen elements may be buttons, edit boxes, menus, list boxes, and choice items, as identified in sections 5.3, 5.4, and 5.5 of Appendix “A”. Other screen elements, such as images and checkboxes, as detailed in Appendix “A” may also be supported. For clarity of illustration, their processing by screen generation engine 67 however, is not detailed. Each supported tag under the SCREEN definition section, in turn causes creation of instances of object classes within the virtual machine software 24. Typically, instances of objects corresponding to the tags, used for creation of a screen, result in presentation of data at mobile device 10. As well the creation of such objects may give rise to events (e.g. user interaction) and actions to be processed at device 10.

Each element definition causes virtual machine software 24 to use the operating system of the mobile device to create corresponding display element of a graphical user interface as more particularly illustrated in FIG. 14. Specifically, for each element, the associated XML definition is read in step S806, S816, S826, S836, and S846, and a corresponding instance of a screen object defined as part of the virtual machine software 24 is created by the virtual machine software 24 in steps S808, S818, S828, S838 and S848, in accordance with steps S902 and onward illustrated in FIG. 14. Each interface object instance is created in step S902. Each instance takes as attribute values defined by the XML text associated with the element. A method of the virtual object is further called in step S904, and causes a corresponding device operating system object to be created. Those attributes defined in the XML text file, stored within the virtual machine object instance are applied to the corresponding instance of a display object created using the device operating system in steps S908S-S914. These steps are repeated for all attributes of the virtual machine object instance. For any element allowing user interaction, giving rise to an operating system event, the event handler 65 of virtual machine software 24 is registered to process operating system events, as detailed below.

Additionally, for each event (as identified by an <EVENT> tag) and action (as identified by an <ACTION> tag) associated with each XML element, virtual machine software 24 creates an instance of a corresponding event and action object forming part of virtual machine software 24. Virtual machine software 24 further maintains a list identifying each instance of each event and action object, and an associated identifier of an event in steps S916 to S928.

Steps S902-S930 are repeated for each element of the screen in steps S808, S818, S828, S838 and S848 as illustrated in FIG. 13. All elements between the <SCREEN> definition tags are so processed. After the entire screen has been so created in memory, it is displayed in step S854, using conventional techniques.

As will be appreciated, objects specific to the type of device executing the virtual machine software 24. Functions initiated as a result of the XML description may require event handling. This event handling is processed by event handler 65 of virtual machine software 24 in accordance with the application definition file 28. Similarly, receipt of data from a mobile network will give rise to events. Event handler 65, associated with a particular application presented at the device similarly processes incoming messages for that particular application. In response to the events, virtual machine software 24 creates instance of software objects, and calls functions of those object instances, as required by the definitions contained within the XML definitions contained within the application definition file 28, giving rise to the event.

As noted, the virtual machine software 24 includes object classes, allowing the virtual machine to create object instances corresponding to an <EVENT> tag. The event object classes includes methods specific to the mobile device that allow the device to process each of the defined XML descriptions contained within the application definition file, and also to process program/event flow resulting from the processing of each XML description.

Events may be handled by virtual machine software 24 as illustrated in FIG. 15. Specifically, as device handler 65 has been registered with the operating system for created objects, upon occurrence of an event, steps S1002 and onward are performed in response to the operating system detecting an event.

An identifier of the event is passed to event handler 65 in step S1002. In steps S1004-S1008, this identifier is compared to the known list of events, created as a result of steps S916-S930. For an identified event, actions associated with that event are processed in step S1008-S1014.

That is, virtual machine software 24 performs the action defined as a result of the <ACTION> tag associated with the <EVENT> tag corresponding to the event giving rise to processing by the event handler 65. The <ACTION> may cause creation of a new screen, as defined by a screen tag, a network transmission, a local storage, or the like.

New screens, in turn, are created by invocation of the screen generation engine 61, as detailed in FIGS. 13 and 14. In this manner the navigation through the screens of the application is accomplished according to the definition embodied in the XML application description.

Similarly, when the user wishes to communicate with the middleware server, or store data locally, event handler 65 creates instances of corresponding object classes within the object classes 69 of virtual machine software 24 and calls their methods to store or transmit the data using the local device operating system. The format of data is defined by the device local definition section 52; the format of network packages is defined in the network transaction package definition section 50.

For example, data that is to be sent to the wireless network is assembled into the correct XML packages using methods within an XML builder object, formed as a result of creating an instance of a corresponding object class within object classes 69 of virtual machine software 24. Methods of the XML builder object create a full XML package before passing the completed XML package to another message server object. The message server object uses the device's network APIs to transmits the assembled data package across the wireless network.

Received XML data packages from network 63 (FIG. 5) give rise to events processed by event handler 65. Processing of the receipt of data packages is not specifically illustrated in FIG. 14. However, the receipt of data triggers a “data” event of the mobile device's operating system. This data event is passed to the virtual machine, and event handler 65 inspects the package received. As long as the data received is a valid XML data package as contained within the application definition, the virtual machine inspects the list of recognised XML entities.

So, for example, a user could send a login request 80 by interacting with an initial login screen, defined in the application definition file for the application. This would be passed by the middleware server 44 to the backend application server 70. The backend application server according to the logic embedded within its application, would return a response, which the middleware server 44 would pass to the virtual machine software 24. Other applications, running on the same or other application servers might involve different interactions, the nature of such interactions being solely dependent on the functionality and logic embedded within the application server 70, and remaining independent of the middleware server 44.

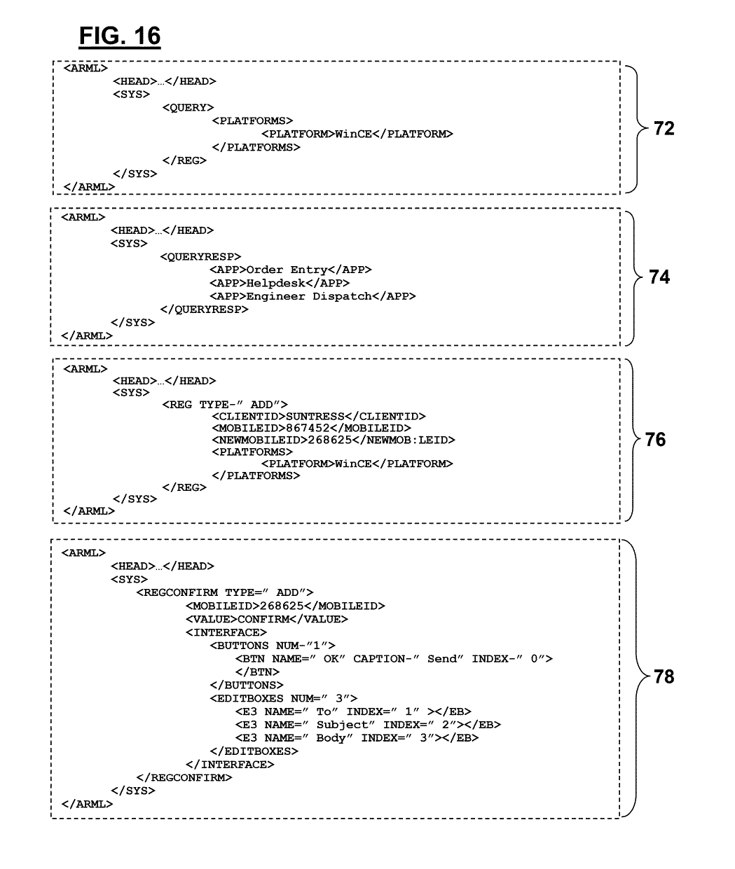

FIG. 16 illustrates sample XML messages passed as the result of message flows illustrated in FIG. 2. For each message, the header portion, between the <HEAD> . . . </HEAD> tags contains a timestamp and the identifier of the sending device.

Example message 72 is sent by the mobile device to request the list of applications that the server has available to that user on that device. It specifies the type of device by a text ID contained between the <PLATFORM> . . . </PLATFORM> tags. Example message 74 is sent in response to message 70 by middleware server 44 to the mobile device 10. It contains a set of <APP> . . . </APP> tag pairs, each of which identifying a single application that is available to the user at device 10. Example message 76 is sent from the mobile device 10 to middleware server 44 to register for a single server side application. The tags specify information about the user. Message 78 is sent by the middleware server 44 to the mobile device in response to a request to register device 10 for an application. The pair of tags <VALUE> . . . <VALUE> gives a code indicating success or failure. In the sample message shown, a success is shown, and is followed by the interface description for the application, contained between the <INTERFACE> . . . </INTERFACE> tags. This interface description may then be stored locally within memory 16 of device 10.

As noted, when a user starts an application that has been downloaded in the manner described above, the virtual machine software 24 reads the interface description that was downloaded for that device 10, and the virtual machine software 24 identifies the screen that should be displayed on startup, and displays its elements as detailed in relation to FIGS. 14 and 15. The user may then use the functionality defined by the user interface definition section 48 of the application definition 28 to send and receive data from a server side application.

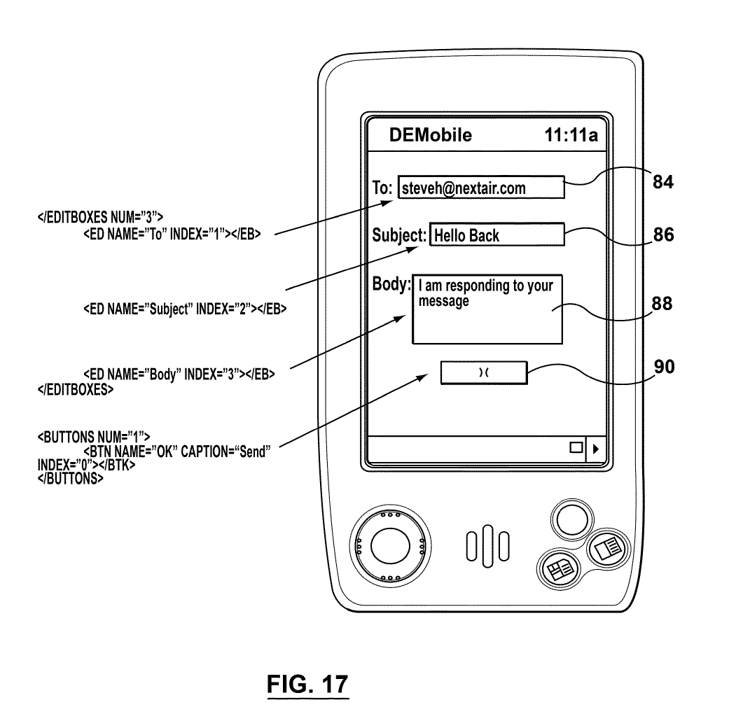

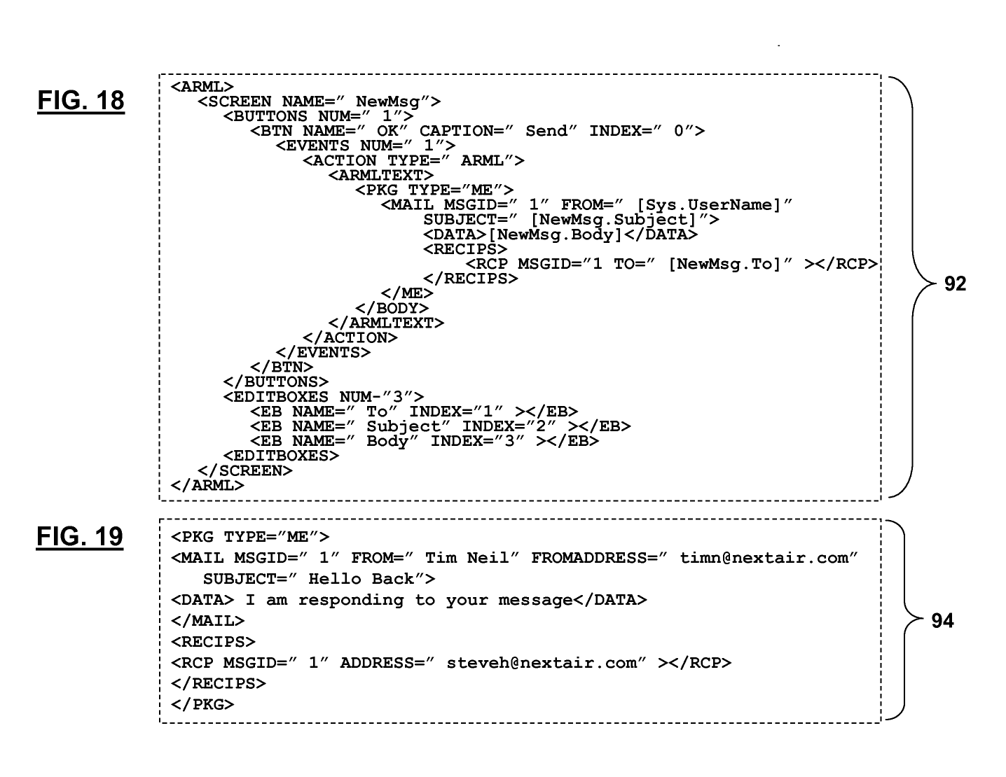

For the purposes of illustration, FIGS. 17 and 18 illustrate the presentation of a user interface for a sample screen on a Windows CE Portable Digital Assistant. As illustrated in FIG. 18, a portion of an application definition file 28 defines a screen with the name ‘New Msg’. This interface description may be contained within the user interface definition section 48 of an application definition file 28 associated with the application. The screen has a single button identified by the <‘BTN NAME’=“OK”, CAPTION=“Send” INDEX=“0”> tag, and identified as item D in FIG. 17. This button gives rise to a single event, (identified by the <EVENTS NUM=“1” tag) giving rise to a single associated action (defined by the tag <ACTION TYPE=“ARML”>). This action results in the generation of a network package (defined by the tag <PKG TYPE=“ME”>), having an associated data format as defined between the corresponding tags. Additionally, the screen defines three editboxes, as defined after the <EDITBOXESNUM=3> tag, and identified as items A, B, and C.

Upon invocation of the application at the local device, screen generation engine 67 of virtual machine software 24 at the device process the screen definition, as detailed with reference to FIGS. 13 and 14. That is, for each tag D, the screen generation engine 67 creates a button object instance, in accordance with steps S804-S812. Similarly for each tag A, B and C within the application definition file, virtual machine software 24 at the device creates instances of edit box objects (i.e. steps S834-S842 (FIGS. 13 and 14)). The data contained within the object instances reflects the attributes of the relevant button and edit box tags, contained in the application definition 28 for the application.

The resulting screen at the mobile device is illustrated in FIG. 17. Each of the screen items is identified with reference to the XML segment within XML portion 92 giving rise to the screen element. The user interface depicts a screen called ‘NewMsg’, which uses the interface items detailed in FIG. 13, but which adds the ability to compose and send data. This screen has three edit boxes, named ‘To’, ‘Subject’ and ‘Body’ as displayed in FIG. 13 (84, 86, 88); these are represented by the XML tags A, B and C. The screen also incorporates a button, named ‘OK’, also as displayed in FIG. 17 (90), which is represented by the XML tag D.

Call-backs associated with the presented button cause graphical user interface application software/operating system at the mobile device to return control to the event handler 65 of virtual machine software 24 at the device. Thus, as the user interacts with the application, the user may input data within the presented screen using the mobile device API. Once data is to be exchanged with middleware server 44, the user may press the OK button, thereby invoking an event, initially handled by the operating system of the mobile device. However, during the creation of button D, in steps S804-S810 any call-back associated with the button was registered to be handled by event handler 65 of virtual machine software 24. Upon completion, virtual machine software 24 receives data corresponding to the user's interaction with the presented user interface and packages this data into XML messages using corresponding objects, populated according to the rules within the application definition file 28.

Event handler 65, in turn processes the event caused by interaction of the button in accordance with the <EVENT> tag and corresponding <ACTION> tag associated with the button D. The events, and associated actions are listed as data items associated with the relevant user interface item, as result of the EVENT and ACTION tags existing within the definitions of the relevant user interface item, within the application definition file 28. This <ACTION> tag causes the virtual machine software 24 to create an instance of an object that sends an XML package to the middleware server in accordance with the format defined between the <ACTION> tag. That is, a “template” (defined after the <PKG TYPE=“ME”> tag) for the XML package to be sent is defined against the EVENT handler for a given user interface item. This template specifies the format of the package to be sent, but will include certain variable fields. These are pieces of data in the formatted XML package that will vary according to the values contained in data entry fields on the current and previous screens. The definition of the template specifies which data entry field should be interrogated to populate a given entry within a data package that is to be sent.

This template fills some of its fields dynamically from data inserted by a user into edit boxes that were presented on the mobile device's screen. The template has within it certain placeholders delimited by square brackets ([, ]). These placeholders specify a data source from which that section of the template should be filled. A data source might be a user interface field on the current screen, a user interface field on the previous screen, or a database table. Virtual machine software 24, reading the data source name, searches for the field corresponding to that data source and replaces the placeholder with actual data contained within the data source. For example, the SUBJECT attribute of the MAIL tag in XML portion 92 is read from the edit box named ‘Subject’ on the screen named ‘NewMsg’ This process is repeated for each such placeholder, until the virtual machine, reading through the template has replaced all placeholders in the template. At this point the template has been converted into a well-formed XML message 94.

A resulting XML message 94 containing data formed as a result of input provided to the fields of the “NewMsg” screen is illustrated in FIG. 19. This exemplary XML message 94 that is created by pressing the button 90 in XML message portion 92. In this case, the editbox 86 named ‘Subject’ contains the text “Hello Back”; the editbox 84 named ‘To’ contains the text “steveh@nextair.com”; and the editbox 88 named Body contains the text “I am responding to your message”.

The virtual machine software 24 using the template inspects these three fields, and places the text contained within each edit box in the appropriate position in the template. For example, the placeholder [NewMsg.Subject] is replaced by “Hello Back”. The virtual machine software 24, inspecting the template contained in the XML message portion 92 and populating the variable fields, creates the sample XML message 94 by invoking the functionality embedded within an XML builder software object. Once the XML message 94 has been assembled in this fashion, the relevant method of the message server object is then invoked to transmit the XML message 94 in a data package across the network.

Similarly, when data is received, the event handler 65 of the virtual machine software 24 is notified. In response, the event handler examines the data package that it has received using the parser 61 to build a list of name value pairs containing the data received. Thereafter, methods within an object class for processing incoming packets are invoked to allow virtual machine software 24 to inspect the application definition for the application to identify the fields in the database and user interface screens that need to be updated with the new data. Where screens are updated, this is done according to the procedures normal to that device 10.

Handling of incoming packages is defined in the application definition file 28 at the time the application description file was downloaded. That is, for each of the possible packages that can be received, application description file 28 includes definitions of database tables and screen items that should be updated, as well as which section of the package updates which database or screen field. When a package is received, event handler 65 of virtual machine software 24 uses rules based on the application description file 28 to identify which database and screen fields need to be updated.

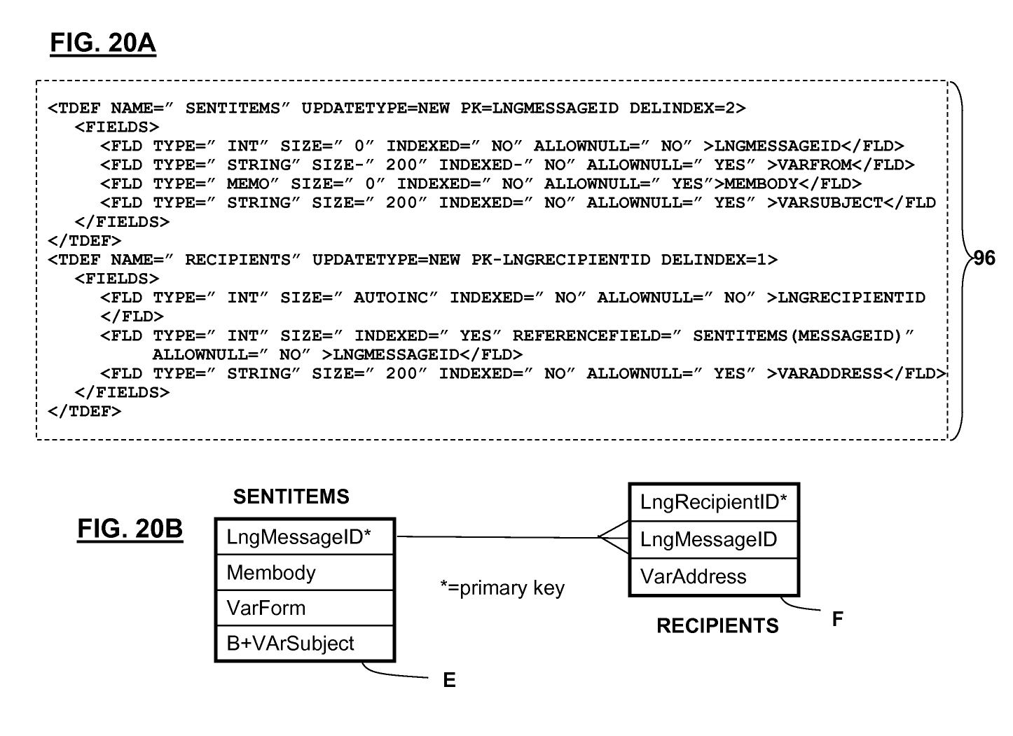

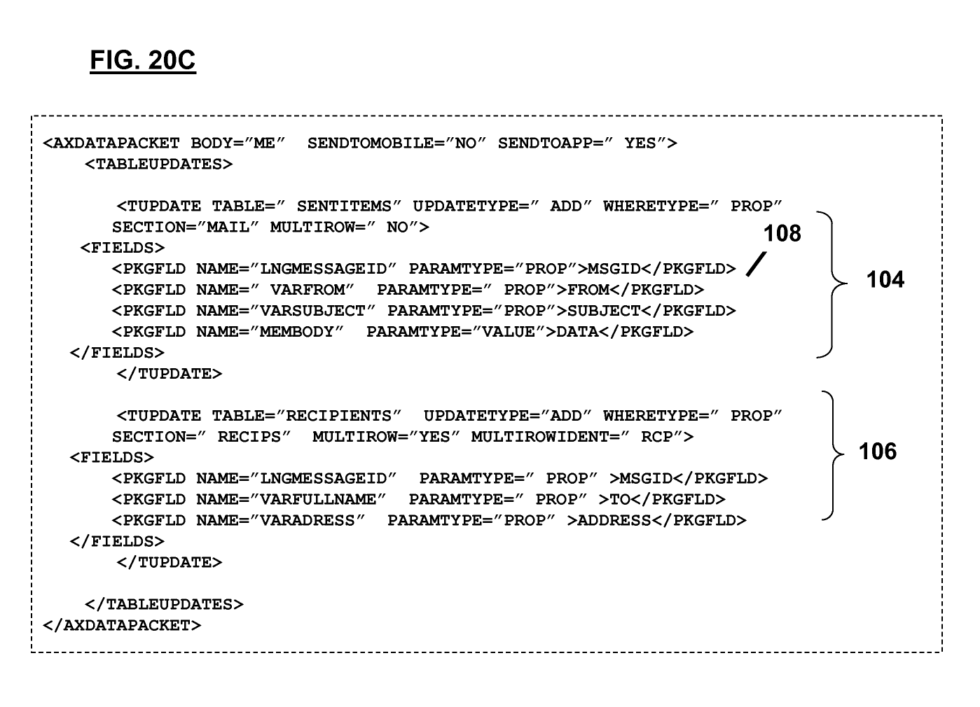

FIGS. 20A-20C similarly illustrates how local storage on the device, and the messages that update it, are defined in the application definition file 28. XML portion 96 forming part of the device local definition section 52 of an application definition defines an example format of local storage for the email application described in FIGS. 17 and 18. Two example tables, labeled E and F are defined in the local storage for the application. One table (E) stores details of sent emails. A second table (F) stores the recipients of sent emails. The first table E, “SentItems”, has four fields; the second table F, “Recipients” has three fields. This is illustrated in graphical form below the XML fragment.

FIGS. 20A and 20B further illustrates the use of local storage to store to data packages that are sent and received. Specifically, as illustrated in FIG. 20A the table given in FIG. 20A may store an email contained in the example message 94, shown in FIG. 19. So application definition file 28 for this application would contain, along with XML message portions 92 and XML portion 96, the XML fragment 102. XML fragment 102 defines how the data packages composed by the XML message portion 92 (an example of which was illustrated in FIG. 18), updates the tables defined by the XML portion 96.

XML fragment 102 includes two sections 104 and 106. First section 104 defines how the fields of the data package would update the “SentItems” table E. An example line 108 describes how the ‘MSGID’ field in the data package would update the ‘LNGMESSAGEID’ field in the table E. Similarly, the second section 106 describes how the fields of the data package would update the “Recipients” table.

Attributes of the illustrated <AXDATAPACKET> tag instruct the virtual machine software 24 as to whether a given data package should update tables in local storage. These rules are applied whenever that package is sent or received.

As can be seen from the preceding description and example, such an approach has significant advantages over the traditional method of deploying applications onto mobile devices. First, the definition of an application's functionality is separated from the details associated with implementing such functionality, allowing the implementers of a mobile application to concentrate on the functionality and ignore implementation details. Second, application definitions can be downloaded wirelessly, wherever the device happens to be at the time. This greatly improves the usefulness of the mobile device, by removing reliance on returning the device to a cradle and running a complex installation program. Thirdly, the use of application definition files allows flexible definitions for numerous applications. Server-side application may be easily ported for a number of devices 10.

It will be further understood that the invention is not limited to the embodiments described herein which are merely illustrative of a preferred embodiment of carrying out the invention, and which is susceptible to modification of form, arrangement of parts, steps, details and order of operation. The invention, rather, is intended to encompass all such modification within its scope, as defined by the claims.

What is claimed is:

1.-23. (canceled)

24. An application development tool for developing an application for subsequent deployment on a mobile device in a wireless network, the wireless network comprises a middleware server, a data source, the data source communicating with the middleware server and the application development tool via a defined interface, the application development tool comprising:
a communication interface defining communication between the application, the middleware server, and the data source via the defined interface;
a user interface layer including an editor and a viewer;
a model layer defining data models representing a persistent state of the application, the model layer providing for the user interface layer to respond to changes in the model layer; and
a service layer providing facilities to the user interface layer.

25. The application development tool as claimed in claim 24, wherein the mobile device is in communication with the data source, the mobile device receiving an application definition comprising:
a user interface section defining a screen format for the application and user interaction, a network transactions definition section defining a data format to be exchanged with the data source, and a local data definition section defining a second data format for data stored locally on the mobile device by the application;
where in the mobile device forms the application based on the application definition.

26. The application development tool as claimed in claim 24, wherein the service layer includes a backend connector facilitating simulating a suitable application message and data set to permit communication from the application when simulated running on the mobile device.

27. The application development tool as claimed in claim 26, wherein the model layer includes a design time model representing a current version of the application.

28. The application development tool as claimed in claim 27, wherein the design time model includes definition of at least one of a data component; a global variable; a message component; a resource; a screen component; a script; and a style.

29. The application development tool as claimed in claim 27, wherein the model layer includes a runtime data model representing a state of an emulated application under development, and collaborating with the design time model.

30. The application development tool as claimed in claim 29, wherein the a runtime data model notifies the viewer in the user interface layer.

31. The application development tool as claimed in claim 24, wherein the facilities provided by the service layer includes at least one of validation, localization, generation, build, simulator module and deployment.

32. The application development tool as claimed in claim 24, wherein the application development tool generates automatically packages of the application represented as metadata.

33. The application development tool as claimed in claim 24, wherein the application development tool provides a simulation of the application and a simulation of the middleware server with the data source.

34. The application development tool as claimed in claim 24, wherein the middleware server queues the data set received from mobile device intended for a given data source.

35. The application development tool as claimed in claim 24, wherein the middleware server and the application development tool are configured through the communication interface to communicate the data set directly with the data sources via the defined interface.

36. The application development tool as claimed in claim 24, wherein the middleware server is a transaction server.

37. The application development tool as claimed in claim 24, wherein the data source is a schema based service or a database providing enterprise services used by the application.

38. The application development tool as claimed in claim 24, wherein the middleware server functions as a messaging server for mediating messaging between the device executing the application and a backend server of the data sources.

39. The application development tool as claimed in claim 24, wherein the middleware server includes a master application definition, wherein a plurality of application definitions for a plurality of mobile devices is derived from the master application definition.

40. A method for developing an application for subsequent deployment on a mobile device in a wireless network, the wireless network comprises a middleware server, a data source, the data source communicating with the middleware server and the application development tool via a defined interface, the method comprising:
defining communication between the application, the middleware server, and the data source through a communication interface of an application development tool, the application development tool further comprising a user interface layer including an editor and a viewer;
defining data models representing a persistent state of the application in a model layer of the application development tool, the model layer providing for the user interface layer to respond to changes in the model layer; and
providing facilities to the user interface layer through a service layer of the application development tool.

41. The method as claimed in claim 40, wherein the mobile device is in communication with the data source, the mobile device receiving an application definition comprising:
a user interface section defining a screen format for the application and user interaction, a network transactions definition section defining a data format to be exchanged with the data source, and a local data definition section defining a second data format for data stored locally on the mobile device by the application;
where in the mobile device forms the application based on the application definition.

42. The method as claimed in claim 40, the service layer includes a backend connector facilitating simulating a suitable application message and data set to permit communication from the application when simulated running on the mobile device.

43. A storage medium readable by a computer encoding a computer program for execution by the computer to carry out a method as claimed in claim 40.
